(19) United States
(12) Patent Application Publication
(10) Pub. No.: US 2012/0071082 A1
(43) Pub. Date: Mar. 22, 2012

(54) MODULAR BUILDING UTILITIES SYSTEMS AND METHODS

(76) Inventor: John Chris Karamanos, San Jose, CA (US)

(21) Appl. No.: 13/073,809

(22) Filed: Mar. 28, 2011

Related U.S. Application Data
(63) Continuation-in-part of application No. 12/956,668, filed on Nov. 30, 2010.
Application No. 12/956,668 is a continuation-in-part of application No. 12/792,674, filed on Jun. 2, 2010.
(60) Provisional application No. 61/317,929, filed on Mar. 26, 2010.
(60) Provisional application No. 61/321,260, filed on Apr. 6, 2010.
(60) Provisional application No. 61/183,458, filed on Jun. 2, 2009.
(60) Provisional application No. 61/317,929, filed on Mar. 26, 2010.
(60) Provisional application No. 61/321,260, filed on Apr. 6, 2010.

(51) Int. Cl. F24F 13/02; B23P 15/26

(52) U.S. Cl. 454/284; 29/890.03

(57) ABSTRACT

Methods and apparatus for modular building utilities systems and assemblies for a building are provided. A modular system may include a first assembly having a duct, inlet piping, and outlet piping coupled via a bracket in a first positional relationship, where the inlet piping and outlet piping are disposed exterior to the duct. The modular system may also include a second assembly that may also have a duct, inlet piping, and outlet piping coupled via a bracket in a second positional relationship, where the inlet piping and outlet piping are also disposed exterior to the duct. The first positional relationship of the first assembly and the second positional relationship of the second assembly may provide alignment between the respective ducts, inlet piping, and outlet piping to facilitate coupling of the first and second assemblies.

### CROSS-REFERENCES TO RELATED APPLICATIONS

The present application is a continuation-in-part of U.S. patent application Ser. No. 12/956,668 filed Nov. 30, 2010 (Attorney Docket No. 025920-000920US), which is a continuation-in-part of U.S. patent application Ser. No. 12/792,674 filed Jun. 2, 2010 (Attorney Docket No. 025920-000910US), which claims the benefit of priority to U.S. Provisional Patent Application No. 61/183,458 filed Jun. 2, 2009 (Attorney Docket No. 025920-000900US), U.S. Provisional Patent Application No. 61/317,929 filed Mar. 26, 2010 (Attorney Docket No. 025920-001200US), and U.S. Provisional Patent Application No. 61/321,260 filed Apr. 6, 2010 (Attorney Docket No. 025920-001210US). The present application is also a non-provisional of and claims priority to U.S. Provisional Patent Application No. 61/317,929 filed Mar. 26, 2010 (Attorney Docket No. 025920-001200US) and U.S. Provisional Patent Application No. 61/321,260 filed Apr. 6, 2010 (Attorney Docket No. 025920-001210US). The entire disclosure of all of the aforementioned U.S. Provisional and Non-Provisional patent applications are hereby incorporated by reference, for all purposes, as if fully set forth herein.

### BACKGROUND

Various embodiments described herein relate generally to the field building utilities systems, and more particularly to modular systems for building utilities. The building utilities may include data, electrical, controls, fire, security, plumbing, and the like.

A range of approaches are used in existing HVAC systems. Existing HVAC systems include, for example, conventional forced air variable volume systems and systems employing chilled beams.

Conventional Building Utilities Installation

In conventional building construction, generally all building utilities are designed separately by an architect and/or engineer. The building utilities are then separately hung by various tradesmen.

Conventional Forced Air Variable Air Volume Systems

A conventional forced air variable air volume (VAV) system distributes air and water to terminal units installed in habitable spaces throughout a building. The air and water are cooled or heated in central equipment rooms. The air supplied is called primary or ventilation air. The water supplied is called primary or secondary water. Steam may also be used. Some terminal units employ a separate electric heating coil in lieu of a hot water coil. The primary air is first tempered through a large air handling unit and then distributed to the rest of the building through conventional air duct work. The large air handling unit may consist of a supply fan, return fan, exhaust fan, cooling coil, heating coil, filters, condensate drain pans, outside air dampers, return dampers, exhaust dampers, sensors, controls, etc. Once the primary air leaves the air handling unit the primary air is distributed through out the building through air duct work and then to in-room terminal units such as air distribution units and terminal units. A single in-room terminal unit usually conditions a single space, but some (e.g., a large fan-coil unit) may serve several spaces. Air distribution units and terminal units are typically used primarily in perimeter spaces of buildings with high sensible loads and where close control of humidity is not desired; they are also sometimes used in interior zones. Conventional forced air variable air volume systems work well in office buildings, hospitals, hotels, schools, apartments, and research labs. In most climates, these VAV systems are typically installed to condition perimeter building spaces and are designed to provide all desired space heating and cooling, outside air ventilation, and simultaneous heating and cooling in different parts of the building during intermediate seasons.

A conventional forced air variable air volume system has several disadvantages. For example, because large volumes of air circulated around a building, fan energy consumption and temperature losses may be significant. To minimize energy consumption, the large air handling unit may recycle the circulated air and only add a small portion of fresh air. Such recycling, however, may result in air borne contaminants and bacteria being spread throughout the building resulting in “sick building syndrome.” Other disadvantages may include draughts, lack of individual control, increased building height required to accommodate ducting, and noise associated with air velocity. Additionally, for many buildings, the use of in-room terminal units may be limited to perimeter spaces, with separate systems required for other areas. More controls may be needed as compared to other systems. In many systems, the primary air is supplied at a constant rate with no provision for shut off, which may be a disadvantage as tenants may prefer to shut off their heating or air conditioning or management may desire to do so to reduce energy consumption. Chilled beams and/or water based systems may be the most expensive system to install. Further, such systems may be prone to leaks causing water damage (e.g., mold growth). In many systems, low primary chilled water temperature and or deep chilled water coils are required to control space humidity accurately, which may result in more energy consumption from a chiller, cooling tower, and/or pumps. A conventional forced air variable air volume system may not be appropriate for spaces with large exhaust requirements such as labs unless supplementary ventilation is provided. In many systems, low primary air temperatures require heavily insulated ducts. In many systems, the energy consumption is high because of the power needed to deliver primary air against the pressure drop of the terminal units. The initial cost for a VAV system may be high. In many systems, the primary air is cooled, distributed, and may be subsequently re-heated after delivery to a local zone, thus wasting energy. In many systems, individual room control is expensive as an individual terminal unit or fan coil unit is required for each zone, which may be costly to install and maintain, including for ancillary components such as controls. Moving large flow rates of air thru duct work is inefficient and wastes energy. Mold and biocides may form in the duct work and then be blown into the ambient/occupied space.

Chilled-Beam Systems

A chilled beam uses water, not air, to remove heat from a room. Chilled beams are a relatively recent innovation. Chilled beams work by pumping chilled water through radiator like elements mounted on the ceiling. As with typical air ventilation systems, chilled beams typically use water heated or cooled by a separate system outside of the space. The building's occupants and equipment (e.g., computers) heat the air, which rises and is cooled by the chilled beam creating convection currents. Radiant cooling of interior elements and exposed slab soffit enhances this convective flow. Room occupants are also cooled (or warmed) by radiant heat transfer to or from the chilled beam.

Chilled beams, however, have some disadvantages. For example, they are relatively expensive due to the use of copper coils. A chilled beam is not easy to relocate, which may require major renovation for some office space reconfigurations. They can also be expensive to install for a variety of reasons, for example, their weight may be an issue with regard to seismic codes; they may take several tradesmen to install; they may require increased piping, valves, and controls compared to other systems; and three to four chilled beams may be required for every VAV air distribution unit or fan coil unit. Air still needs to be tempered to prevent condensation from forming on the chilled beam. They may be unable to provide the indoor comfort required in large spaces. They are exposed directly to the ambient space, which may result in condensate forming on the chilled beam and dripping on to products and equipment below. Substantially unrestricted airflow to the beam is typically required. A chilled beam requires more ceiling area than diffusers of a conventional system, thus leaving less room for sprinklers and lights. This can impact the aesthetics of the interior spaces and require a higher level of coordination for other systems such as lighting, ceiling grid, and fire protection. Mechanical contractors may not be familiar with chilled beams and may charge more. Re-circulated air passing through the chilled beam is not filtered as it would be in a VAV system. A chilled beam may not be suitable for use in an area with a high latent load. Areas such as conference rooms, meeting rooms, class rooms, restaurants, or theaters with dense population may be difficult to condition with chilled beams. Portions of a building that are open to the outside air typically cannot be conditioned with chilled beams. Noise may be an issue with chilled beams due to the use of pressure nozzles, which are factory set for a certain performance, derivation from which causes noise thereby limiting the options of the building occupants. The building should have a very tight construction for humid climates. Naturally ventilated buildings may need to include a sensor to measure dew point in the space and/or window position switches that automatically raise the cooling water temperature or shut down flows to the chilled beam when high dew points are reached. Chilled beams may need to be vacuumed every year. More control valves, strainers, etc. may be desired. Typical room design temperature for chilled beams is 75 to 78 degrees F., which may be too high for healthcare and pharmaceutical applications. A chilled beam typically does not provide a radial-symmetric airflow pattern like most hospital/lab air diffusers; instead, they drive the air laterally across the top of the room, which can disrupt hood airflow patterns.

In light of the above, it would be desirable to have improved HVAC systems and components with increased advantages and/or decreased disadvantages compared to existing HVAC systems and components. In particular, improved HVAC systems and components having reduced installed cost, improved controllability, decreased energy usage, increased recyclability, increased quality, increased maintainability, decreased maintenance costs, and decreased sound would be beneficial.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present disclosure generally provides modular building utilities systems sometimes referred to as a Coordinated and Integrated Modular Building Utilities Systems (CIMBUS). The modular building utilities systems and methods described herein may including prefabricating/pre-assembling some or all of a building's utilities and/or controls systems on to modules and then shipping to the modules to job sites where they are assembled or coupled together like a lego set.

The modular building utilities system (CIMBUS) provides a turnkey solution for some or all utilities including power, data, communication, HVAC, process controls (e.g., building automation system (BAS)), security, fire, and the like. The modular building utilities system may be like a LEGO® set that is prefabricated at an assembly site and snapped/assembled together at a construction site. The modular building utilities system may reduce that field labor costs by 50% or more, may provide faster building construction time, and/or may provide a single BAS automation integration platform for some or all utilities. One of the many values of the modular building utilities system may include the easy of hanging the modular system, leveling the modular system, prefabricating the modular system with some or a majority of utilities, providing a defect free modular system, providing an energy efficient modular system, and the like. The modular building utilities system may work with solar, geothermal, ice storage, gas, water, chemical systems, and the like. The modular building utilities system may have the lowest installed cost for the reasons described herein and may provide one controls integration platform.

An HVAC system may be part of the modular building utilities system. The HVAC system and/or the duct modules may be made in such a way which allows pre fabrication of a main distribution grid with all the utilities attached at the factory or added on in the field.

Currently, multiple trades and engineers are involved with designing and field fabricating various building utilities and/or controls in a building. Generally, most utilities are hung separately from ceiling platform or walls of the building. Union work preservation rights typically prohibit a tradesmen from engaging in each others work (e.g., prohibits sheet metal tradesman from touching a pipefitters or electricians work and the like). An example of installing building utilities ma involve a sheet metal tradesman installing the duct first by cutting support brackets (e.g., unistrut) and fastening (e.g., using off thread rod) the support brackets/duct to the ceiling platforms after they have been leveled. Pipefitters may then perform a similar function to build a piping platform (pipefitters may use a different fastening system to building the platform). The installation process may be followed by an electrician, low voltage communication/data, insulators, and the like. In contrast, once a modular building utilities system is hung, the main distribution for the building utilities may be installed quickly and defect free.

Water based HVAC systems are generally very energy efficient systems, but may also be the most expensive systems to install. The modular building utilities systems described herein may allow the use of a water based/gas HVAC system with high energy efficiencies at a low installed cost since the installed labor cost may be reduced by up to 50% or more, which may represent a majority of the construction costs for a building. By using ecm pumps and/or ecm fans, standardized sized ducts and/or pipes may be used, which may make the pre fabrication process simple and easy. The ecm motors technology may facilitate in overcoming any type of pressure differential in the water pipe or air duct by simply decreasing/increasing the cfm/gpm relative to the zone/pressure differentials in the system.

The modular building utilities systems and/or assemblies described herein may be prefabricated/factory manufactured with other building utilities such as the electrical conduit, quick connect electrical kits (replace conduit, cable trays, and the like), process gas piping (e.g., for hospitals, Pharma, and the like), communications/data cable, DC power run through out building utilities systems to power ecm motors and lights. Similarly, DC to AC converters may be provided at zone levels to supply 115 volt outlet power or the building utilities system may include separate distribution grids for 277/115 volt and/or a separate DC grid from solar power.

The modular building utilities system makes a lot of this possible in a very cost effective way by functioning as the main distribution platform within the building. Once the modular building utilities system is hung, it may be leveled. Further, the modular building utilities system may include expansion slots to add additional field fabricated items such as conduit, pipe, and the like. Once these items are added to the modular building utilities system, a tradesman does not need to level and/or install piping, conduit, cables, and the like separately, which may reduce a tremendous amount of time and/or cost. The cost savings using the modular building utilities system may allow for improved equipment and controls.

Furthermore, the modular building utilities system may allow the use of the same or similar sensors for some or all the utilities and one Building Automated System (BAS) integration platform to run/monitor all the utilities, such as light, electrical, hvac, security, data, and the like. By prefabricating some or a majority of controls hardware on to the modular building utilities system HVAC platform, a majority (e.g., up to 90%) of a controls company's field labor may be eliminated. The modular building utilities system may be installed and powered (e.g., a power switch may be flipped) and some or all the front end programming may be done remotely. In addition, the HVAC system may be self balancing. LED light manufacturers typically have a sensor pak and power pak on each light. HVAC systems may have their own sensors. The modular building utilities system may have a Personal Integrated Optimized Light Air Fixture (PIOLA) which may combine the led lights with an air distribution device. This device may handle a 10′×10′ area for lights and HVAC. Supplemental lights may be added as a master slave combination. The Zone Control Unit (ZCU) may be the source for the power to the lights in those zones thus eliminating the individual power paks for the lights. The ZCU controller could run the master PIOLA and the other supplemental lights could be slaves to the master. One sensor array could be used for some or all utilities and could be tied into the ZCU controller. Such a system may make the LED lights affordable. Further, the modular building utilities system may supply and/or include one front end controls integration platform.

The modular building utilities system may be prefabricated with a drain pan. The drain pan may function as a safety net in case of leaking pipes. The drain pan may be used primarily in or for data center to protect sensitive equipment, components, and/or information. The modular building utilities system may include a primary drain piping that is prefabricated or field fabricated onto the modular building utilities system. The primary drain piping may remove and/or recycle condensate water. The heat transfer medium for the HVAC unit (e.g., ZCU unit) may include water/fluid, gas, direct expansion (DX) refrigerant, and/or chemical. The modular building utilities system can be used with multiple HVAC systems such as air, water, refrigerant, chilled beams, and the like.

The present disclosure generally provides heating, ventilation, and air conditioning (HVAC) systems, components, and control systems. In many embodiments, an HVAC system includes distributed zone control units that locally re-circulate air to zones serviced by each respective zone control unit. A zone control unit can condition the re-circulated air by adding heat, removing heat, and/or filtering. A supply airflow (e.g., a flow of outside air) can be mixed in with return airflows extracted from the serviced zones, the resulting mixed airflow conditioned prior to discharge to the serviced zones. Automated control dampers and a variable speed fan(s) can be used to control flow rates of the mixed air discharged to each serviced zone, control the flow rates of the return airflows extracted from the serviced zones, and to control the flow rate of the supply airflow mixed in with the return airflows. In many embodiments, the supply airflows are provided to the distributed zone control units by a central supply airflow source, which can intake outside air and condition the outside air prior to discharging the conditioned outside air for distribution to the distributed zone control units. In many embodiments, an HVAC system includes an exhaust air system that extracts air from one or more HVAC zones and discharges the extracted air as exhaust air. In many embodiments, an HVAC system includes a heat recovery wheel for exchanging heat and moisture between the incoming outside intake air and the outgoing exhaust air. In many embodiments, an HVAC system includes one or more filters and/or a humidity adjustment device for conditioning the supply airflow prior to distribution to the distributed HVAC zone control units. In many embodiments, an HVAC zone control unit and/or the central supply airflow source incorporates one or more heat exchangers with micro-channel coils. In many embodiments, the distributed HVAC zone control units include control electronics having an Internet protocol address and can include a resident processor and memory providing local control functionality.

The disclosed modular building utilities system, HVAC systems, zone control units, and control systems provide a number of advantages. These advantages may include reduced installed system cost; improved air quality; increased Leadership in Energy and Environmental Design (LEED) points; improved quality; reduced maintenance costs; improved maintainability; reduced sound; reduced energy usage; improved control system; improved building flexibility; superior Indoor Air Quality (IAQ); exceeding American Society of Heating, Refrigerating and Air-Conditioning Engineers (ASHRAE) standards; flexible application in a variety of different types of buildings/applications; and/or reduced manufacturing costs and installed cost. In addition, the modular building utilities system provides a reduced energy footprint.

Thus, in a first aspect, a method for providing heating, ventilation, and air conditioning (HVAC) to zones of a building is provided. The method includes providing a flow of supply air from outside the zones. First and second flows of return air are extracted from a first subset of the zones and a second subset of the zones, respectively. The first and second return airflows are mixed with first and second portions of the supply airflow to form first and second mixed airflows, respectively. Heat is added to and/or removed from at least one of the first return airflow, the first supply airflow, or the first mixed airflow. Heat is added to and/or removed from at least one of the second return airflow, the second supply airflow, or the second mixed airflow. The first mixed airflow is distributed to the first subset of zones. And the second mixed airflow is distributed to the second subset of zones.

The heat can be added or removed using heat exchanging coils. Each of the first and second mixed airflows can be routed through a respective heat exchanging coil. Heat can be added to a mixed airflow by routing water having a temperature higher that a temperature of the mixed airflow within the respective heat exchanging coil. Each of the respective heat exchanging coils can include a heating coil and a cooling coil. Water having a temperature higher than the temperature of the respective mixed airflow can be routed within the respective heating coil to add heat to the respective mixed airflow. And water having a temperature lower than the temperature of the respective mixed airflow can be routed within the respective cooling coil to remove heat from the respective mixed airflow. A variable rate pump can be used to control a flow rate of water routed through the respective heat exchanging coil. A variable speed fan can be used to draw the respective mixed airflow through the respective heat exchanging coil so as to control a flow rate of the respective mixed airflow.

The first subset of zones can include a plurality of zones. One or more automated controllable dampers can be used to control a flow rate of return air originating from one or more zones of the first subset of zones. And one or more automated controllable dampers can be used to control a flow rate of the first mixed airflow distributed to one or more zones of the first subset of zones.

In another aspect, a heating, ventilation, and air conditioning (HVAC) zone control unit (ZCU) configured to provide HVAC to a building in conjunction with at least one additional of such a zone control unit is provided. In a building having zones that include a first and second subset of zones, the ZCU provides HVAC to the first subset of the zones, and the at least one additional ZCU provides HVAC to the second subset of the zones. The ZCU includes a housing configured to mount to the building local to the first subset of zones. A return air plenum is disposed within the housing. A first return air inlet is configured to input a first return airflow originating from at least one of the first subset of zones into the return air plenum. A supply air inlet is configured to receive a supply airflow into the plenum from a supply air duct transporting the supply airflow from outside the zones of the building. The supply airflow and the return airflow combine to form a mixed airflow. At least one heat exchanging coil is disposed within the housing. A discharge air plenum is disposed within the housing. A fan motivates the mixed airflow to pass through the heat exchanging coil and discharges into the discharge air plenum. A first discharge outlet is configured to discharge air from the discharge air plenum for distribution to at least one zone of the first subset of zones. The ZCU can include one or more return airflow inlets and/or one or more discharge outlets.

The ZCU can include one or more automated controllable dampers. For example, an automated controllable damper can be used to control a flow rate of the first return airflow input through the first return air inlet. And an automated controllable damper can be used to control a flow rate of the second return airflow input through the second return air inlet. An automated controllable damper can be used to control a flow rate of the supply airflow input through the supply air inlet. And one or more automated controllable dampers can be used to control the rate at which the mixed airflow is discharged to one or more zones serviced by the ZCU.

The ZCU can also employ an open air plenum design. In an open air plenum design, return air inlets draw return airflows directly from the air surrounding the ZCU so that no return airflow ducts are required. Instead, zone installed vents and natural passageways in building's ceiling can be used to provide a pathway by which the return airflows are routed from the serviced building zones back to the ZCU.

The at least one heat exchanging coil can include a heating coil and a cooling coil. A first variable rate pump can be used to route water having a temperature higher than the mixed airflow through the heating coil at a controlled rate. And a second variable rate pump can be used to route water having a temperature lower than the mixed airflow through the cooling coil at a controlled rate.

The ZCU can include handle brackets, which include handle features that provide for convenient handling/transport of the ZCU. The handle brackets can include support provisions for ZCU system components (e.g., heating coil piping, cooling coil piping, controllable valves, variable rate pumps, etc.).

The ZCU can be sealed and pressurized for testing and/or shipping. For example, the ZCU can be sealed, pressurized, and then shipped to the job site in the pressurized state. The pressure level can be monitored to detect any leaks, or to verify the absence of leaks as evidenced by a lack of drop in the pressure level over a suitable time period. Exemplary brackets and related methods that can be employed are disclosed in U.S. Pat. Nos. 6,951,324, 7,140,236, 7,165,797, 7,387,013, 7,444,731, 7,478,761, 7,537,183, and 7,596,962; and United States Patent Publication No. U.S. 2007/0108352 A1; the full disclosures of which are hereby incorporated herein by reference.

The ZCU can include a local control unit to control the ZCU. The local control unit has its own Internet Protocol (IP) address and be connectable to the Internet via a communication link. The communication link can include, for example, a hard-wired communication link and/or a wireless communication link. The local control unit can be configured to control lighting in the first subset of zones, power management, and/or HVAC.

The modular building utilities system may provide a single controls integration platform comprising and/or communicatively coupled with one or more sensors (e.g., photo, motion, temperature, infrared, and the like.

A sensor(s) can be coupled with the local control unit to measure a compound concentration level. The local control unit can use the measured concentration level to control a flow rate of the supply airflow input into the ZCU to control a resulting concentration level of the measured compound. The sensor(s) can include at least one of a carbon-dioxide (CO₂) sensor or a total organic volatile (TOV) sensor. The local control unit can transmit the measured compound concentration level to an external device.

Lighting for serviced building zones can also be controlled via the ZCU local control unit. For example, lights (e.g., light emitting diode (LED) lights) can be located on air diffusers and controlled by the ZCU local control unit (e.g., as a master/slave control combination). Lighting and sensors can be co-located. For example, a sensor pack and a LED light(s) can be co-located on a return air grill. Additional zone lights (e.g., LED lights) can be employed via master slave combination off of the ZCU local control unit.

Power may be provided to the lights from the modular building utilities system and/or the modular building utilities system may provide power to the ZCU, which in turn provides power to the lights. The ZCU and/or modular building utilities system may include one or more transformers for the lights and/or other power requirements. Similarly, the ZCU and/or modular building utilities system may include one or more converters (e.g., DC to AC or vice versa) and/or include a DC and/or AC power supply.

In another aspect, an HVAC system for providing HVAC to zones of a building is provided. The system includes first and second HVAC ZCUs, such as the above-described ZCU. The system further includes a supply airflow duct transporting a flow of supply air. A first portion of the supply airflow is provided to the first ZCU and a second portion of the supply air is provided to the second ZCU. The system further includes an air-handling unit that intakes the supply airflow from external to the zones of the building and discharges the supply airflow into the supply airflow duct.

The HVAC system can include at least one supply line providing a heat transfer fluid to the at least one heat exchanging coil and at least one return line for returning the heat transfer fluid discharged from the at least one heat exchanging coil. The fluid may include gas, water, chemical, and/or any other heat transfer fluid.

In another aspect, a prefabricated assembly is provided that is configured for use in an HVAC system providing HVAC to zones of a building. The HVAC system has a plurality of distributed ZCUs, with each of the ZCUs providing HVAC to a respective subset of the zones. The prefabricated has a length and includes a length of duct having first and second ends. The duct is configured to transport a flow of supply air from the first end to the second end. The duct is adaptable to include a discharge port to discharge a portion of the supply airflow to one of the distributed ZCUs. Brackets that include mounting features are coupled with the duct along the length of the duct. A supply line and a return line are supported by at least one of the mounting features. The supply line and the return line are provided to supply and return water from a heat exchanging coil of one or more of the distributed ZCUs. The prefabricated assembly is configured so that corresponding components of a plurality of the prefabricated assemblies can be coupled to provide for the transport of the flow of supply air along a combined length of the coupled assemblies and for the transport of the supply and return water along the combined length. The prefabricated assembly includes mounting surfaces to mount the assembly to the building. The prefabricated assembly may include components and/or equipment for process gas, water, chemical, plumbing, electrical, data, communications, security, HVAC, fire, and the like.

The prefabricated assembly can include additional features. For example, the prefabricated assembly can be configured so that at least one electrical conduit can be supported by at least one of the mounting features. The prefabricated assembly can include at least one cable tray supported by at least one of the mounting features. The prefabricated assembly can include at least one wireless transmitter or a wireless repeater coupled with at least one of the brackets. The prefabricated assembly can include control wires connectable to the distributed ZCUs to transmit at least one of control signals or data at least to or from the distributed ZCUs. The prefabricated assembly may also include hot water heaters, DC and/or AC converters, plumbing piping, process gas piping (e.g., oxygen, nitrogen, carbon dioxide, and the like), data cables, security cables and/or equipment, and the like.

In another aspect, a method for providing HVAC to first and second zones of a building is provided. The method includes providing first and second flows of supply air from outside the zones via an air duct. A first flow of return air is extracted from a first zone and a second flow of return air is extracted from a second zone. The first flow of return air is mixed with the first flow of supply air in a first zone control unit so as to form a first mixed flow. The second flow of return air is mixed with the second flow of supply air in a second zone control unit so as to form a second mixed flow. Heated water is directed to the first and second zone control units from a hot water source. Cooled water is directed to the first and second zone control units from a cold water source. Although water is described, the fluid may alternatively or additionally include direct expansion refrigerants, chemicals, and/or any other heat transfer medium. In response to a low temperature in the first zone, heat transfer within the first zone control unit from the heated water to the first mixed airflow is increased. In response to a high temperature in the first zone, heat transfer within the first zone control unit from the cooled water to the first mixed airflow is increased. In response to a low temperature in the second zone, heat transfer within the second zone control unit from the heated water to the second mixed airflow is increased. In response to a high temperature in the second zone, heat transfer within the second zone control unit from the cooled water to the first mixed airflow is increased. The first mixed airflow is distributed to the first zone. And the second mixed airflow is distributed to the second zone. The ZCU may also provide heating and/or cooling at zone levels.

Heat transfer can be increased within the zone control units using several approaches. For example, heat transfer can be increased by varying the return airflows by altering a fan speed within each zone control unit. And/or heat transfer can be increased by varying flow of the heated water or the cooled water within each zone control unit.

Humidity control can be employed. For example, a mixed airflow can be dehumidified in a zone control unit by cooling the mixed airflow to full saturation to form condensate (which is removed, for example, via a sump pump a condensate return line). The dehumidified mixed airflow can then be reheated (e.g., via a heater coil).

Common zone control units can be employed. For example, the first zone control unit can be interchangeable with the second zone control unit, even if the first zone has significantly different heating and cooling load characteristics than the second zone.

The modular building utilities system may allow economies of scale thereby reducing overall costs. The modular building utilities system may be used in various projects including hotels, offices, campus, pharma, healthcare, and the like.

The method can include installing the HVAC system in the building using pre-assembled assemblies. For example, the HVAC system can be installed in the building by coupling the first zone control unit to the duct, the hot water source, and the cold water source using a first assembly and coupling the second zone control unit to the duct, the hot water source, and the cold water source using a second assembly. Each of the first and second assemblies includes a supply air duct, a hot water line, and a cold water line supported by a bracket.

In another aspect, a set of prefabricated assemblies are provided that are configured for use in an HVAC system providing HVAC to zones of a building. The HVAC system has a plurality of zone control units (ZCUs), each of the ZCUs locally providing HVAC to a respective subset of the zones. Each of the prefabricated assemblies has a length and includes a length of duct having first and second ends. The duct is configured to transport a flow of supply air from the first end to the second end. The duct is adaptable to include a discharge port to discharge a portion of the supply air to an associated one of the distributed ZCUs. Brackets are coupled with the length of the duct. The brackets include mounting features. The set of prefabricated assemblies includes a supply line to supply water to and a return line to return water from a heat exchanging coil of one or more of the distributed ZCUs. The supply and return lines are supported by at least one of the mounting features. Corresponding components of a plurality of the prefabricated assemblies can be coupled to provide for the transport of the flow of supply air along a combined length of the coupled assemblies and for the transport of the supply and return water along the combined length. The prefabricated assemblies include mounting surfaces to mount the assemblies to the building.

The duct and/or piping of the modular building utilities system may stay the same size throughout a portion or all of the modular building utilities system by using localized pumps and fans to overcome pressure differentials in the system. To overcome such differentials, a temperature reset controls strategy may be employed.

Embodiments of the present invention encompass methods of installing a heating, ventilation, and air conditioning (HVAC) unit in an HVAC system. Exemplary methods may include steps such as securing an inlet piping assembly of the HVAC unit to a bracket, securing an outlet piping assembly of the HVAC unit to the bracket, coupling a thermal transfer mechanism of the HVAC unit with the inlet piping assembly and the outlet piping assembly, fluidly coupling a water pump with at least one of the thermal transfer mechanism, the inlet piping assembly and the outlet piping assembly, placing at least a portion of the thermal transfer mechanism along an air flow path within a casing of the HVAC unit such that at least a portion of the inlet piping assembly and at least a portion of the outlet piping assembly are disposed exterior to the casing, positioning a fan along the airflow path within the casing, mounting the HVAC unit by mounting the bracket to the HVAC system, and maintaining alignment of the HVAC unit thermal transfer mechanism, the HVAC unit inlet piping assembly, and the HVAC unit outlet piping assembly while mounting the HVAC unit in the HVAC system. In some cases, the water pump includes a variable rate water pump. In some cases, the water pump includes a variable rate water pump having an electronically commutated motor. In some cases, the water pump includes a variable rate water pump operable between about 0 and about 15 gallons per minute. Optionally, the water pump can be controlled by pulse width modulation. Relatedly, the water pump can be controlled by a signal of between about 0 volts and about 10 volts. In some instances, the fan includes a variable rate fan. In some instances, the fan includes a variable rate fan having an electronically commutated motor. In some instances the water pump, fan, and/or any other equipment or controls may be powered by solar power, which may power a DC ECM moter that may run a DC/AC converter that provides 115 volt (or other voltage) AC power to one or more receptacles.

In some aspects, embodiments of the present invention encompass methods of preparing a heating, ventilation, and air conditioning (HVAC) unit for delivery to a construction site for installation in an HVAC system. Exemplary methods may include steps such as coupling a thermal transfer mechanism with an inlet piping assembly and an outlet piping assembly, where the inlet piping assembly is configured to supply fluid to the thermal transfer mechanism and the outlet piping assembly is configured to receive fluid from the thermal transfer mechanism. Method steps may also include fluidly coupling a water pump with at least one of the thermal transfer mechanism, the inlet piping assembly, and the outlet piping assembly, placing at least a portion of the thermal transfer mechanism along an air flow path within a casing, such that at least a portion of the inlet piping assembly and at least a portion of the outlet piping assembly are disposed exterior to the casing, positioning a fan along the airflow path within the casing, and coupling a bracket with the casing, the inlet piping assembly, and the outlet piping assembly, so as to maintain the casing, the inlet piping assembly, and the outlet piping assembly in positional relationship. In some cases, the water pump includes a variable rate water pump. In some cases, the water pump includes a variable rate water pump having an electronically commutated motor. In some cases, the water pump includes a variable rate water pump operable between about 0 and about 15 gallons per minute. Optionally, the water pump can be controlled by pulse width modulation. In some instances, the water pump can be controlled by a signal of between about 0 volts and about 10 volts. In some embodiments, the fan may include a variable rate fan. In some cases, the fan may include a variable rate fan having an electronically commutated motor.

In yet another aspect, embodiments of the present invention include a heating, ventilation, and air conditioning (HVAC) unit for transporting fluid in an (HVAC) system. Exemplary HVAC units may include a thermal transfer mechanism, an inlet piping assembly coupled with the thermal transfer mechanism for supplying fluid to the thermal transfer mechanism, an outlet piping assembly coupled with the thermal transfer mechanism for receiving fluid from the thermal transfer mechanism, and a water pump in fluid communication with at least one of the thermal transfer mechanism, the inlet piping assembly, and the outlet piping assembly. HVAC units may also include a bracket that maintains the thermal transfer mechanism, the inlet piping assembly, and the outlet piping assembly in positional relationship, a casing defining an airflow path, and a fan disposed along the airflow path within the casing. In some cases, at least a portion of the thermal transfer mechanism can be disposed along the air flow path within the casing, at least a portion of the inlet piping assembly and at least a portion of the outlet piping assembly can be disposed exterior to the casing, and at least a portion of the bracket can be disposed exterior to the casing. In some instances, the water pump includes a variable rate water pump having an electronically commutated motor. In some instances, the water pump includes a variable rate water pump operable between about 0 and about 15 gallons per minute. Optionally, the fan may includes a variable rate fan having an electronically commutated motor.

Embodiments of the present invention also encompass a modular building utilities system for installation in a building. The modular system may include a first assembly having a first duct for transporting air, a first bracket coupled with the first duct, a first inlet piping coupled with first bracket and disposed exterior to the first duct, a first outlet piping coupled with the first bracket and disposed exterior to the first duct, and a first adjustable fastening mechanism coupled with the first bracket for adjustably coupling the first bracket with the building. The modular system may also include a second assembly having a second duct for transporting air, a second bracket coupled with the second duct, a second inlet piping coupled with second bracket and disposed exterior to the second duct, a second outlet piping coupled with the second bracket and disposed exterior to the second duct, and a second adjustable fastening mechanism coupled with the second bracket for adjustably coupling the second bracket with the building. The first bracket may maintain the first inlet piping, the first outlet piping, and the first duct in a first positional relationship and the second bracket may maintain the second inlet piping, the second outlet piping, and the second duct in a second positional relationship. The first and second positional relationships may provide alignment between the first and second ducts, the first and second inlet pipings, and the first and second outlet pipings, respectively, so as to facilitate coupling of the first and second ducts, the first and second inlet pipings, and the first and second outlet pipings, respectively.

The modular system may further include a zone control unit (ZCU) configured to provide HVAC to one or more zones of the building. In one embodiment the ZCU comprises a 3 pipe configuration having an inlet pipe, an outlet pipe, and a primary drain pipe. In other embodiments, the ZCU may include a 5 pipe system having a primary drain pipe and one or more inlet pipes and outlet pipes. The ZCU and/or modular building utilities system may also include a drain pan separate from the primary drain piping. The drain pan may be used for backup in critical environments, such as data centers and the like or used in any other environment. The first duct may include a discharge port configured to supply a portion of the air to the ZCU; and the first inlet piping and first outlet piping may be coupled with a coil of the ZCU to provide fluid communication between the coil and the first inlet piping and first outlet piping. The first bracket may include a cable tray configured to support one or more electrical wires. The first and/or second assembly may include an enclosure disposed around the at least one of the first assembly and the second assembly to protect the assembly. The first and/or second bracket may include a wireless transmitter and/or a wireless repeater. The first bracket may also include a drain pan coupled with and extending along the length of the first bracket and the second bracket may also include a drain pain coupled with and extending along the length of the second bracket. The first drain pan and the second drain pan may be configured to collect condensate of the modular system. The first and second brackets may provide alignment between the first and second drain pans, respectively, to facilitate coupling of the first and second drain pans so that the condensate may be transported at least partially along the length of the first and second assemblies to a condensate reclamation system.

Embodiments of the present invention may further include a method of assembling a modular assembly at an assembly site for transportation to an installation site, where the modular assembly is configured to include various building utilities. The method may include obtaining a first duct having a first end and a second end, the first duct configured to transport air between the first end and the second end. The method may also include obtaining a first inlet piping having a first end and a second end, the first inlet piping configured to transport a fluid between the first end and the second end. The method may further include obtaining a first outlet piping having a first end and a second end, the first outlet piping configured to transport a fluid between the first end and the second end. The method may additionally include obtaining a first bracket having a plurality of mounting features and a first adjustable fastening mechanism for adjustably coupling the first bracket with the building. The method may additionally include obtaining a second bracket having a plurality of mounting features and a second adjustable fastening mechanism for adjustably coupling the second bracket with the building. The method may additionally include coupling via one or more of the plurality of mounting features, the first bracket with the first end of the first duct, the first inlet piping, and the first outlet piping, wherein the first inlet piping and the first outlet piping are disposed exterior to the first duct, and wherein the first bracket maintains the first end of the first duct, the first inlet piping, and the first outlet piping in a first positional relationship. The method may additionally include coupling via one or more of the plurality of mounting features, the second bracket with the second end of the first duct, the first inlet piping, and the first outlet piping, wherein the second bracket maintains the second end of the first duct, the first inlet piping, and the first outlet piping in the first positional relationship.

The method may additionally include sealing the first and second ends of the first duct, the first inlet piping, and/or the first outlet piping, pressurizing the sealed first duct, the first inlet piping, and/or the first outlet piping to a predetermined pressure, and measuring the pressure in the pressurized duct, inlet piping, and/or outlet piping after an amount of time to determine whether the duct, inlet piping, and/or outlet piping is holding pressure. The method may additionally include transporting the modular assembly from the assembly site to the installation site, where the step of pressurizing is performed at the assembly site, and where the step of measuring the pressure is performed at the installation site. The method may additionally include obtaining a cable tray having a first end and a second end, where the cable tray is configured to support one or more electrical cables, coupling the first bracket with the first end of the cable tray via a mounting feature of the plurality of mounting features, and coupling the second bracket with the second end of the cable tray via a mounting feature of the plurality of mounting features. Coupling the first and second brackets with the first and second ends of the cable tray, respectively, may be performed at the installation site. Alternatively or additionally, coupling the first and second brackets with the first and second ends of the cable tray, respectively, may be performed at the assembly site. The modular building utilities system may snap or assembly together like blocks of a LEGO® set to facilitate installation of the building utilities. The modular building utilities system may include one or more components or equipment for power, data, HVAC, and the like.

The method may additionally include coupling the first duct with a zone control unit (ZCU) configured to provide HVAC to one or more zones of the building, where the first duct provides fluid communication between the ZCU and the air within the duct and coupling a coil of the ZCU with the first inlet piping and first outlet piping, where the first inlet piping supplies a hot or cold fluid to the coil to heat or cool a volume of air, and where the first outlet piping receives a hot or cold fluid from the coil after the volume of air is heated or cooled. The method may additionally include coupling a drain pan with the first and second brackets so that the drain pan extends along the length of the modular assembly. The drain pan may be configured to collect condensate and transport the condensate along the length of the modular assembly. Each of the brackets may includes a handle configured to maneuver the bracket and/or modular assembly. The bracket may be configured to maintain support and/or positional relationship for the pipe assembly while the bracket is maneuvered by the handle. One or more of the brackets may be coupled with a drain pan that may be used as a backup safety feature in one or more environments, such as data centers.

Embodiments of the present invention may additionally include a method of installing a modular system that includes obtaining a first modular assembly having a first duct for transporting air, a first bracket coupled with the first duct, a first inlet piping coupled with the first bracket and disposed exterior to the first duct, a first outlet piping coupled with the first bracket and disposed exterior to the first duct, and a first adjustable fastening mechanism coupled with the first bracket for adjustably coupling the first bracket with the building. The method may also include securing the first modular assembly to the building via the first adjustable fastening mechanism and leveling the first modular assembly so that opposing ends of the first modular assembly are substantially level. The method may further include obtaining a second modular assembly having a second duct for transporting air, a second bracket coupled with the second duct, a second inlet piping coupled with the second bracket and disposed exterior to the second duct, a second outlet piping coupled with the second bracket and disposed exterior to the second duct, and a second adjustable fastening mechanism coupled with the second bracket for adjustably coupling the second bracket with the building. The method may additionally include securing the second modular assembly to the building via the second adjustable fastening mechanism and leveling the second modular assembly so that opposing ends of the second modular assembly are substantially level. The method may additionally include coupling the first modular assembly with the second modular assembly in a fluid tight relationship to provide air transportation along the combined length of the coupled first and second ducts and to provide fluid transportation along the combined length of the first and second inlet piping and first and second outlet piping.

The method may additionally include obtaining a cable tray configured to support one or more electrical cables and coupling the cable tray with at least one of the first bracket or the second bracket so that the cable tray extends along the length of at least one of the first modular assembly or second modular assembly. In some embodiments, the modular building utilities system may include separate data cable, electrical cables, and the like that are not included or positioned in the cable tray. For example, the cables could be coupled directly with the bracket or run through electrical conduit attached to the bracket. The method may additionally include positioning electrical cables in the cable tray to provide electrical communication to one or more zones of the building. The method may additionally include obtaining a third modular assembly having a third duct for transporting air, a third bracket coupled with the third duct, a third inlet piping coupled with the third bracket and disposed exterior to the third duct, a third outlet piping coupled with the third bracket and disposed exterior to the third duct, and a third adjustable fastening mechanism coupled with the third bracket for adjustably coupling the third bracket with the building. The method may additionally include securing the third modular assembly to the building so that the third modular assembly comprises a substantially perpendicular orientation with respect to the first modular assembly and coupling the third modular assembly with the first modular assembly to provide fluid communication between the first and third ducts, first and third inlet piping, and first and third outlet piping. The first modular assembly and the second modular assembly may each include a drain pan that extends along the length of the respective modular assembly. The drain pan of the first modular assembly may be coupled with the drain pan of the second modular assembly to form a substantially continuous drain pan extending along the length of the coupled assemblies. The continuous drain pans may be configured to collect condensate from the first and/or second assembly and transport the condensate to a condensate reclamation system. The method may additionally include obtaining a fourth piping, obtaining a fifth piping, after securing the first modular assembly to the building, coupling the fourth piping with the first modular assembly, after securing the second modular assembly to the building, coupling the fifth piping with the second modular assembly, and coupling the fourth piping with the fifth piping to provide fluid transportation along the combined length of the fourth and fifth piping.

Embodiments of the present invention may additionally include a method of installing a modular system in a heating, ventilating, and air conditioning (HVAC) system of a building. The method may include assembling a first modular assembly at an assembly site, the first modular assembly having a first duct for transporting air, a first bracket coupled with the first duct, a first inlet piping coupled with the first bracket and disposed exterior to the first duct, a first outlet piping coupled with the first bracket and disposed exterior to the first duct, and a first adjustable fastening mechanism coupled with the first bracket for adjustably coupling the first bracket with the building. The method may also include assembling a second modular assembly at an assembly site, the second modular assembly having a second duct for transporting air, a second bracket coupled with the second duct, a second inlet piping coupled with the second bracket and disposed exterior to the second duct, a second outlet piping coupled with the second bracket and disposed exterior to the second duct, and a second adjustable fastening mechanism coupled with the second bracket for adjustably coupling the second bracket with the building. The method may further include transporting the first modular assembly and the second modular assembly to an installation site, installing the first modular assembly in the building, installing the second modular assembly in the building, and coupling the first and second ducts, the first and second inlet piping, and the first and second outlet piping so as to provide fluid communication between the first and second ducts, the first and second inlet piping, and the first and second outlet piping.

For a fuller understanding of the nature and advantages of the present invention, reference should be made to the ensuing detailed description and accompanying drawings.

### BRIEF DESCRIPTION OF THE DRAWINGS

FIG. 1 diagrammatically illustrates an modular building utilities system having distributed zone control units that provide localized air recirculation, in accordance with many embodiments.

FIG. 2 is a perspective view illustrating installed distribution assemblies for a modular building utilities system having distributed zone control units, in accordance with many embodiments.

FIG. 3 is a perspective view illustrating the installed distribution assemblies of the modular building utilities system of FIG. 2 from a closer view point.

FIG. 4 is a perspective view illustrating a junction between a vertically-oriented distribution assembly and a horizontally-oriented distribution assembly of the modular building utilities system of FIG. 2.

FIGS. 5A-B are perspective views illustrating a horizontally-oriented distribution assembly of the modular building utilities system of FIG. 2.

FIG. 6 illustrates details of prefabricated distribution assemblies used in a modular building utilities system having distributed zone control units, in accordance with many embodiments.

FIG. 7 illustrates details of brackets used in a prefabricated distribution assembly of a modular building utilities system having distributed zone control units, in accordance with many embodiments.

FIG. 8 is a perspective view illustrating the installation of two zone control units of a modular building utilities system having distributed zone control units, in accordance with many embodiments. The figure illustrates one zone control unit having an open plenum while the other zone control unit includes a ducted return.

FIG. 9 is a perspective view illustrating supply and return lines used to couple a zone control unit with a distribution assembly of a modular building utilities system having distributed zone control units, in accordance with many embodiments. The zone control unit may also be coupled with the modular building utilities system using electrical connections, air, fluid, gas, condensate connections, and the like.

FIG. 10 is a perspective view illustrating details of a distribution assembly of a modular building utilities system having distributed zone control units and a supply air duct port and associated supply air duct used to transfer a flow of supply air from the distribution assembly to a zone control unit, in accordance with many embodiments.

FIG. 11 is a top view diagrammatic illustration of a modular building utilities system zone control unit that provides localized air recirculation via return air ducts and a circulation fan section disposed between a cooling coil section and a heating coil section, in accordance with many embodiments.

FIG. 12 is a side view diagrammatic illustration of the modular building utilities system zone control unit of FIG. 11. The figure illustrates the zone control unit with valve packages and/or ECM pumps.

FIG. 13 is a top view diagrammatic illustration of a modular building utilities system zone control unit that provides localized air recirculation via return air ducts and a combined heating/cooling coil section, in accordance to many embodiments.

FIG. 14 is a side view diagrammatic illustration of the modular building utilities system zone control unit of FIG. 13.

FIG. 15 is a top view diagrammatic illustration of a modular building utilities system zone control unit with direct intake of local recirculation air and a circulation fan disposed between a cooling coil section and a heating coil section, in accordance with many embodiments.

FIG. 16 is a photograph of a prototype zone control unit, in accordance with many embodiments.

FIG. 17 is a photograph of the prototype zone control unit of FIG. 16, illustrating internal components and showing flow strips employed during testing.

FIG. 18 schematically illustrates modular building utilities system zone control units, in accordance with many embodiments.

FIGS. 19A and 19B illustrate a micro-channel coil design, in accordance with many embodiments. The micro-channel design can be used with various fluids (e.g., liquids or gas).

FIG. 20 is a perspective view illustrating a control damper of a modular building utilities system zone control unit, in accordance with many embodiments.

FIG. 21 diagrammatically illustrates the distribution of outside supply air, heated water, cooled water, and the discharge of exhaust air to and from zones of a multi-floor building, in accordance with many embodiments. The figure also illustrates the modular building utilities system installed in a building.

FIGS. 22 and 23 diagrammatically illustrate a number of configurations that can be used for the routing of supply air, return air, and exhaust air in an HVAC system having distributed zone control units, in accordance with many embodiments.

FIG. 24 schematically illustrates a control system for a modular building utilities system zone control unit.

FIG. 25 schematically illustrates a control system for a modular building utilities system zone control unit, the control system comprising a local control unit with an Internet protocol address, in accordance with many embodiments.

FIG. 26 schematically illustrates a control system for a modular building utilities system zone control unit, the control system comprising a local control unit that receives input from a zone mounted sensor(s) and controls zone lighting, power management, and the like in accordance with many embodiments.

FIG. 27 is a simplified diagrammatic illustration of a method for providing heating, ventilation, and air conditioning (HVAC) to zones of a building, in accordance with many embodiments.

FIG. 28 diagrammatically illustrates an algorithm for controlling a zone control unit for zone cooling and heating, in accordance with many embodiments.

FIG. 29 diagrammatically illustrates an algorithm for controlling a zone control unit for zone pressurization, in accordance with many embodiments.

FIG. 30 diagrammatically illustrates an algorithm for controlling a zone control unit for supply air and mixed airflow control, in accordance with many embodiments.

FIG. 31 diagrammatically illustrates an algorithm for determining whether to operate a zone control unit so as to provide both heating and cooling to zones serviced by the zone control unit, in accordance with many embodiments. The algorithm may comprise a temperature reset algorithm. The temperature difference between room temperature and the temperature at or near the coil may determine how much gallons per minute (GPM) of fluid (e.g., refrigerant, water, etc.) and/or cubic feet per minute (CFM) of air to supply to the coil.

FIG. 32 diagrammatically illustrates an algorithm for controlling a flow rate of supply air, in accordance with many embodiments.

FIG. 33 diagrammatically illustrates an algorithm for controlling the flow of heated and cooled water through heat exchanging coils of a zone control unit, in accordance with many embodiments.

FIG. 34 diagrammatically illustrates an algorithm for controlling a zone control unit to reduce energy usage via the selection of flow rates for return air and supply air, in accordance with many embodiments.

FIGS. 35 and 36 show aspects of modular building utilities systems according to embodiments of the present invention. The modular building utilities system may have valves, pumps, etc. directly prefabricated onto the modular building utilities system. Further, the modular building utilities system may have embedded thermal transfer units (e.g., embedded in the duct) and/or be coupled with one or more thermal transfer units.

FIGS. 37A-B illustrate aspects of brackets that may be used with the distribution assemblies in accordance with many embodiments. The brackets may be coupled with components and/or equipment for data, security, fire, electrical, speakers, and the like.

FIGS. 38A-C illustrate aspects of additional brackets that may be used with the distribution assemblies in accordance with many embodiments.

FIGS. 39A-B illustrate aspects of additional brackets that may be used with the distribution assemblies in accordance with many embodiments.

FIGS. 40A-B illustrate aspects of brackets that may be used with the distribution assemblies in accordance with many embodiments.

FIG. 41 illustrates aspects of an additional bracket that may be used with the distribution assemblies in accordance with many embodiments.

FIGS. 42A-B illustrate aspects of a jig that may be used with the distribution assemblies in accordance with many embodiments.

FIGS. 43A-B illustrate aspects of a field erected housing unit that may include a distribution assembly in accordance with many embodiments.

FIG. 44 illustrates aspects of an enclosure that may be used to enclose the distribution assemblies in accordance with many embodiments.

FIG. 45 illustrates aspects of brackets that may be used with the distribution assemblies in accordance with many embodiments.

FIGS. 46A-D illustrate aspects of a fan section that may be used with the distribution assemblies in accordance with many embodiments.

FIGS. 47 and 48 illustrates aspects of a modular system that may include modular assemblies and/or zone control units in accordance with many embodiments.

FIG. 49 illustrates a method of assembling a modular assembly in accordance with many embodiments.

FIG. 50 illustrates a method of installing a modular system in a building in accordance with many embodiments.

FIG. 51 illustrates another method of installing a modular system in a building in accordance with many embodiments.

FIG. 52 illustrates another method of installing a modular building utilities system in a building in accordance with many embodiments.

FIG. 53 illustrates aspects of a zone control unit in accordance with many embodiments.

### DETAILED DESCRIPTION

In the following description, various embodiments of the present invention will be described. For purposes of explanation, specific configurations and details are set forth in order to provide a thorough understanding of the embodiments. The present invention can, however, be practiced without the specific details. Furthermore, well-known features may be omitted or simplified in order not to obscure the embodiment being described.

HVAC System Configuration

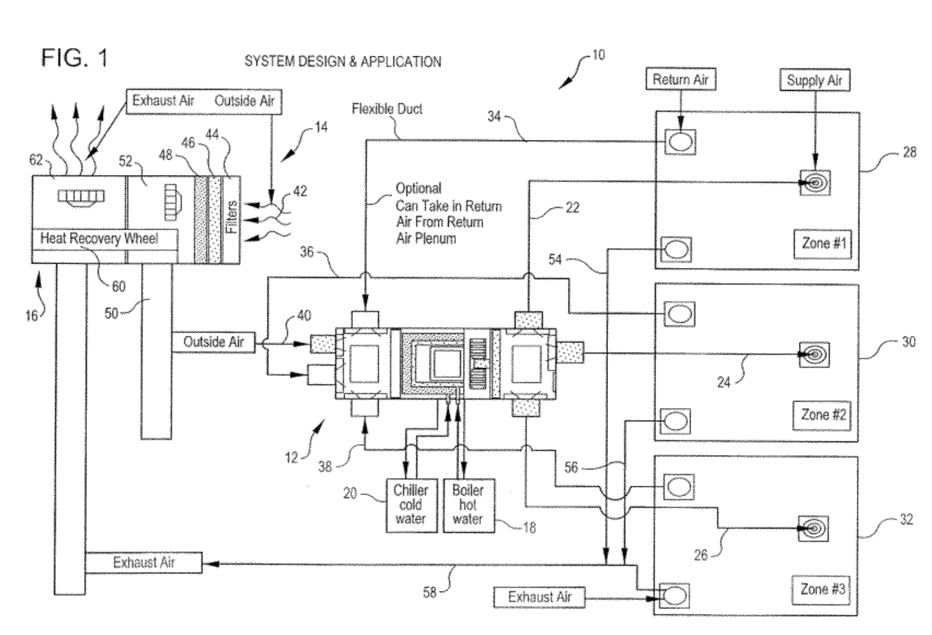

Referring now to the drawings, in which like reference numerals represent like parts throughout the several views, FIG. 1 diagrammatically illustrates an HVAC system 10 that includes a zone control unit 12, a supply air system 14, an exhaust air system 16, a boiler 18, and a chiller 20. While the illustrated HVAC system 10 includes one zone control unit 12 servicing three HVAC zones 28, 30, 32, additional zone control units can be used, and each zone control unit can serve one or more HVAC zones. Likewise, one or more supply air systems, exhaust air systems, boilers, and/or chillers can be used in any particular HVAC system.

The zone control unit 12 discharges mixed airflows 22, 24, 26 to building zones 28, 30, 32, respectively. The zone control unit 12 extracts return airflows 34, 36, 38 from building zones 28, 30, 32, respectively. A supply airflow 40 (e.g., an outside airflow) can be combined with the recirculation airflows 34, 36, 38 within the zone control unit in a controlled manner via automated dampers to form a mixed airflow. Heat can be added or extracted from the mixed airflow via one or more coils located within the zone control unit prior to discharging the mixed airflow for delivery to the building zones 28, 30, 32. For example, the mixed airflow can be drawn through a heating coil and a cooling coil located within the zone control unit. The boiler 18 can be used to add heat to a flow of water that is circulated through the heating coil. The chiller 20 can be used to extract heat from a flow of water that is circulated through the cooling coil. Other suitable approaches can also be used to add heat to or extract heat from the mixed airflow, for example, a heat pump system can be used to add or extract heat via a heat exchanger located within the zone control unit. A number of HVAC zone control unit configurations, in accordance with many embodiments, will be discussed in more detail below.

The supply air system 14 can be used to distribute intake outside air to provide the supply airflow 40 to each of the distributed zone control units in an HVAC system. The supply air system 14 intakes outside air 42, filter the outside air 42 via filters 44, add heat to the outside air via a heater coil 46, and/or remove heat from the outside air via an air conditioning coil 48. Other approaches can also be used to add heat to or extract heat from the air inducted by the supply air system 14, for example, a heat pump system can be used to add or extract heat via a heat exchanger located within the supply air system. The supply air system 14 includes a fan section 52, which can employ a variable speed motor, for example, an electronically commutated motor (ECM), for controlling the amount of outside air inducted by the supply air system 14 in response to system demands. The supply air system 14 is coupled with a duct system 50 to deliver the supply airflow 40 to the zone control unit 12, as well as to any additional zone control unit employed by the HVAC system 10. The ducts described herein may present any of a variety of cross section shapes including without limitation: round, rectangular, and square shapes. Relatedly, ducts can be manufactured from or include any of a variety of materials including without limitation: flexible, acoustical, fabric, polycarbonate, sheet metal, aluminum, steel, stainless steel, plastic, wire, wood, sheet rock, fiber board, insulated, non-insulated, and the like.

The exhaust air system 16 can be used to extract exhaust airflows 54, 56, 58 from building zones 28, 30, 32, respectively. The exhaust air system 16 and the supply air system 14 can be coupled via a heat recovery wheel 60 to exchange heat and moisture between the outside air inducted by the supply air system 14 and the combined exhaust airflows discharged by the exhaust air system 16. The exhaust air system 16 includes a fan section 62, which can employ a variable speed motor, for example, an electronically commutated motor (ECM), for controlling the amount of exhaust air discharged by the exhaust air system 16 in response to system demands.

HVAC System Distribution Assemblies

In the above-described HVAC system 10, a supply airflow 40 is delivered to the zone control unit 12 and heated and cooled water are circulated to the zone control unit 12. In many embodiments, an integrated distribution system is used to deliver the supply airflow and circulate heated and cooled water to each of the distributed zone control units employed within a building HVAC system. Such an integrated distribution system can employ a number of joined distribution assemblies that each includes a supply air duct to distribute supply air to the zone control units, and supply and return water or gas pipes to circulate the heated and cooled water to the zone control units. The water or gas may be circulated with or without ECM pumps.

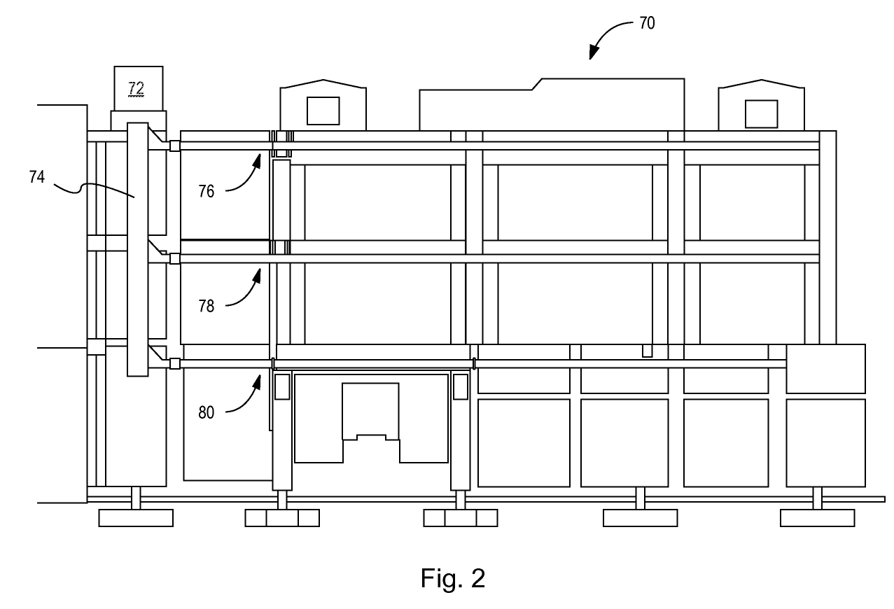

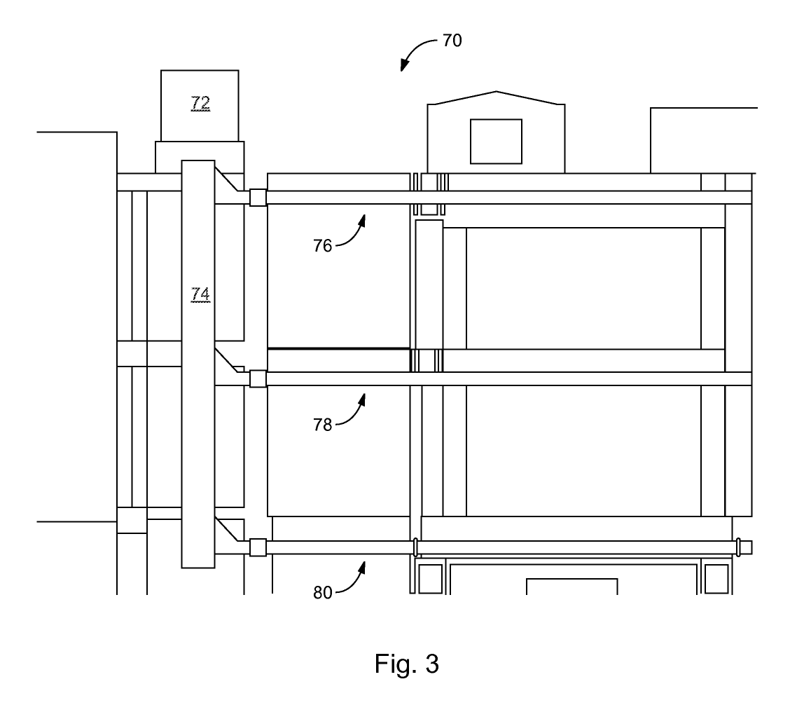

For example, FIG. 2 illustrates an installed distribution system 70 of a modular building utilities system having distributed zone control units, in accordance with many embodiments. The distribution system 70 includes a roof-mounted air handler 72 that discharges a supply airflow (e.g., outside air) into a vertically-oriented distribution assembly 74. The vertically-oriented distribution assembly 74 in turn distributes the supply airflow to horizontally-oriented distribution assemblies 76, 78, 80, which in turn distribute the supply airflow to zone control units distributed along the horizontally-oriented distribution assemblies 76, 78, 80. FIG. 3 illustrates the installed distribution system of FIG. 2 from a closer view point.

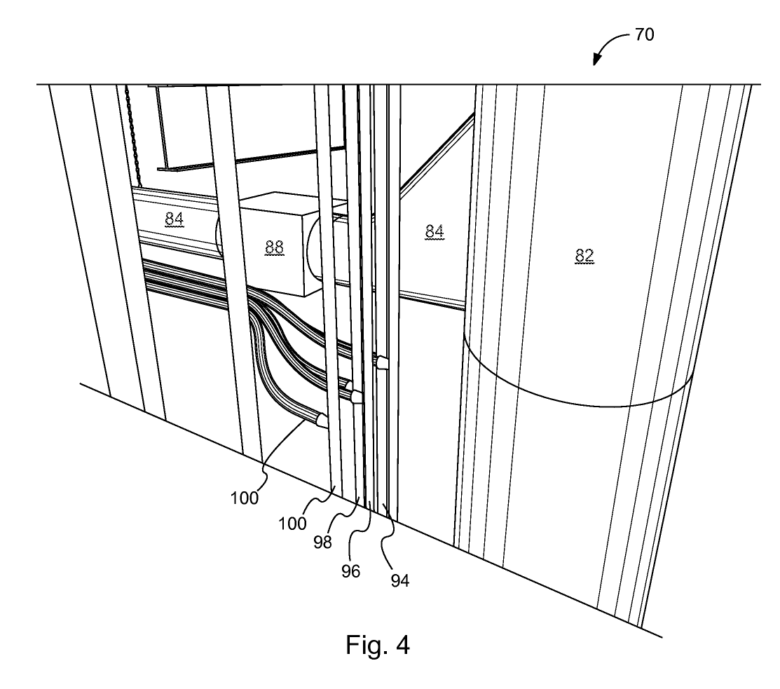

FIG. 4 illustrates a junction between the vertically-oriented distribution assembly 74 and one of the horizontally-oriented distribution assemblies 76, 78, 80. The vertically-oriented distribution assembly 74 includes a trunk supply air duct 82 that can be suitably sized to transport the supply air distributed to the downstream zone control units. Likewise, the horizontally-oriented distribution assembly 76, 78, 80 includes a supply air duct 84 that can be suitably sized to transport the portion of the supply air distributed to respective downstream zone control units. Because the disclosed HVAC systems employ distributed zone control units that locally re-circulate air to respective zones, the required minimum size of the supply air ducts is significantly smaller than duct sizes required by conventional forced air HVAC systems, which do not employ local re-circulation of air. As a result, the sizes of the supply air ducts employed in the disclosed HVAC systems can be selected to reduce the number of different duct sizes employed without substantial detriment due to the significantly reduced minimum size of the ducts. For example, the vertically-oriented distribution assembly 74 illustrated employs a supply air duct 82 having a single constant cross-section, and each of the horizontally-oriented distribution assemblies 76, 78, 80 employ a supply air duct 84 having a common, albeit smaller, cross-section. At the junction, a transition duct 86 and a duct coupling section 88 are used to couple the supply airflow ducts of the vertically and horizontally-oriented distribution assemblies together.

The distribution assemblies includes four water supply and return lines 92, 94, 96, 98 used to circulate heated and cooled water to and from the distributed zone control units, and further includes a condensate return line 100 used to remove condensate water from the zone control units. At the junction, the supply and return lines of the horizontally-oriented distribution assembly are coupled into the corresponding lines of the vertically oriented distribution assembly.

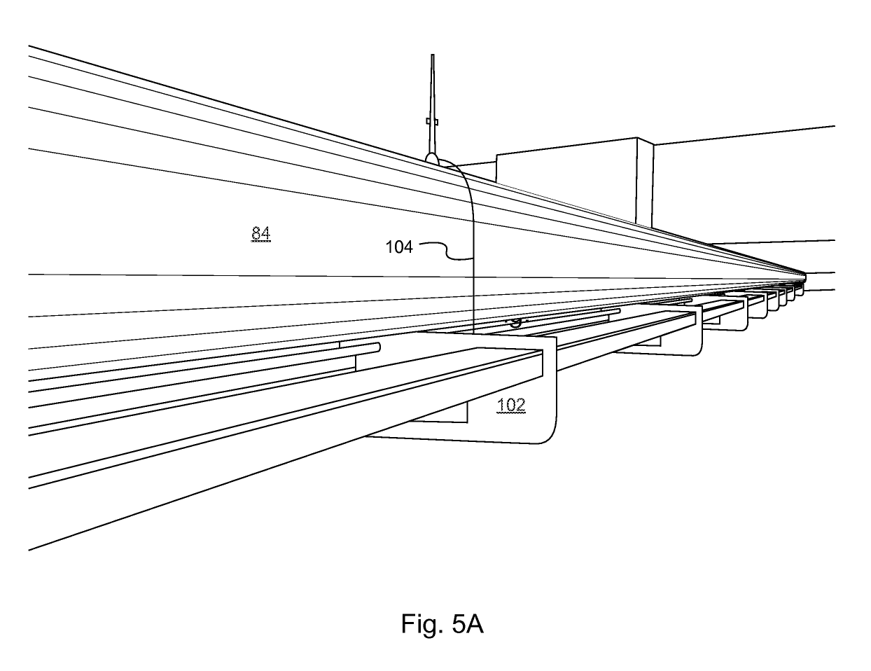

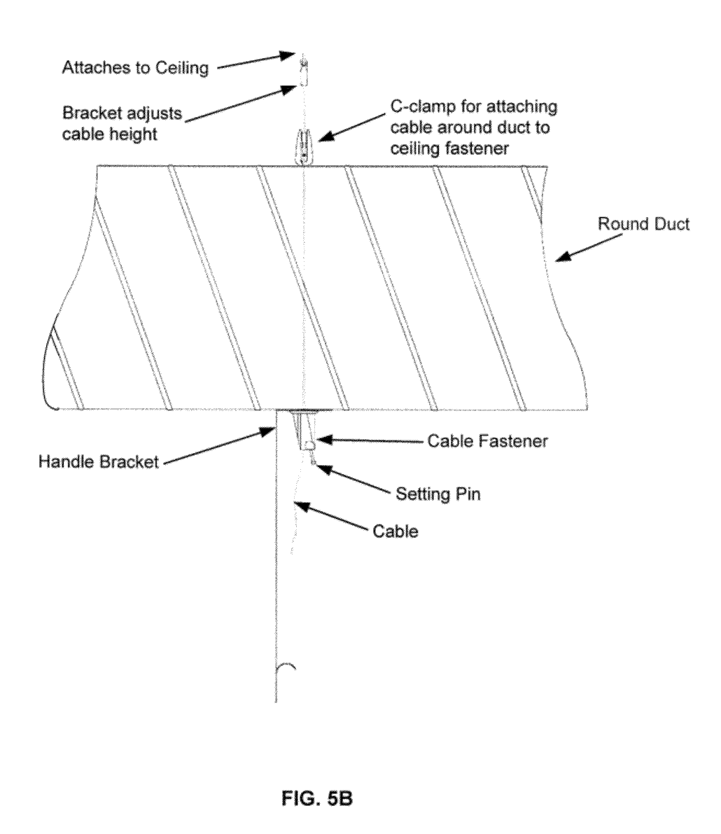

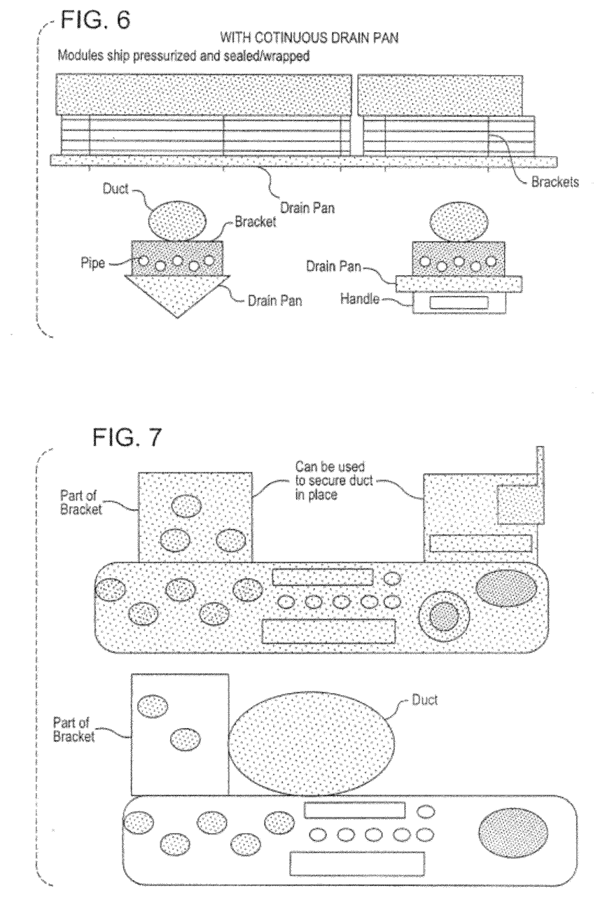

FIG. 5A illustrates one of the horizontally-oriented distribution assemblies 76, 78, 80 as installed. The horizontally-oriented distribution assembly includes a plurality of brackets 102 distributed along the length of the distribution assembly. Each of the brackets 102 is hung from via a hanger 104 and is disposed under and supports the supply air duct 84. Each of the brackets 102 includes mounting features used to support the four water supply and return lines and the condensate return line. The mounting features may be used to support a variety of piping that may be used to transfer water, process gases, refrigerant, oxygen, argon, nitrogen, CO₂, and the like. For example, the piping may be hot and/or cold water piping, chemical piping, fire sprinkler piping, and the like. The pipes of the piping may be include a variety of materials (insulated or non-insulated) such as copper, PVC, polycarbonate, black iron, stainless steel, and the like. The brackets 102 may also include or be coupled with drain pans that may extend longitudinally along the length of the distribution assembly and that are configured to collect condensate from the distribution assembly (e.g., the duct, piping, conduits, and the like). The drain pan may be built into the bracket or may be coupled with the bottom portion of the bracket. The drain pan may add an extra layer of protection against water leaks. The drain pans of adjacent distribution assemblies 76, 78, 80 may be coupled together to provide a continuous or integrated raceway that the collected condensate may run down. At the end of the raceway (e.g., where the horizontally-oriented distribution assemblies 76, 78, 80 couple with the vertically-oriented distribution assembly 74) may be a condensate collection reservoir or pump that pump the condensate into a condensate reclamation system for later use (e.g., pumps the condensate through condensate return line 100 to a water reclamation system for use as wastewater in toilets and the like). The drain pans may also be coupled with condensate collection bottles under the drain pan. The drain pans may be made of different materials and shapes, such as the rectangular and triangular or V shaped drain pans shown in FIG. 6. The drain pans may be prefabricated/pre-assembled with the distribution assemblies 76, 78, 80 or may be installed just prior to or after installation of the assemblies. The brackets 102 also include mounting features used to, for example, support additional components such as electrical conduits and cable trays used to route power and/or control cables to systems distributed in the building (e.g., to the zone control units, to lighting, telephone, computers, outlets, wireless repeaters, wireless transmitters, fire suppression sprinklers, smoke detectors, water heaters, DC/AC and/or AC/DC converters, insulation, controls hardware, and the like). The conduit may be manufactured of a variety of materials including: flexible, steel, stainless steel, aluminum plastic, wire, polycarbonate, and the like. Likewise, the conduit can be used to transfer a variety of cables including electrical, wire, light, communications, data, wireless communications, cat 5 networking, and the like. The brackets 102 can also be used to support sensors and/or electronic devices. For example, wireless repeaters and/or wireless transmitters can be distributed throughout the building via attachment to selected brackets 102 so as to provide wireless internet connectivity in the building. A 3 pipe assembly or 5 pipe assembly including a drain pipe may be connected to the bracket.

The distribution assemblies 74, 76, 78, 80 can be prefabricated prior to installation in a building. In many embodiments, the distribution assemblies 74, 76, 78, 80 include prefabricated subassemblies that are assembled on site prior to installation. For example, each of the horizontally-oriented distribution assemblies 76, 78, 80 can be fabricated from a number of prefabricated modules that are separately transported to a building site, mounted to the building (e.g., by lifting the prefabricated modules up to be hung via the above-described hangers from the ceiling of the building), and then joined to the adjacent prefabricated modules into a combined assembly. Alternatively, the prefabricated modules can be joined into a combined assembly before being lifted and hung from the ceiling (e.g., while disposed on the floor). FIG. 6 and FIG. 7 illustrate details of such prefabricated distribution assemblies that can be used in an HVAC system having distributed zone control units, in accordance with many embodiments. Additional details of such prefabricated distribution assemblies are disclosed in U.S. Provisional Patent Application No. 61/317,929, entitled “Modular Building Utilities Superhighway Systems and Methods,” (Attorney Docket No. 025920-001200US), filed on Mar. 26, 2010; and U.S. Provisional Patent Application No. 61/321,260, entitled “Modular Building Utilities Superhighway Systems and Methods,” (Attorney Docket No. 025920-001210US), filed on Apr. 6, 2010; the entire disclosures of which are incorporated by reference above.

HVAC Zone Control Unit Installation

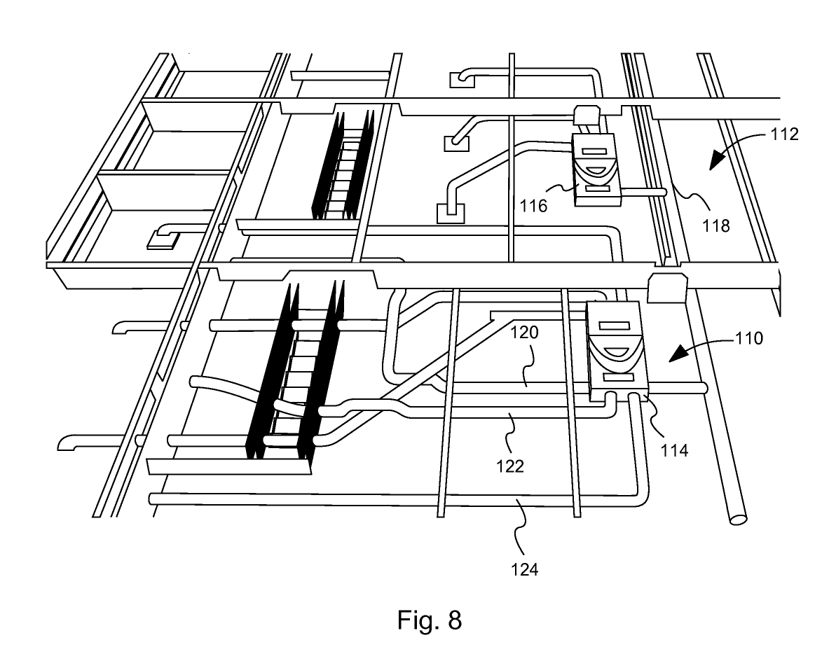

FIG. 8 illustrates two example installations 110, 112 of zone control units 114, 116, respectively, in accordance with many embodiments. In the example installations 110, 112, the zone control units 114, 116 are mounted adjacent to a horizontally-oriented distribution assembly 118 so as to provide for convenient coupling between the distribution assembly 118 and the zone control units 114, 116 with respect to provisions for the supply airflow, the circulation of heated and cooled water to and from the zone control units, and the removal of condensate from the zone control units. In the first example installation 110, return air ducts 120, 122, 124 are used to transport return airflow extracted from building zones serviced by the first zone control unit 114 to return air inlets of the first zone control unit 114. In the second example installation 112, no return air ducts are employed so that the return air inlets of the second zone control unit 116 intake return airflows directly from adjacent to the second zone control unit 116. The second example installation 112 can be used, for example, when a suitable route exists for return airflows to travel between the building zones serviced by a zone control unit and the zone control unit. For example, vents can be installed in the ceiling panels of the serviced building zones to allow for return airflows to exit the serviced zones into the ceiling cavity in which the zone control unit is located.

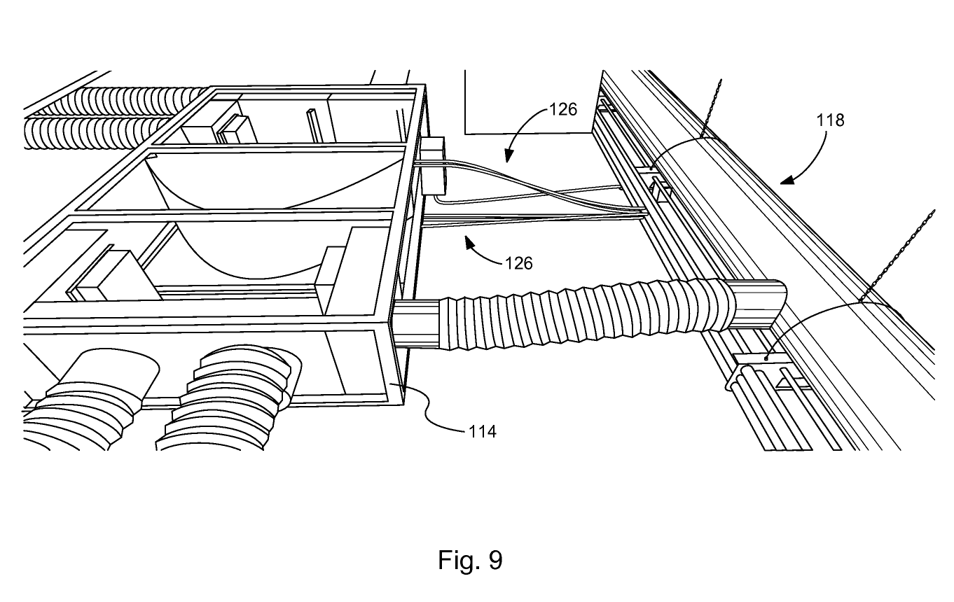

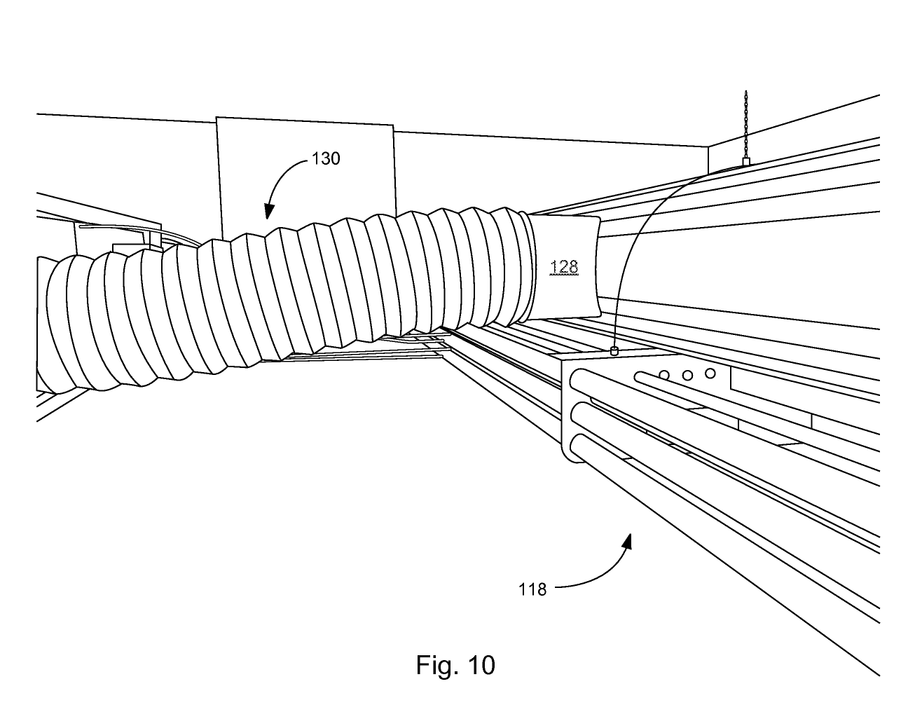

FIG. 9 illustrates the coupling of the zone control unit 114 to the horizontally-oriented distribution assembly 118. The zone control unit and/or distribution assembly may include electrical quick connect kits. Coupling water lines 126 are used to couple the heat exchanging coils of the zone control unit 114 with the supply and return water lines of the distribution assembly 118 and to couple the condensate return line of the distribution assembly 118 with a sump discharge line of the zone control unit 114. FIG. 10 illustrates details a supply airflow duct port 128 of the distribution assembly 118 and an associated supply airflow duct 130 used to transfer a flow of supply air from the distribution assembly 118 to the zone control unit 114.

In many embodiments, the distribution system illustrated in FIG. 1 through FIG. 10 is pre-engineered and prefabricated accordingly so that required on-site fabrication is reduced or eliminated. For example, a method of manufacturing and installing the distribution assemblies 74, 76, 78, 80 can proceed as follows:

1. Perform thermal load calculations for the building.
2. Prepare a design drawing(s) showing where the zone control units, air duct, electrical, piping etc. is going to be installed.
3. Fabricate air duct in sections such as 10, 20, 30, 40, etc. foot sections and label based on the design drawing(s).
4. Cut in openings/duct connections for the duct to attach to adjacent duct and to the zone control units.
5. Insulate the air duct.
6. Attach the brackets and fastening system to the air duct.
7. Pre-fabricate water pipe and insert through the bracket mounting features (e.g., staggered holes/grommets).
8. Couple features to the pipes used to couple the zone control units with the pipes and used to couple adjacent prefabricated distribution assembly modules (e.g., valve bodies, pressure gauges and stainless steel hose kits).
9. Seal the pipe ends and hoses, and pressurize to a suitable testing pressure (e.g., 100 psig).
10. Insulate the pipe and all other components requiring insulation.
11. Same procedure for fire sprinklers, process gas pipe, direct expansion refrigerant (DX gas), electrical cables, data cables, communication cables/equipment, plumbing fixtures and/or pipes, etc. Process gas piping may be used to transport oxygen, nitrogen, carbon dioxide, and/or any other gas.
12. Leave for a suitable time frame (e.g., overnight, other specified time period) to make sure there are no leaks by making sure the pressure is the same as the day before or time frame before.
13. Install the electrical conduit and cable trays (or this can be done in the field after the brackets have been hung).
14. Wrap the entire module in a large plastic bag and seal off both ends.
15. Tag the modules as per the details on the design drawing(s).
16. Cut small slits in the plastic bag over the handles of the brackets so only the handles are exposed.
17. Load the modules on to a transporting service. Use the handles so as not to damage the modules.
18. Deliver the modules to the project site in order by assembly nomenclatures for easy assembly, installation and hanging of the modules.
19. Unload the modules from the transporting service.
20. Unload using handles so as not to damage the modules.
21. Transport the modules to the location in the building shown on the design drawing(s).
22. Lift the horizontally-oriented distribution assembly modules towards the ceiling with a man lift or other lifting device via the handles.
23. Install the vertically-oriented distribution assembly modules in the shaft of the building.
24. Fasten the horizontally-oriented distribution assembly modules to the ceiling using the bracketing system—cable, off thread rod or other fastening device/system.
25. Make final adjustments after module is level.
26. Cut ends of plastic bag at duct work and piping ends and assemble into the next module/air duct.
27. Install zone control units and connect to duct and pipe.
28. Install flex duct from the distribution assembly modules to the zone control units for the transfer of supply airflows (outside air) to the zone control units.
29. Couple the hose kits (e.g., stainless steel, plastic, copper, and the like) to the zone control unit hot water supply/return, chilled water supply/return and drain (option for drain plug in zone control units unit to hold pressure).
30. Optionally repeat items 20-26 for any other assemblies and zone control units.
31. Re-pressurize the zone control modules to 100 psig and leave overnight, or re pressurize entire piping/module run.
32. The next day, check the gauges for the pressure reading to make sure there are no leaks. If the pressure is not the same as the night before then the leak may be in one of the stainless steel hose connections to the zone control units. Troubles shoot and repair.
33. If pressure is the same as the night before, then connect the pipes to the next module with press fittings. (Alternatively, all the pipes and assemblies may be connected and the entire section of piping, conduit, duct, etc. can be pressurized together).
34. Apply the above sequence to connect the vertically-oriented distribution assemblies to a wall of the building and/or to the horizontally-oriented distribution assemblies. (Alternatively, this procedure may be done before the zone control units and horizontal distribution assemblies are connected).
35. Electrician and low voltage tradesman can now come in and run the electrical wires/conduit and the cable wiring. Or the conduit and trays may be already installed on the brackets/modular assemblies.
36. The holes and rectangular box/cable tray are symmetrical and level through out the building. Thus, no hanging or support is required for the electrical, cables etc. Therefore, the installation time is very quick. All the pipe, duct, electrical, cables may be located on the brackets and follow the duct through out the building.
37. This may make it easier to locate all these things and provide more room to work on these components.
38. The components may take up less ceiling space and may be located symmetrically around the duct. It may be possible to have an extra floor(s) in the same building footprint by using this bracketing system.

HVAC Zone Control Unit Configurations

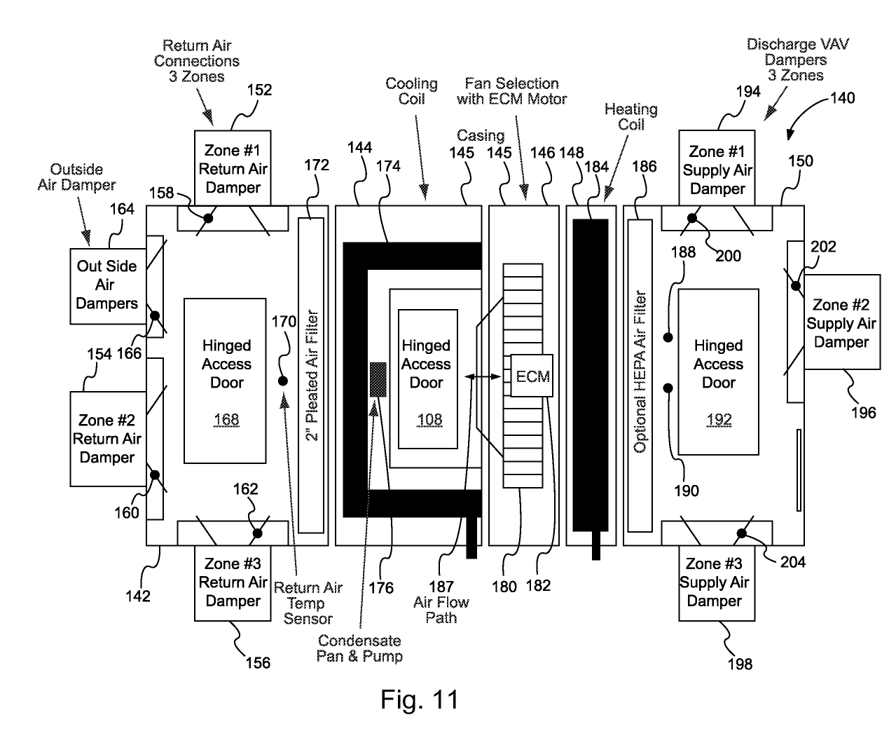

FIG. 11 is a top view diagrammatic illustration of an HVAC zone control unit 140, in accordance with many embodiments. The HVAC zone control unit 140 includes a return air section 142, a cooling coil section 144, a fan section 146, a heating coil section 148, and a supply air section 150.

In operation, return airflows from serviced building zones enters the return air section 142 via return air inlet collars 152, 154, 156. Automated return air dampers 158, 160, 162 are used to control the flow rate of the return airflows entering the return air section 142 through the return air inlet collars 152, 154, 156, respectively, which provides for better control of the associated building zone. For example, a return air damper 158, 160, 162 can be closed when the associated zone is not occupied. The return air dampers 158, 160, 162 can be configured with damper shafts located on the bottom of the HVAC zone control unit 140 for access from the bottom of the zone control unit. Supply airflow can enter the return air section 142 via a supply airflow inlet collar 164. A supply airflow damper 166 can be used to control the flow rate of the supply airflow flowing into the return air section 142. For example, the supply airflow damper 166 can be used in conjunction with an airflow probe to control and measure the flow rate of the supply airflow (e.g., outside air) that is input into the return air section, which can be used to provide better indoor air quality as well as control costs associated with the introduction of outside air (e.g., heating cost, cooling cost, humidity adjustment cost, etc.). The return air section 142 can include an access provision 168 (e.g., an access panel, a hinged access door) for access to the interior of the return air section (e.g., for maintenance, repair, etc.). The return air section 142 can include a return air temperature sensor 170 for monitoring the temperature of the mixed airflow. The temperature of the mixed airflow can be used to adjust system operational parameters. The return air section 142 can include an air filter 172 (e.g., a 2 inch pleated air filter) for filtering the mixed airflow prior to discharge from the return air section into the cooling coil section 144. The return air section can share a common footprint with the supply air section 150. A common damper can be used at two or more locations (e.g., a common 12 inch by 12 inch damper can be used for the return air dampers 158, 160, 162). The return air inlet collars 152, 154, 156 can be sized for an associated zone airflow requirement (e.g., CFM requirement). The return air section 72 can be configured such that the return air inlet collars 152, 154, 156 and the supply airflow inlet collar 164 are easily installable after the HVAC zone control unit has been installed to minimize shipping and installation damage. The return air section 142 can be insulated (e.g., with 1 inch engineered polymer foam insulation (EPFI)—closed cell insulation).

In many embodiments, a carbon dioxide (CO₂) sensor and/or a total organic volatile (TOV) sensor(s) are installed in the return air section 142 to sample the return airflows. The sensor(s) can be connected into a controller for the zone control unit for use in controlling the flow rate of supply air added to the return airflows and for controlling the rate of mixed airflow discharged to the zones serviced by the zone control unit. The sensor(s) can be installed in between the return air dampers to sample the return air as there is an invisible air curtain where the supply airflow (outside air) is coming in and mixing with the return airflows. Or a separate sensor(s) can be installed on each return air damper. By sensing the concentration of the measured compound (e.g., parts per million (ppm) of CO₂ and/or TOV(s)), the zone control unit can vary the rate of the supply airflow introduced to control the concentration of the measured compound. For example, when the concentration of CO₂ exceeds a specified level, the zone control unit can increase the flow rate of the supply airflow added to the return airflows (e.g., by opening the supply airflow damper and/or closing the return airflow dampers), and can also increase the flow rate of the mixed airflow discharged to the zones serviced by the zone control unit. The measured concentration levels can also be transmitted from one or more of the zone control units for external use. For example, for critical environments the concentration levels can be centrally monitored for use in making adjustments (e.g., by a central monitoring system, by a building operator, by a plant manager, etc.). With such an integrated sensor(s), the zone control units can employ the measured concentration levels to accomplish fine-tuned adjustments to operating parameters, thereby saving energy and providing excellent environmental control, which may be especially beneficial when critical environmental control is required.

The cooling coil section 144 receives air discharged by the return air section 142. The zone control unit and/or modular assembly may include a temperature reset with ECM pumps, fans, and the like, which may eliminate valves thereby reducing the pressure drop thereby providing better energy control. The cooling coil section 144 includes a cooling coil 174. The cooling coil 174 can use a cooled medium (e.g., cooled water, refrigerant) to absorb heat from the mixed airflow. In many embodiments, the cooling coil 174 employs micro-channel technology. The cooling coil 174 can be arranged in a variety of ways (e.g., a planar arrangement, a u-shaped arrangement, 180 to 360 degree arrangements, etc.). Arranging the cooling coil 174 for increased surface area provides for the ability to realize a more compact zone control unit. The cooling coil 174 can employ, for example, ⅜ inch copper tubes (or micro channel technology) for better heat transfer. The cooling coil 174 can employ high performance fins for better heat transfer. The cooling coil can employ fins that provide for a reduced pressure drop across the cooling coil as compared to industry standard coils, for example, seven to eight fins per inch can be used as compared to the industry standard of 10 fins per inch. In many embodiments, the cooling coil 174 is coupled with the chiller 20 (shown in FIG. 1) so that a cooling fluid (e.g., chilled water) is circulated between the chiller and the cooling coil 174 and heat is transferred from the mixed airflow to the chiller via the cooling fluid. The cooling coil section 144 can include a condensate pan and pump 176 (e.g., using plastic and/or aluminum construction to reduce or eliminate corrosion) for managing any condensate produced. The condensate pump can be factory installed. The condensate pump can be mounted and wired, and can be piped from a strainer and allow back flushing to reduce fouling and increase energy efficiency. The condensate pump can be wired to a control system and an alarm can be signaled if the condensate pump fails. An access provision 178 (e.g., an access panel, a hinged access door) can be provided for access to the interior of the cooling coil section for a range of purposes (e.g., inspection, access to the condensate pan and condensate pump, maintenance, access to coiling coil, cleaning of the cooling coil, repair, etc.). The cooling coil section 144 can be configured to produce a desired temperature drop in the airflow (e.g., a 30 degree Fahrenheit drop—entering airflow temperature at 80 degrees and a leaving airflow temperature at 50 degrees). The cooling coil section 144 provides for cooling local to the building zone as opposed to a large and expensive air handling unit. The cooling coil section 144 can be insulated (e.g., with 1 inch engineered polymer foam insulation (EPFI)—closed cell insulation).

The fan section 146 receives the mixed airflow from the cooling coil section 144. The fan section 146 includes a fan 180 driven by a motor 182. The motor 182 can be a known electric motor, for example, a variable speed motor (e.g., an ECM motor) for controlling the rate of the mix airflow through the HVAC zone control unit 140. The motor 182 can be a DC motor that can be run directly off of solar panels. Because the HVAC zone control unit provides for control over the air temperature of the mixed airflow discharged to the HVAC zones, an increased flow rate of the mixed airflow can be used, which increases the flow rate of the mixed airflow discharged into the building zones for better throw and mixing. The use of increased flow rate may help to reduce or eliminate stratification in the building zones serviced. The fan 180 can be a high efficiency plastic plenum or axial fan. The motor 182 can be an ECM motor for reduced energy usage and can be a variable speed ECM motor for adjusting the flow rate of the mixed airflow discharged to the building zone(s). Locating the fan section 146 between the cooling coil section 144 and the heating coil section 148 may provide for better acoustics. The use of a plenum fan may allow for better airflow velocity across the cooling coil and the heating coil. In the embodiment of FIG. 11, the fan section 146 draws the mixed airflow through the cooling coil and blows the mixed airflow through the heating coil. The use of a plenum fan may allow for a smaller footprint for the fan section 146. The fan section 146 can be insulated (e.g., with 1 inch engineered polymer foam insulation (EPFI)—closed cell insulation). Another fan section can be employed in series with the fan section 146, for example, downstream of the filters. Such an additional fan section can be used to account for an additional amount of pressure drop associated with HEPA and/or ultra low particle air (ULPA) filters, which may be used in certain applications such as laboratory applications. In some embodiments, an HVAC unit can be manufactured with an integrated fan 180. Exemplary fan mechanisms may include a motor 182 such as an electronically commutated motor (ECM) motor. Motor 182 can operate to control or modulate air flow across a thermal transfer device or coil of an HVAC unit. Hence, fan 180 can provide a selected air flow rate through an HVAC unit, so as to achieve a desirable energy savings or comfort protocol. As shown in FIG. 11, at least a portion of a thermal transfer mechanism such as coil 174 can be placed along an air flow path 187 within a casing 145 (e.g at coil section 144) such that at least a portion of an inlet piping assembly and at least a portion of an outlet piping assembly coupled with the coil are disposed exterior to the casing. Relatedly, fan 180 can be positioned along the airflow path 187 within casing 145 (e.g. at fan section 146). The use of ECM pumps and/or ECM fans may provide for a variety of controls strategies based off a temperature reset algorithm, strategy, and/or equipment. For example, the cubic feet per minute (CFM) of air and/or the gallons per minute (GPM) of fluid may be adjusted based on the temperature and heating or cooling needs. The CFM may be increased with the GPM is increased, held constant, or decreased. Similarly, the GPM may be increased with the CFM is increased, held constant, or decreased. The variance of the CFM and/or GPM provide multiple energy savings options and heating/cooling options.

The fan section 146 discharges the mixed airflow into the heating coil section 148, which contains a heating coil 184. The heating coil 184 can be coupled with the boiler 18 (shown in FIG. 1) so that a heating fluid (e.g., heated water) is circulated between the boiler and the heating coil and heat is transferred into the mixed airflow from the boiler via the heating fluid. In many embodiments, the heating coil 184 employs micro-channel technology. The heating coil 184 can be arranged in a variety of ways (e.g., a planar arrangement, a u-shaped arrangement, 180 to 360 degree arrangements, etc.). Arranging the heating coil 184 for increased surface area provides for the ability to realize a more compact unit. The heating coil 184 can employ, for example, ⅜ inch copper tubes for better heat transfer. The heating coil can employ high performance fins for better heat transfer. The heating coil can employ fins that provide for a reduced pressure drop across the heating coil as compared to industry standard coils, for example, seven to eight fins per inch can be used as compared to the industry standard of 10 fins per inch. The heating coil section 148 can be configured to produce a desired temperature rise in the airflow (e.g., a 30 degree Fahrenheit rise—entering airflow temperature at 70 degrees and a leaving airflow temperature at 100 degrees). The heating coil section 148 can be insulated (e.g., with 1 inch engineered polymer foam insulation (EPFI)—closed cell insulation).

The mixed airflow is discharged from the heating coil section 148 into the supply air section 150. The supply air section 150 can include a high efficiency particulate air (HEPA) filter 186. The supply air section 150 can include a humidity sensor 188 and can include a supply air temperature sensor 190. An access provision 192 (e.g., an access panel, a hinged access door) can be provided for access to the interior of the supply air section (e.g., for maintenance, repair, etc.). Supply airflows are discharged from the supply air section 150 to one or more serviced building zones via one or more supply air outlet collars 194, 196, 198. The supply air section 150 can include one or more actuated supply air dampers 200, 202, 204 for controlling the airflow rate through the supply air outlet collars 194, 196, 198, respectively, which provides for better control of airflow to the associated zone. For example, a supply air damper 200, 202, 204 can be closed when the associated zone is not occupied. The supply air dampers 200, 202, 204 can be configured with damper shafts located on the bottom of the HVAC zone control unit 140 for access from the bottom of the zone control unit. The supply air section can share a common footprint with the return air section 142. A common damper can be used at two or more locations (e.g., a common 12 inch by 12 inch damper can be used for the supply air dampers 200, 202, 204). The supply air outlet collars 194, 196, 198 can be sized for associated zone airflow requirements. The supply air section can be configured such that the supply air outlet collars 194, 196, 198 are easily installable after the HVAC zone control unit has been installed to minimize shipping and installation damage. The supply air section can be insulated (e.g., with 1 inch engineered polymer foam insulation (EPFI)—closed cell insulation).

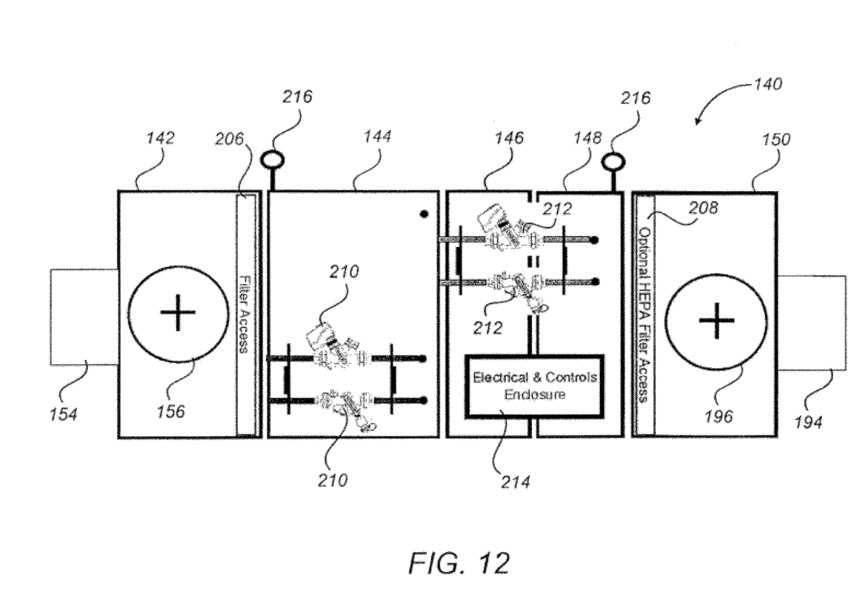

FIG. 12 is a side view diagrammatic illustration of the HVAC zone control unit 140 of FIG. 11. As further illustrated by FIG. 12, the return air section 142 can include a filter access provision 206 for access to the air filter 172 (shown in FIG. 11). Likewise, the supply air section 150 can include an access provision 208 for access to the HEPA filter 186. Cooling fluid control valves 210 can be used to control the circulation of cooling fluid between the cooling coil 174 (shown in FIG. 11) and the chiller 20 (shown in FIG. 1). The control valves 210 can be modulating control valves to provide for variable control of the temperature drop produced in the cooling coil section 144 so as to provide variable control of the temperature of the air supplied to the building zones services by the HVAC zone control unit 140. Likewise, heating fluid control valves 212 can be used to control the circulation of heating fluid between the heating coil 184 (shown in FIG. 11) and the boiler 18 (shown in FIG. 1). Instead of or in addition to the boiler, the heating fluid may be provided by geothermal sources, a heat pump, and or DX/water source. The control valves 212 can be modulating control valves to provide for variable control of the temperature increase produced in the heating coil section 148 so as to provide variable control of the temperature of the air supplied to the building zones services by the HVAC zone control unit 140. Alternatively, variable rate water pumps, for example, variable rate water pumps employing an ECM motor, can be employed to regulate the rate at which cooled water is circulated through the cooling coil section 144 and to regulate the rate at which heated water is circulated through the heating coil section 148. This may provide faster response time, variable flow, and/or complete or near complete shut off. The HVAC zone control unit 140 can include an electrical and controls enclosure 214 for housing HVAC zone control unit related electrical and controls components. The HVAC zone control unit 140 can include one or more mounting provisions 216.

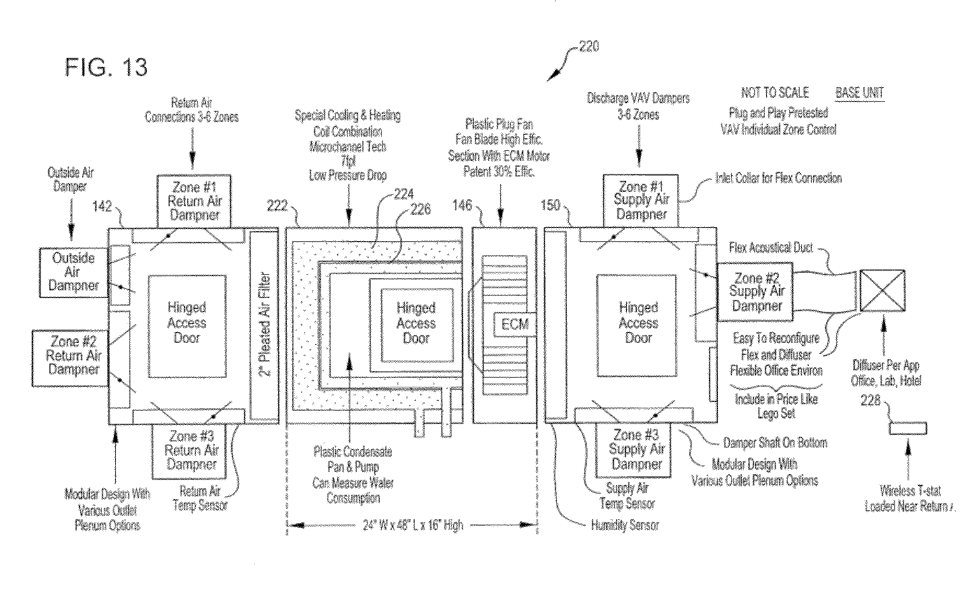

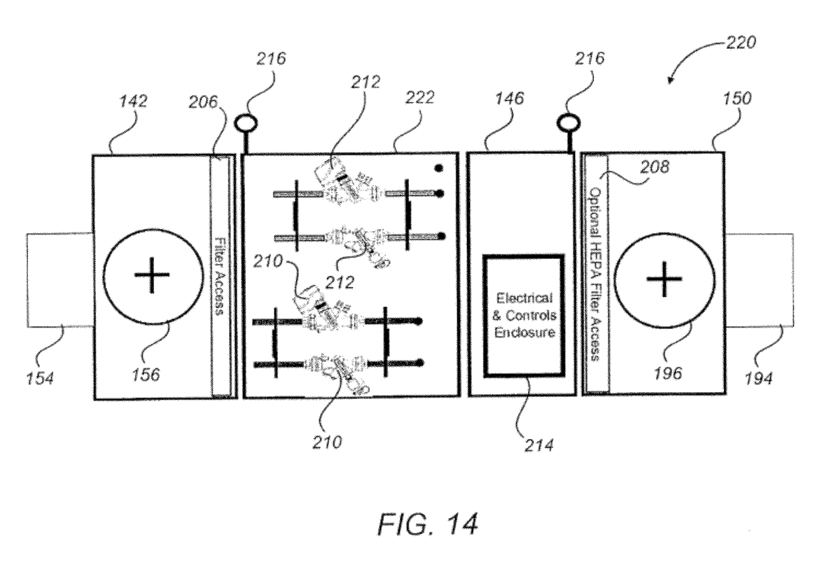

FIG. 13 is a top view diagrammatic illustration of an HVAC zone control unit 220, in accordance with many embodiments, that includes a combined heating/cooling section 222 in place of the separate cooling section 144 and heating section 148 discussed above with reference to FIGS. 11 and 12. The HVAC zone control unit 220 includes the above discussed return air section 142, fan section 146, and supply air section 150, which can contain the above discussed related components. The combined heating/cooling section 222 can include a cooling coil 224 and a heating coil 226, which as discussed above with reference to HVAC zone control unit 40, can employ micro-channel technology. The use of micro-channel technology may result in a decreased pressure drop across the cooling and heating coils. A wireless thermostat 228 can be used to provide for control of the HVAC zone control unit. FIG. 14 is a side view of the HVAC zone control unit 220, showing the location of components that were discussed above with reference to FIGS. 11, 12, and 13.

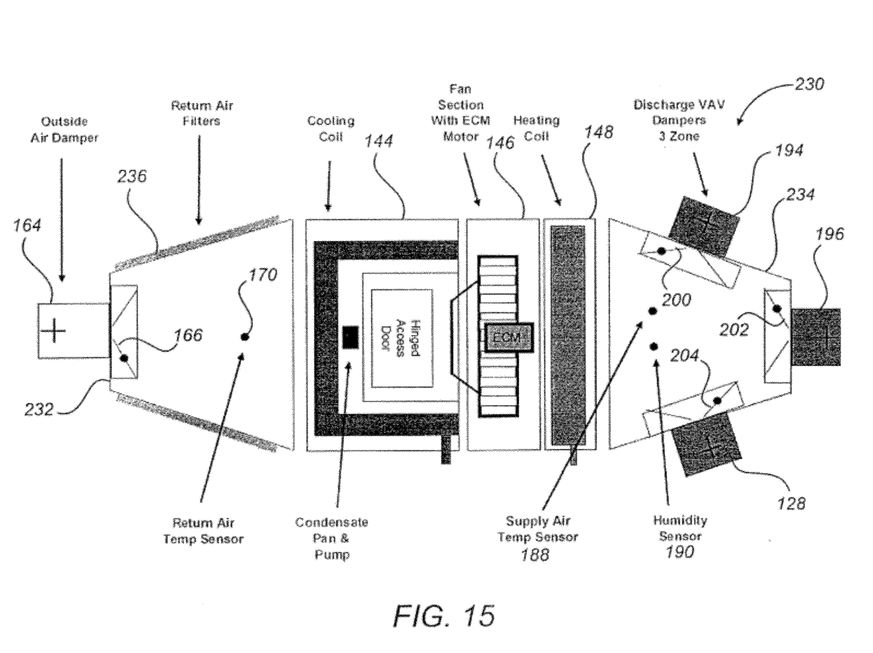

FIG. 15 is a top view diagrammatic illustration of an HVAC zone control unit 230, in accordance with many embodiments, that includes a return air section 232 with a direct return airflow intake and a supply air section 234. The HVAC zone control unit 230 includes the above discussed cooling coil section 144, fan section 146, and heating coil section 148, which can contain the above discussed related components. The return air section 232 can share a common footprint with the supply air section 234. The return air section 232 includes return air filters 236 disposed on the exterior surface of the return air section. For example, the return air filters 236 can partially or completely surround the return air section. The return air section 232 can be conically shaped, which may serve to produce desired airflow patterns due to the increasing cross-sectional area of the return air section in the direction of airflow, which corresponds to the increased amount of airflow at the exit of the return air section as compared to the beginning of the return air section. The return air section 232 can include above discussed components (e.g., the labeled components). The supply air section 234 can be conically shaped, which may serve to produce desired airflow patterns due to the decreasing cross-sectional area of the supply air section in the direction of airflow, which corresponds to a decreased amount of airflow just prior to the supply air outlet collar 196 as compared to the beginning of the supply air section. The supply air section 234 can include above discussed components (e.g., the labeled components). The return air section 232 and the supply air section 234 can share a common footprint, which may provide for the use of common components.

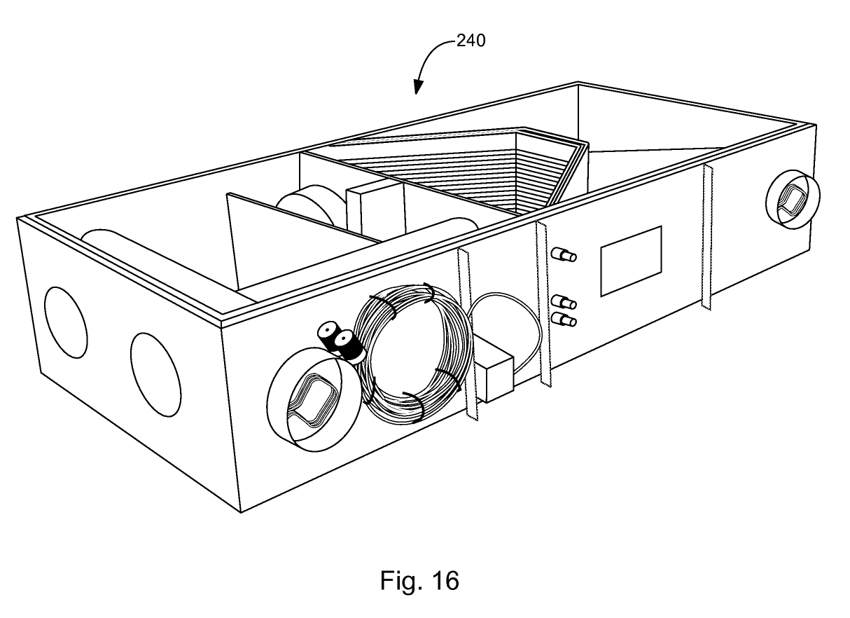

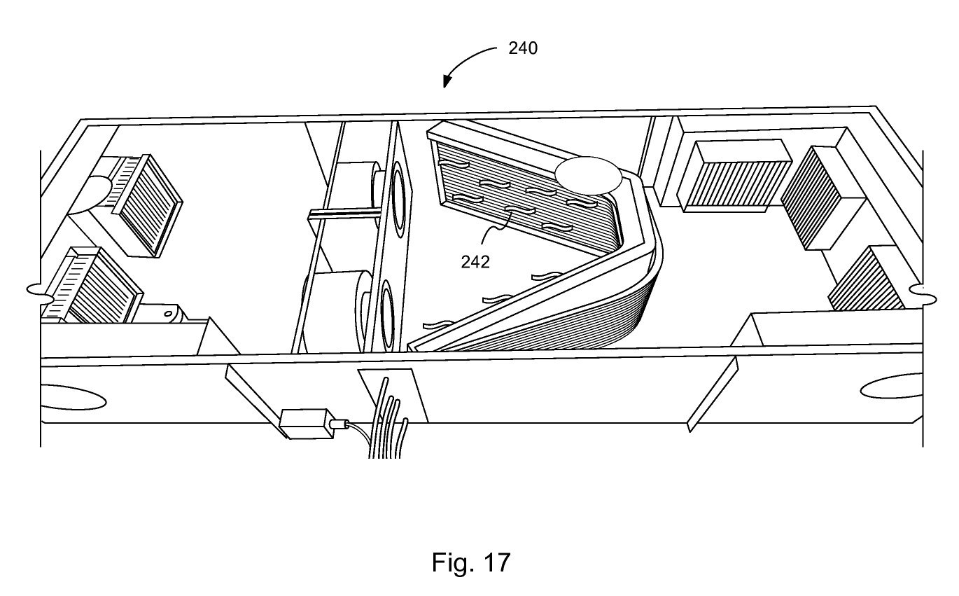

FIG. 16 is a photograph of a prototype zone control unit 240 having a transparent top panel installed to allow viewing of airflow during testing. FIG. 17 is another photograph of the prototype zone control unit 240, showing internal components and flow strips 242 employed during testing.

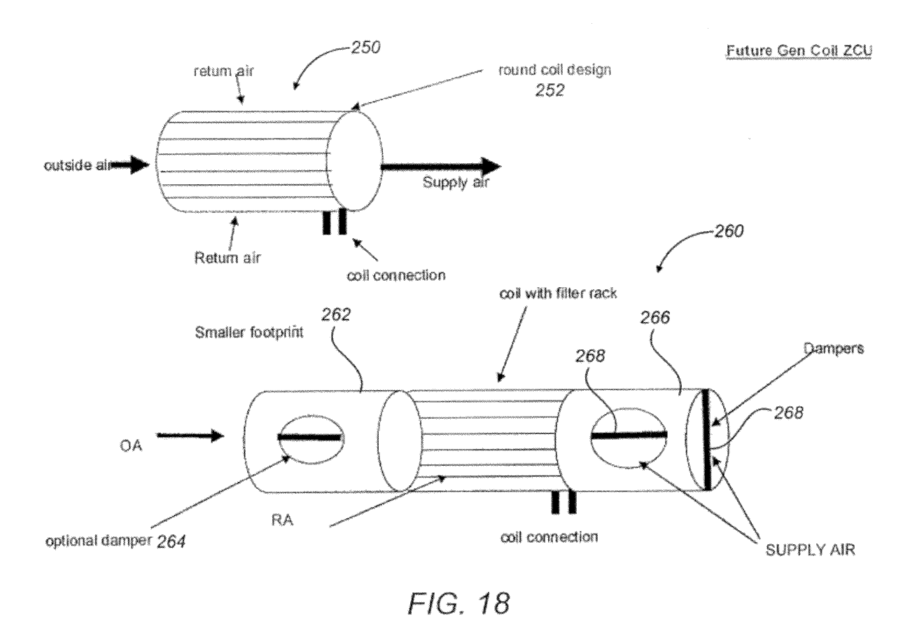

FIG. 18 illustrates an HVAC zone control unit 250 and an HVAC zone control unit 260, in accordance with many embodiments. The HVAC zone control unit 250 includes a round coil 252 that provides for direct intake of a return airflow. A supply airflow (e.g., outside air) enters at one end, is mixed with the return airflow to form a mixed airflow, and the mixed airflow exits from the other end of the zone control unit 250. The amount of heat added to, or removed from, the mixed airflow can be used to control the temperature of the mixed airflow as desired. The HVAC zone control unit 260 further includes a supply airflow intake collar 262 that houses an optional supply airflow control damper 264 for controlling the flow rate of the supply airflow (e.g., outside airflow) used. The HVAC zone control unit 260 further includes a supply airflow section 266 that houses one or more mixed airflow dampers 268 for controlling the flow rate of the mixed airflow discharged to one or more serviced building zones.

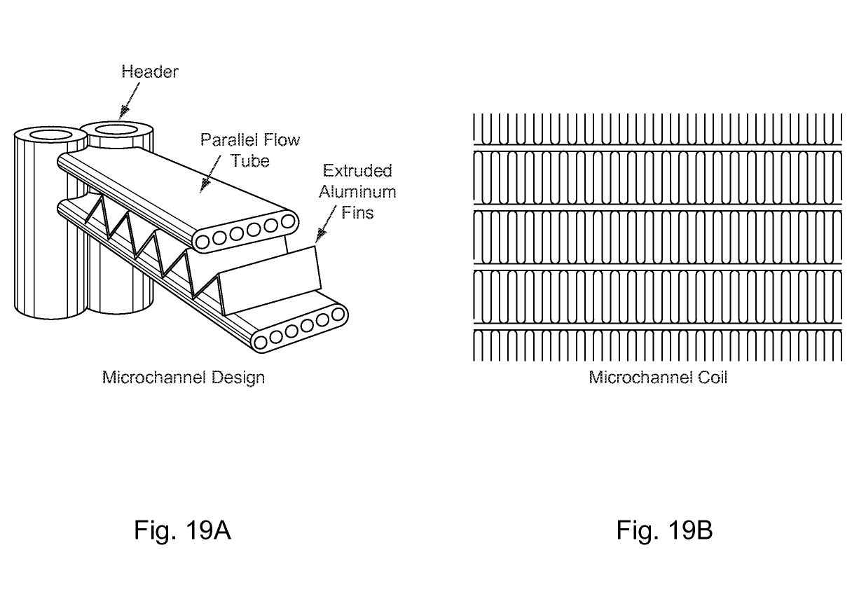

FIGS. 19A and 19B illustrate micro-channel coils that can be used as discussed above. A micro-channel coil can include a plurality of parallel flow tubes through which a working fluid is transferred between headers and enhanced fins for transferring heat to or from the parallel flow tubes to the airflow via enhanced fins, for example, aluminum fins. As discussed above, a micro-channel coil heat exchanger coil can employ a fin arrangement that provides for reduced pressure drop across the coil as compared to industry standard coils, for example, seven to eight fins per inch can be used as compared to the industry standard of 10 fins per inch.

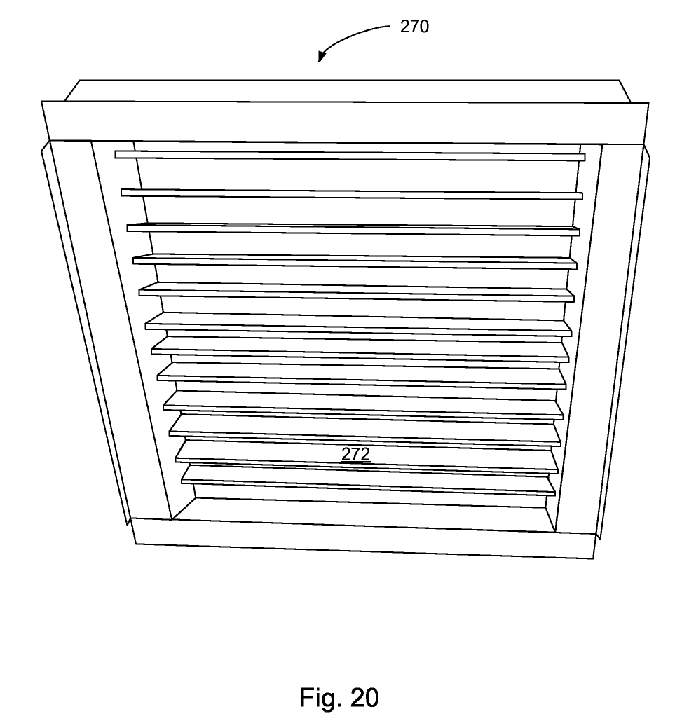

FIG. 20 illustrates a control damper 270 for an HVAC zone control unit. The control damper 270 includes an array of louvers 272 that are controllably actuated to vary the flow rate of the respective airflow through the control damper 270 under the control of a control unit for the zone control unit.

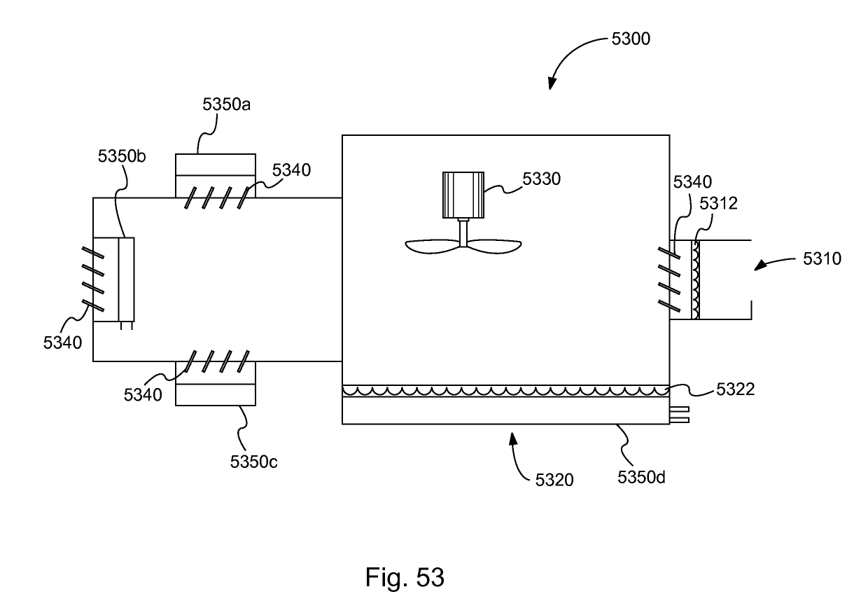

FIG. 53 illustrates another configuration of a ZCU. The ZCU may include one or more dampers. Positioned adjacent the one or more dampers may be a thermal transfer unit(s) that may be pre-piped with valves, pumps. The thermal transfer unit(s) may ship under pressure. Disposed within the ZCU may be a fan. The ZCU may include a port to receive return air. Positioned adjacent or near the return air port may be a thermal transfer unit(s) that may be pre-piped with valves, pumps, and the like. The thermal transfer unit(s) may ship under pressure. Positioned adjacent or near the thermal transfer unit(s) may be a filter. The ZCU may also include a port to receive outside air. A filter may be positioned adjacent or near the outside air port.

Distribution System Configurations

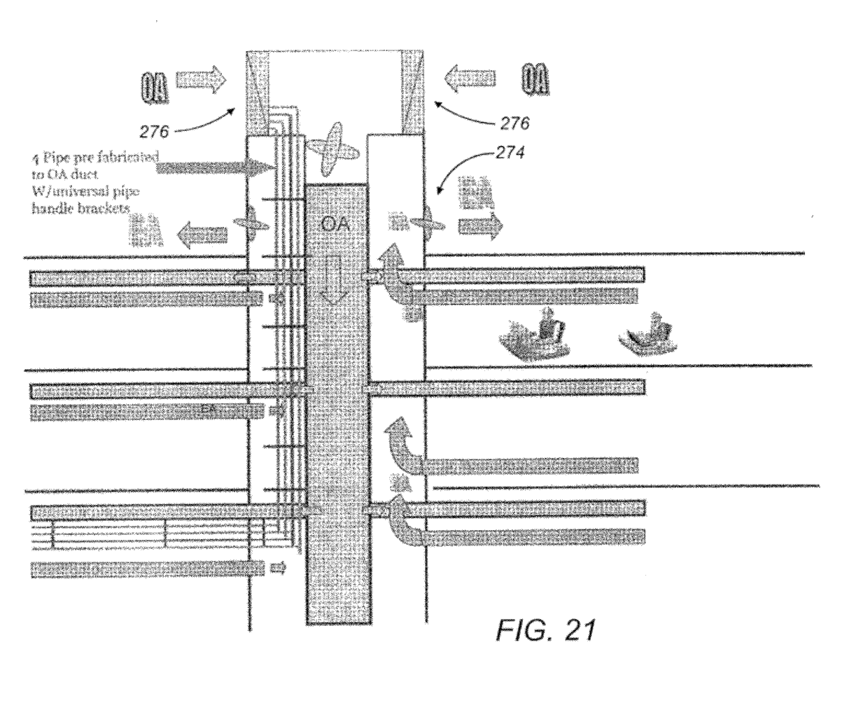

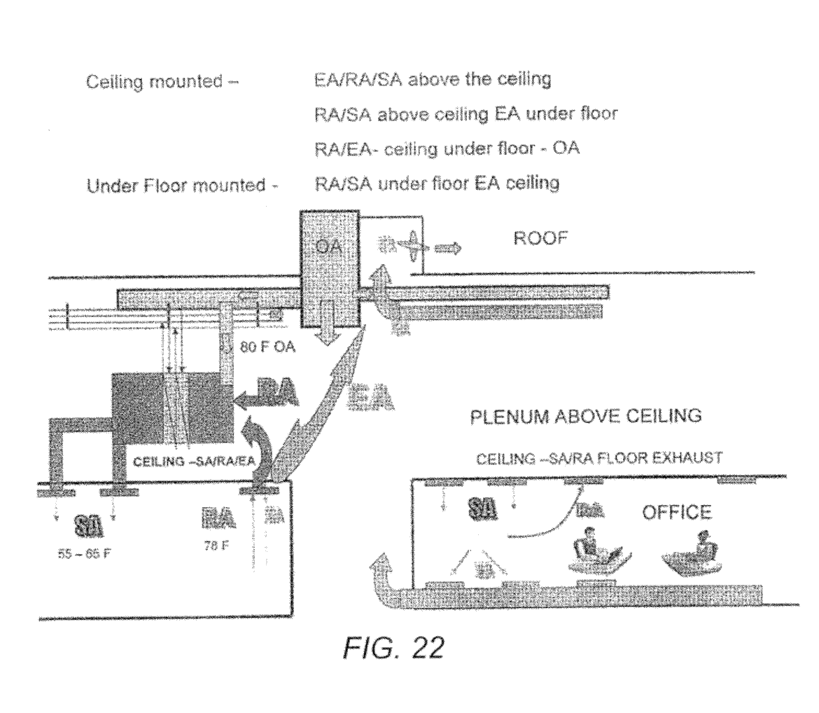

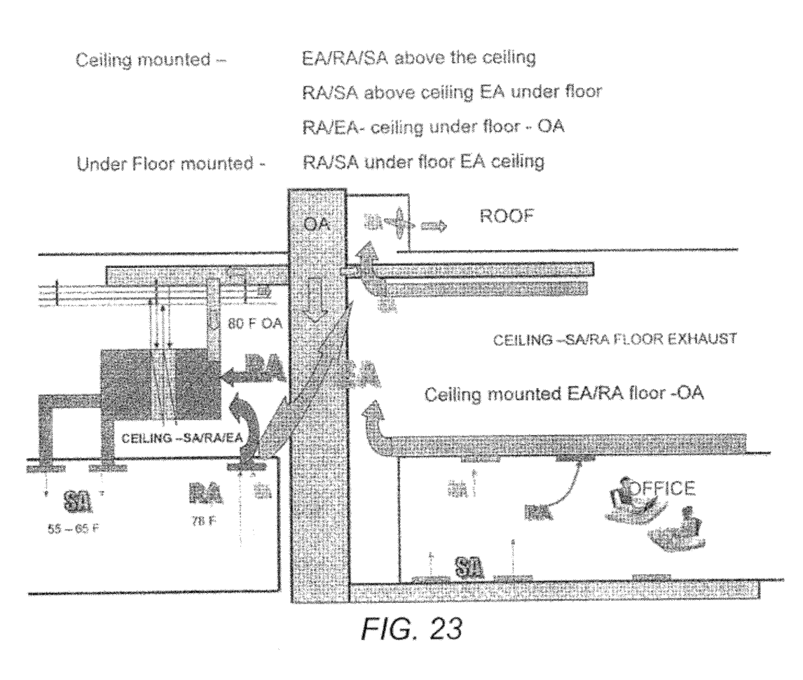

FIG. 21 through FIG. 23 illustrate a number of distribution system configurations that can be used for the routing of the supply airflow (e.g., outside air), the mixed airflows discharged to the serviced zones, the return airflows, and the exhaust airflows. For example, as illustrated in FIG. 21, the horizontally-oriented distribution assemblies used to service the zones on a building floor can be ceiling mounted and the exhaust airflows (EA) from the serviced zones can be discharged into a vertical shaft of the building (e.g., a vertical shaft where the vertically-oriented distribution assembly is installed) for subsequent discharge from the vertical shaft to outside of the building via an exhaust airflow outlet 274. The exhaust airflow outlet 274 can be suitably separated from one or more outside air inlets 276 used to intake outside air for delivery to the distributed zone control units. As illustrated in FIG. 22 and FIG. 23, the mixed airflow can be introduced into the serviced zones from ceiling mounted diffusers and/or floor mounted diffusers, and the exhaust airflows can be extracted from the ceiling and/or the floor.

HVAC Zone Control Unit Control System

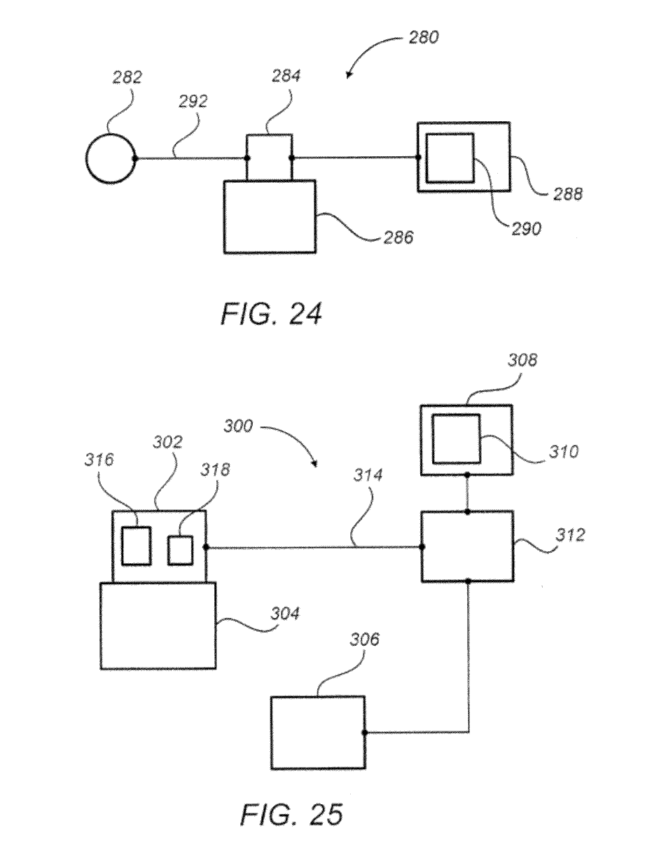

FIG. 24 illustrates a control system 280 for an HVAC zone control unit. The control system 280 includes a thermostat 282, a local control unit 284 configured to control an HVAC zone control unit 286, and a computer 288 hosting a building automation control program 290. The computer may operate as part of a main frame computing system, data center, cloud computing system, and the like. The thermostat 282 is coupled with the local control unit 284 via a communication link 292. The local control unit 284 communicates with the computer 288 via a communication link 294. The control system 280 can be used to control the above described HVAC zone control units. Aspects of additional control systems that can be used to control the above described HVAC zone control units are described in numerous patent applications and publications, for example, in U.S. Patent Publication No. 2009/0062964, filed Aug. 27, 2007; U.S. Patent Publication No. 2009/0012650, filed Oct. 5, 2007; U.S. Patent Publication No. 2008/0195254, filed Jan. 24, 2008; U.S. Patent Publication No. 2006/0287774, filed Dec. 21, 2006; U.S. Pat. No. 7,343,226, filed Oct. 26, 2006; U.S. Pat. No. 7,274,973, filed Dec. 7, 2004; U.S. Pat. No. 7,243,004, filed Jan. 7, 2004; U.S. Pat. No. 7,092,794, filed Aug. 15, 2006; U.S. Pat. No. 6,868,293, filed Sep. 28, 2000; and U.S. Pat. No. 6,385,510, filed Dec. 2, 1998, the entire disclosures of which are hereby incorporated herein by reference.

FIG. 25 illustrates a control system 300, in accordance with many embodiments, for an HVAC zone control unit, for example, the above described HVAC zone control units. The control system 300 includes an HVAC local control unit 302 configured to control an HVAC zone control unit 304; and one or more external control devices (e.g., an internet access device 306 (for example, laptop, PDA, etc.), a remote server 308 hosting an HVAC control program 310). In many embodiments, the local control unit 302 has its own Internet Protocol (IP) address. The local control unit 302 receives commands from and can supply data to the one or more external control devices via the Internet 312. The local control unit 302 is connected to the Internet 312 via a communication link 314. The communication link 314 can be a hard-wired communication link and can be a wireless communication link. In many embodiments comprising a wireless communication link 314, the local control unit 302 comprises wireless communication circuitry 316 for communicating over the Internet 312 via ZigBee communication protocol and 900 MHz frequency hopping and 802.11 WIFI WiFi X open protocol. In many embodiments, the local control unit 302 comprises a temperature sensor 318. The one or more external control devices can be used to access the IP address for the local control unit 302, optionally enter security information (e.g., user IDs, passwords, security code, etc), and adjust control variables (e.g., temperature, etc.). The control system 300 provides for the elimination of the thermostat and/or provides for remote control of the HVAC zone control unit, and enables both local and/or remote hosting of HVAC control programs. For example, the local control unit 302 can include a memory and processor for storing and executing a control program for the HVAC zone control unit 304. The control unit 302 may also include a sensor pak(s) for lights, HVAC, power management, and the like. The communication circuitry 316 comprising ZigBee communication protocol and 900 MHz frequency hopping provides a universal board application with open protocol and/or Wi Fi open protocol that would allow the use of these technologies based on application.

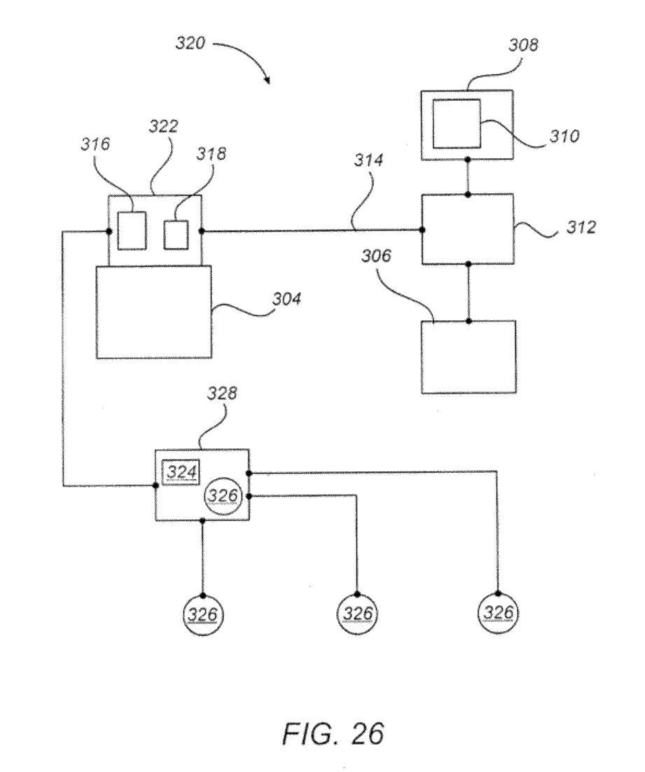

FIG. 26 illustrates a control system 320 for an HVAC zone control unit that includes a local control unit 322 that receives input from a zone mounted sensor(s) 324 and controls zone lights 326, in accordance with many embodiments. The control system 320 may allow for building automation system (BAS) hardware to be preinstalled, which may eliminate the need for field labor installation. The control system 320 (e.g., BAS system) may provide a single software integration platform for all, some, or a majority of the building utilities. The control system 320 includes components used in the control system 300 of FIG. 25, as designated by the like reference numbers used. In addition, the control system 320 further includes the zone mounted sensor(s) 324 and/or one or more of the zone mounted lights 326. For example, the sensor(s) 324 and/or one or more of the zone mounted lights 326 can be mounted on a ceiling mounted return airflow diffuser 328 in one or more building zones serviced by the HVAC zone control unit. The local control unit 322 can be configured to provide control of the zone lights 326, and can be configured to monitor power consumption of the zone lights 326. Thus, the local control unit 322 can control all the HVAC and lights for a serviced zone(s) and also measure the corresponding power consumption for the serviced zone(s). The HVAC, lighting, and/or power consumption information/data can be transferred over the Internet 222 and disseminated, thereby providing occupant level information/data that can be used to control the occupant's zone and implement energy efficient strategies via the remote server 218 or the internet access device 216. The control system 320 enables zone based billing based on zone energy consumption. An application(s) can also be implemented (e.g., on the remote server 218 and/or on an internet access device 216) for the tenant to monitor energy consumption and/or implement energy-efficient HVAC and/or lighting strategies. Such an application(s) can show energy usage and utility rates so that the HVAC and/or the lighting in the zone can be managed commensurate to energy costs during peak and/or off peak hours of the day.

The sensor(s) 324 can include one or more types of sensors (e.g., a temperature sensor, a humidity sensor, a carbon-dioxide (CO₂) sensor, a photocell, a motion detector, an infrared sensor, one or more total organic volatile (TOV) sensors, etc.). For example, a CO₂ sensor and/or a total organic volatile (TOV) sensor(s) can provide concentration measurement information for a measure compound to the local control unit 212, which can use the concentration measurements to control the operation of the zone control unit, and can communicate the concentration measurements over the Internet 222, for example, to the remote server 218 and/or to the internet access device 216. A motion sensor and/or an infrared sensor can be employed to tailor the operation of the zone control unit in response to room occupancy.

A zone control unit control system can also be configured to provide additional functionality. For example, a control system can provide built in controls features such as tracking utility cost, logging of equipment run time for use in related maintenance and/or replacement of the equipment monitored, tracking of zone control unit operating parameters for use in setting boiler and/or chiller operating temperatures, tracking zone control unit operational parameters for use in trend analysis, etc. The control system may monitor and/or report BTUH and/or KW consumption.

HVAC Methods

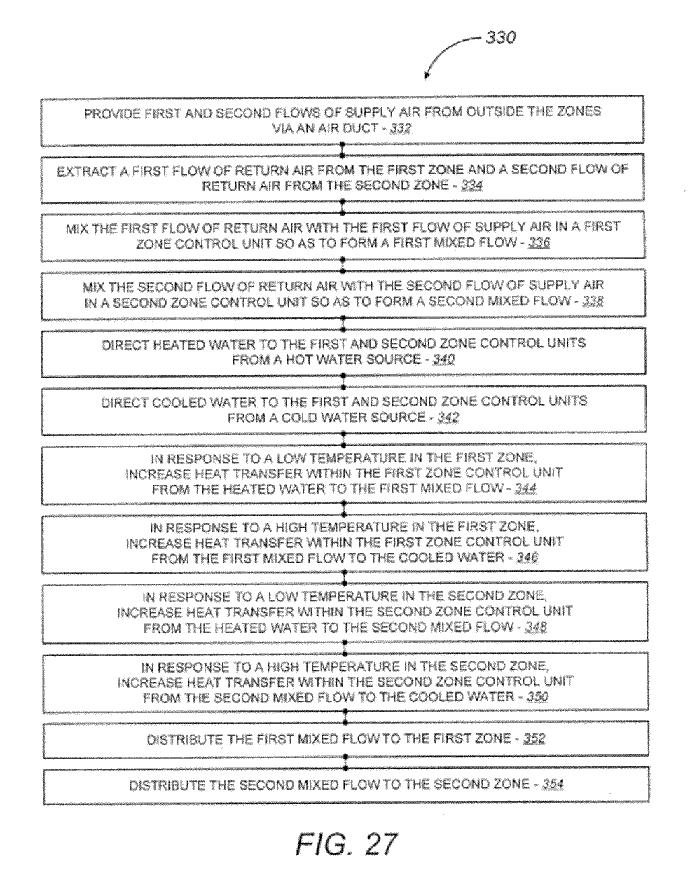

FIG. 27 is a simplified diagrammatic illustration of a method 330 for providing HVAC to zones of a building using distributed zone control units, in accordance with many embodiments. In the method 330, a first zone control unit is used to service a first zone of the building zones, and a second zone control unit is used to service a second zone of the building zones. In step 332, first and second flows of supply air from outside the zones are provided via an air duct. In step 334, a first return airflow is extracted from the first zone and a second return airflow is extracted from the second zone. In step 336, the first return airflow is mixed with the first supply airflow in the first zone control unit so as to form a first mixed flow. In step 338, the second return airflow is mixed with the second supply airflow in the second zone control unit so as to form a second mixed flow. In step 340, heated water is directed to the first and second zone control units from a hot water source (e.g., a boiler). In step 342, cooled water is directed to the first and second zone control units from a cold water source (e.g., a chiller). In step 344, in response to a low temperature in the first zone, heat transfer within the first zone control unit is increased from the heated water to the first mixed airflow. In step 346, in response to a high temperature in the first zone, heat transfer within the first zone control unit is increased from the first mixed airflow to the cooled water. In step 348, in response to a low temperature in the second zone, heat transfer within the second zone control unit is increased from the heated water to the second mixed flow. In step 350, in response to a high temperature in the second zone, heat transfer within the second zone control unit is increased from the second mixed flow to the cooled water. In step 352, the first mixed flow is distributed to the first zone. And in step 354, the second mixed flow is distributed to the second zone. The above-described zone control units can be used in practicing the method 330.

HVAC Zone Control Unit Control Methods

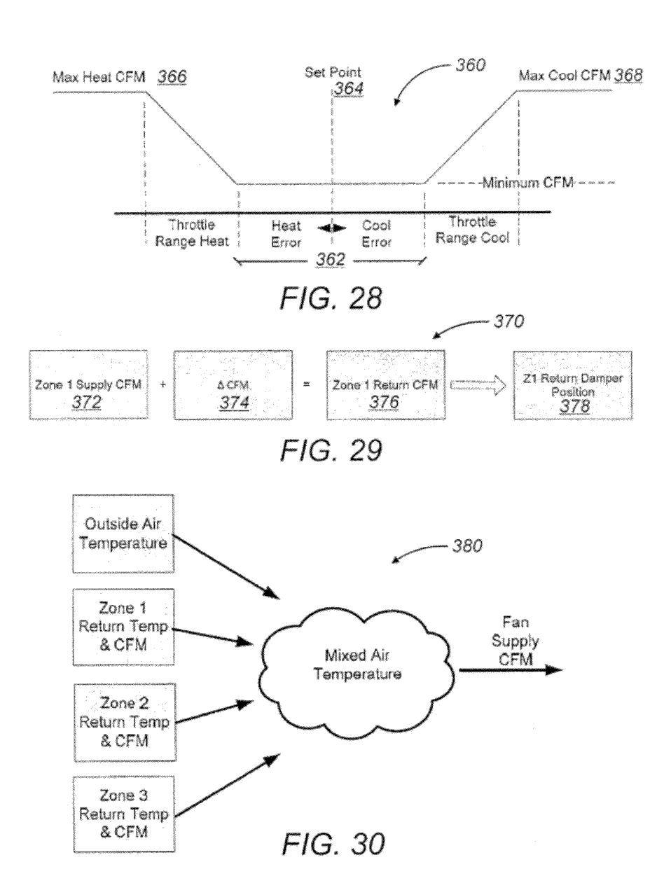

FIGS. 28 through 34 illustrate control algorithms that can be used to control the above-described HVAC zone control units, in accordance with many embodiments. Stand alone independent zones may be configured to work only where there are people, a demand, and/or occupancy. This may significantly reduce the energy footprint of the building. FIG. 28 illustrates a control algorithm 360 that is used to control the speed at which the zone control unit fan(s) operates and the position of the airflow dampers through which the mixed airflow is discharged to the building zones serviced by the HVAC zone control unit. When the measured temperature of the service zoned falls within a specified band 362 encompassing a current temperature set point 364 for the serviced zone, the fan speed(s) and the discharge airflow damper for the serviced zone are set to deliver a minimum airflow rate of the mixed flow to the serviced zone. When the measured temperature of the serviced zone falls outside the specified band 362, the fan speed(s) and the discharge airflow damper position are adjusted to deliver increased flow rates up to the applicable maximum flow rate 366, 368 as a function of the temperature variance involved as illustrated. The control algorithm 360 is implemented in independent loops, one loop for each zone serviced by the zone control unit. Accordingly, the fan speed(s) are set to discharge the mixed flow at a rate equal to the combined rates called for by the serviced zones, and the discharge airflow dampers for the serviced zones are set to distribute the mixed flow according to the determined flow rates for the respective serviced zones.

FIG. 29 illustrates a control algorithm 370 used to control zone pressurization. The algorithm 370 takes the zone discharge airflow rate 372 (i.e., the flow rate that the mixed flow is discharged to the zone) and adds a flow rate offset 374 (which can be either a positive or negative flow rate offset) to obtain a return airflow rate 376 for the zone. The calculated return airflow rate 376 is then used to calculate a return airflow damper position 378 for the zone.

FIG. 30 illustrates an algorithm 380 used to calculate the rate of supply airflow (outside air) that is mixed with the return airflows based on occupancy and space pressurization requirements. The algorithm 380 also establishes minimum rates of the mixed flow discharged to each of the zones serviced by the zone control unit. The minimum zone mixed flow discharge rate can be based on the number of people in the zone. For example, the minimum mixed for discharge rate for a zone (in units of cubic feet per minute (CFM)) can be equal to the flow rate offset 374 of FIG. 29 added to the number of people associated with the zone times 10. The resulting flow rates of the supply airflow and the return airflow rates from each of the serviced zones can be used in combination with the respective temperatures of the supply airflow and the return airflows to determine the temperature of the mixed flow transferred to the heat exchanging coils of the zone control unit. A psychometric chart algorithm(s) may be written into the program for optimum indoor air quality commensurate with a heat transfer coefficient of the thermal transfer units/coil and psychometric chart parameters. This may allow for tight control of temperatures resulting in energy and/or cost savings.

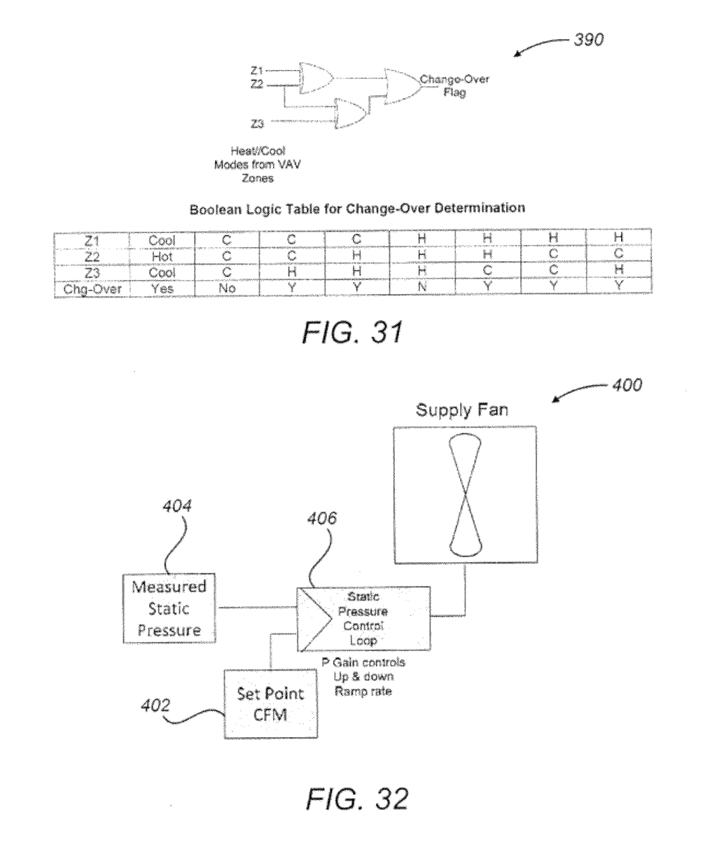

FIG. 31 illustrates an algorithm 390 used to determining whether to operate an HVAC zone control unit so as to provide both heating and cooling to zones serviced by the zone control unit. In some instances, the zones serviced by a zone control unit may have conflicting heating/cooling requirements. For example, one serviced zone may have a current temperature and a thermostat setting requiring heat to be added to the zone, while another serviced zone may have a current temperature and a thermostat setting requiring heat to be extracted from the zone. In such an instance, the zone control unit can be operated in a change-over mode in which the mixed flow is alternately heated and cooled and the discharge of the mixed flow is controlled to discharge the heated mixed flow primarily to the zone(s) requiring heat and to discharge the cooled mixed flow primarily to the zone(s) requiring the removal of heat. For example, the flow rate discharged to a particular zone can be maximized when the mode of the zone control unit matches the heating/cooling requirements of the zone and can be minimized when the mode of the zone control unit disagrees with the heating/cooling requirements of the zone. Because zone pressurization may require that a minimum mixed airflow rate be discharged to each zone at all times, a certain amount of reheating and/or re-cooling of the serviced zones may result. To account for this, the zone control unit can be configured with an increased heating/cooling capacity to account for the resulting additional reheating and re-cooling requirements. The algorithm 390 can be periodically executed (e.g., every 10 minutes) to change over between heating and cooling if such a mixed heating/cooling requirement is present. In the absence of such a mixed heating/cooling requirement, the zone control unit remains in the applicable heating/cooling mode.

FIG. 32 illustrates an algorithm 400 for controlling the speed of the supply fan(s) used to discharge the mixed airflow to the serviced zones. The supply fan(s) speed 402, determined in the algorithm 360 of FIG. 28, along with a measured static pressure 404 (if employed) are fed into a static pressure control loop 406 that adjusts the supply fan(s) speed 402 up or down according to a standard variable air volume static pressure loop. A static pressure set point can be set at a suitable level just high enough to overcome variable air volume box static pressure drop (e.g., 0.3 inch H₂O). A P gain or ramp function can be used to minimize noise due to changing fan speed during a heating/cooling mode changeover.

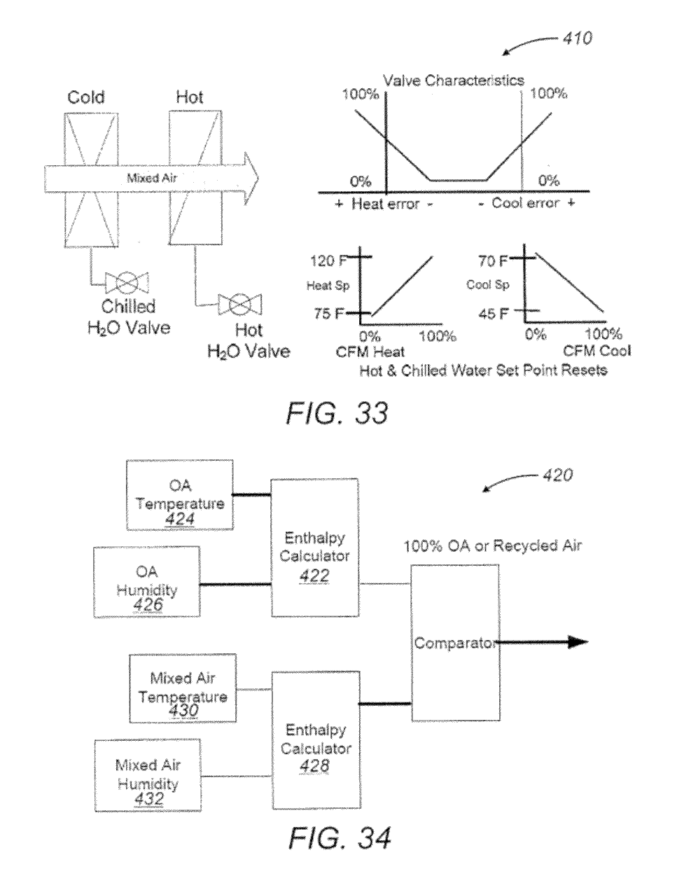

FIG. 33 illustrates an algorithm 410 for controlling the flow rates of heated and cooled water through the heat exchanging coils of an HVAC zone control unit. The flow rates of the heated and cooled water can be controlled via controllable valves and/or via variable flow rate pumps (e.g., a pump with the highly efficient electronically commutated permanent magnet motor (ECM technology)). The algorithm 410 can also be used to control the temperatures of the heated and cooled water directed to the distributed zone control units based on the heating/cooling requirements of one or more of the distributed zone control units.

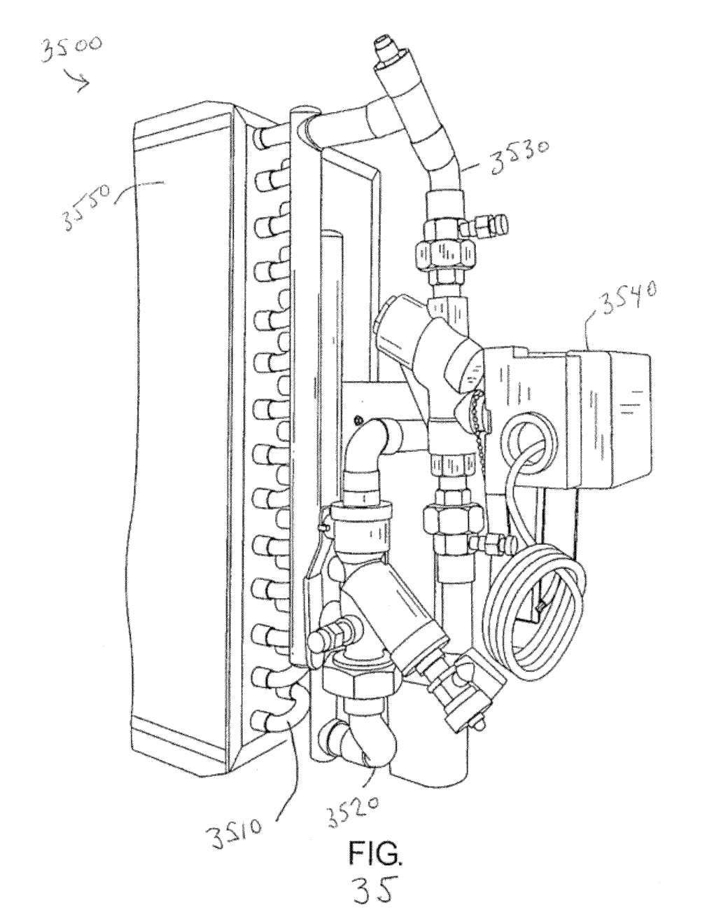

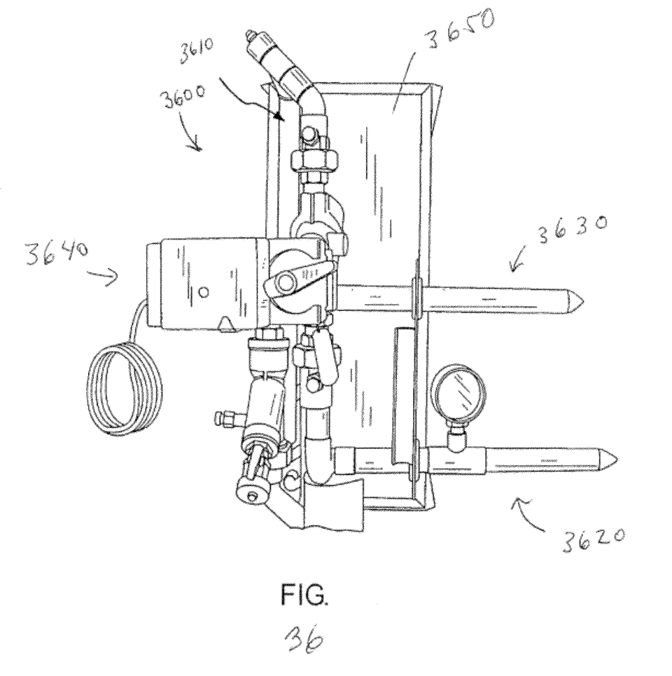

FIG. 34 illustrates an algorithm 420 for controlling an HVAC zone control unit to reduce energy consumption via the selection of flow rates for the return airflow and the supply airflow. A supply airflow enthalpy calculator 422 calculates the enthalpy of the supply airflow based on the supply airflow temperature 424 and the supply airflow humidity 426. Similarly, a return airflow enthalpy calculator 428 calculates the enthalpy of the mixed airflow based on the mixed airflow temperature 430 and the mixed airflow humidity 432. The calculated results can be used to select the airflows so as to minimize energy usage (e.g., by selecting the lowest energy airflow to maximize when cooling is called for and by selecting the highest energy airflow to maximize when heating is called for). Enthalpy can be calculated and/or looked up from a table. While enthalpy can be calculated from temperature and relative humidity as these quantities may be the least expensive to commercially measure, dew point, grains, and wet bulb can also be used. The algorithm 420 may not be usable when return air space pressurization is in use due to the lack of mechanism by which a zone control unit can dump excess air to the outdoors. Such a dumping of excess air to the outdoors can instead be accomplished via an exhaust fan(s).

FIG. 35 shows an HVAC unit 3500 packaged with ancillary components, including a thermal transfer mechanism 3510, an inlet piping assembly 3520, an outlet piping assembly 3530, and an embedded pump mechanism 3540. The thermal transfer mechanism, piping, pump, and other ancillary components can be pre assembled prior to shipping to a construction job site, with some or all of the assembly optionally being performed using robotic fabrication techniques and systems. In addition, the thermal transfer unit may be embedded with the necessary piping, conduit, and the like during a manufacturing process. Support structures or handles can facilitate handling and installation of the assembled unit, protect the unit and components thereof during shipping, and may also be used to support the unit after installation. The piping may terminate with sealed piping stubs during shipping and installation, with a pressure sensor and gauge allowing quick verification of the piping assembly integrity. Along with heat exchanger/coil units, other HVAC units such as fan coil units (e.g., cube AHUs described herein) and the like may benefit from the systems and methods described herein. Standardization, quality control and tracking, and other improved structures and method described herein may also be implemented with such units.

In some instances, thermal transfer mechanism 3510 includes a heat exchanger coil, which may be pre-fabricated on the HVAC unit along with the piping and pump. In some cases, pump mechanism 3540 includes a variable speed pump. Optionally, pump mechanism 3540 may include a variable speed water pump having an electronically commutated motor (ECM). In operation, one or more water pumps can regulate the rate at which water is circulated through inlet piping assembly 3520, outlet piping assembly 3530, or thermal transfer mechanism 3510, or any combination thereof. In some cases, HVAC units can be constructed with such water pumps such that flow through inlet piping assembly 3520, outlet piping assembly 3530, or thermal transfer mechanism 3510 is controlled without the use of valves such as automatic control valves. Relatedly, HVAC units can be constructed with such water pumps in the absence of balancing valves or pressure drops. ECM motor embodiments can employ DC (e.g. solar) technology, and in some cases can operate to vary the flow into a thermal transfer device from about 0 to about 15+ GPM. In some instances, the water pumps may be circular pumps. In some cases, the water pumps may be operable at flow rates of 3 gpm, 5 gpm, and the like. Some water pumps may provide variable flow rates between about 0 and about 15 gmp, and may be adjustable on a real-time basis. Some water pumps may include check valves or on/off actuators. Exemplary HVAC units can be manufactured by integrating or embedding pump mechanisms 3540 with inlet piping assembly 3520, outlet piping assembly 3530, or thermal transfer mechanism 3510. Hence, HVAC units can provide fluid communication between pump mechanism 3540 and inlet piping assembly 3520, outlet piping assembly 3530, or thermal transfer mechanism 3510. Such constructions can eliminate the need for field fabrication of ancillary components, controls, and the like. In some cases, pump mechanism 3540 may operate on 0 to 10 volts and pulse width modulation as controls outputs. A building automation controls contractor may wire into the pump 0 to 10 volt signal to control the pump based on sensor inputs. In some instances, water pumps can be operable based on input from pressure sensors located at selected positions on an HVAC system. Pump mechanism 3540 can provide a selected flow rate (e.g. gpm) through inlet piping assembly 3520, outlet piping assembly 3530, or thermal transfer mechanism 3510, so as to achieve a desirable energy savings or comfort protocol. By using ECM technology and tying it to a temperature reset algorithm and/or sensor(s) on a controller, the CFM and/or GPM across and into a coil may be varied, which may provide dynamic automation control strategies. This may save energy while providing optimal indoor air quality.

Pump mechanism 3540 can operate to add heat to or remove heat from air circulating through the HVAC unit by routing water through thermal transfer mechanism 3510, the routed water having a temperature higher or lower than the air temperature. For example, a variable rate pump can control a flow rate of water routed through a heat exchanging coil. In some cases, airflow through the HVAC unit can be modulated with a variable speed fan to control a flow rate of the air. As shown in FIG. 35, at least a portion of thermal transfer mechanism 3510 can be disposed or placed within a casing 3550. Similarly, at least a portion of inlet piping assembly 3520 and at least a portion of outlet piping assembly 3530 can be disposed or placed outside of casing 3550.

FIG. 36 shows an HVAC unit 3600 packaged with ancillary components, including a thermal transfer mechanism 3610, an inlet piping assembly 3620, an outlet piping assembly 3630, and an embedded pump mechanism 3640. The thermal transfer mechanism, piping, pump, and other ancillary components can be pre assembled prior to shipping to a construction job site, with some or all of the assembly optionally being performed using robotic fabrication techniques and systems. Support structures or handles can facilitate handling and installation of the assembled unit, protect the unit and components thereof during shipping, and may also be used to support the unit after installation. The piping may terminate with sealed piping stubs during shipping and installation, with a pressure sensor and gauge allowing quick verification of the piping assembly integrity. Along with heat exchanger/coil units, other HVAC units such as fan coil units and the like may benefit from the systems and methods described herein. Standardization, quality control and tracking, and other improved structures and method described herein may also be implemented with such units.

In some instances, thermal transfer mechanism 3610 includes a heat exchanger coil, which may be pre-fabricated on the HVAC unit along with the piping and pump. In some cases, pump mechanism 3640 includes a variable speed pump. Optionally, pump mechanism 3640 may include a variable speed water pump having an electronically commutated motor (ECM). In operation, one or more water pumps can regulate the rate at which water is circulated through inlet piping assembly 3620, outlet piping assembly 3630, or thermal transfer mechanism 3610, or any combination thereof. In some cases, HVAC units can be constructed with such water pumps such that flow through inlet piping assembly 3620, outlet piping assembly 3630, or thermal transfer mechanism 3610 is controlled without the use of valves such as automatic control valves. Relatedly, HVAC units can be constructed with such water pumps in the absence of balancing valves or pressure drops. ECM motor embodiments can employ DC (e.g. solar) technology, and in some cases can operate to vary the flow into a thermal transfer device from about 0 to about 15+ gpm. In some instances, the water pumps may be circular pumps. In some cases, the water pumps may be operable at flow rates of 3 gpm, 5 gpm, and the like. Some water pumps may provide variable flow rates between about 0 and about 15 gpm, and may be adjustable on a real-time basis. Some water pumps may include check valves or on/off actuators. Exemplary HVAC units can be manufactured by integrating or embedding pump mechanisms 3640 with inlet piping assembly 3620, outlet piping assembly 3630, or thermal transfer mechanism 3610. Hence, HVAC units can provide fluid communication between pump mechanism 3640 and inlet piping assembly 3620, outlet piping assembly 3630, or thermal transfer mechanism 3610. Such constructions can eliminate the need for field fabrication of ancillary components, controls, and the like. In some cases, pump mechanism 3640 may operate on 0 to 10 volts and pulse width modulation as controls outputs. A building automation controls contractor may wire into the pump 0 to 10 volt signal to control the pump based on sensor inputs. In some instances, water pumps can be operable based on input from pressure sensors located at selected positions on an HVAC system. Pump mechanism 3640 can provide a selected flow rate (e.g. gpm) through inlet piping assembly 3620, outlet piping assembly 3630, or thermal transfer mechanism 3610, so as to achieve a desirable energy savings or comfort protocol.

Pump mechanism 3640 can operate to add heat to or remove heat from air circulating through the HVAC unit by routing water through thermal transfer mechanism 3610, the routed water having a temperature higher or lower than the air temperature. For example, a variable rate pump can control a flow rate of water routed through a heat exchanging coil. In some cases, airflow through the HVAC unit can be modulated with a variable speed fan to control a flow rate of the air. As shown in FIG. 36, at least a portion of thermal transfer mechanism 3610 can be disposed or placed within a casing 3650. Similarly, at least a portion of inlet piping assembly 3620 and at least a portion of outlet piping assembly 3630 can be disposed or placed outside of casing 3650.

Embodiments of the present invention may incorporate aspects of zone control units and other HVAC piping or piping and coil assemblies, methods of installing zone control units and other HVAC piping or piping and coil assemblies, methods of preparing zone control units and other HVAC piping or piping and coil assemblies for delivery, methods of transporting zone control units and other HVAC piping or piping and coil assemblies, methods of mounting zone control units and other HVAC piping or piping and coil assemblies to surfaces such as HVAC duct surfaces, methods of manufacturing or fabricating zone control units and other HVAC piping or piping and coil assemblies, control systems which can be used to control zone control units and other HVAC piping or piping and coil assemblies, quality control methods for zone control units and other HVAC piping or piping and coil assemblies, and bracket or handle configurations which may be used in conjunction with or incorporated into zone control units and other HVAC piping or piping and coil assemblies, such as those described in U.S. Patent Publication Nos. 2003/0085022, 2003/0085023, 2005/0056752, 2005/0056753, 2006/0011796, 2006/0130561, 2006/0249589, 2007/0068226, 2007/0108352, 2007/0262162, 2008/0164006, 2008/0307859, 2009/0057499, and 2010/0252641, the entire disclosures of which are incorporated herein by reference.

Universal Handle Bracket

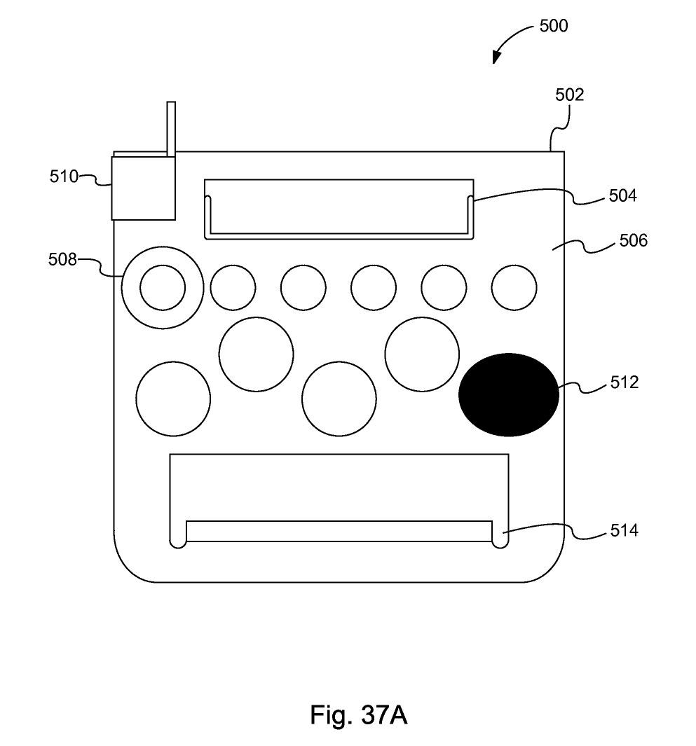

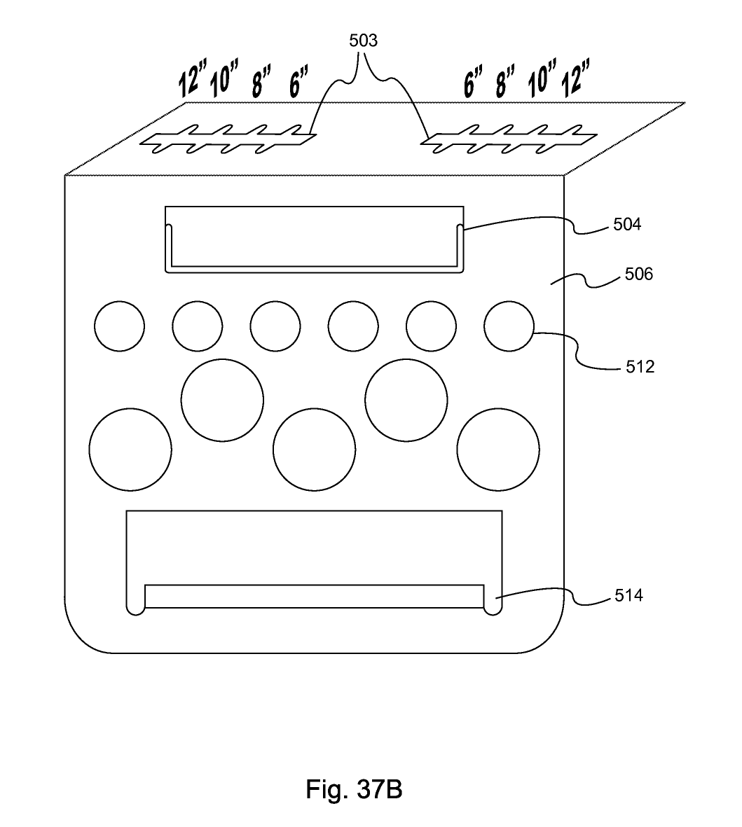

FIGS. 37-41 and 45 Illustrate various handle brackets that may be used with the HVAC systems and assemblies described herein. In some embodiment, the brackets may not include a handle. For example, the handle brackets may be fitted around one or more ducts so that the duct and piping may be mounted to the ceiling and/or walls of a building. The handle brackets can be made in multiple configurations, sizes, and of various materials. They may be contoured to fit or couple with round duct, rectangular duct, and the like. The handle brackets may be configured to protect ancillary equipment/modules when shipped to a job site on a transporting platform. The handle brackets may further facilitate handling and installation of the HVAC system or assembly at the job site while protecting the assembled equipment. The handle bracket may be prefabricated or pre-assembled with one or more pieces of equipment and/or component (e.g., piping, ducts, cable trays, conduit, sprinkler systems, radios, speakers, wireless hardware, networking, electrical outlets, lights, air distribution devices, thermal transfer devices, fans, water heaters, AC/DC and/or DC/AC converters, pumps, valves, controls hardware/networking equipment, dampers, electrical switch gear, circuit breakers, electrical disconnects and the like) so that the HVAC assembly is ready for installation at the job site. In other embodiments, the handle bracket may be partially prefabricated or partially assembled with one or more components referred to above so that the remainder of the assembly occurs at the job site. Assembly at the job site may occur before, during, or after installation. For example, various conduit, piping, electrical equipment (e.g., networking, outlets, pumps, and the like) may be coupled with the handle bracket after the HVAC system is installed in the building. Additional details and features of the handling bracket may be found in U.S. Pat. No. 6,951,324, U.S. Pat. No. 7,165,797, and U.S. Pat. No. 7,444,731, the entire disclosures of which are incorporated herein in their entirety for all purposes as if set forth herein.

The piping assembled with the handle bracket may include valves packages, thermal transfer devices, controls, and the like. The piping may also include 24-48 inch long stainless steel hose kits for connecting vertical pipe and thermal transfer units as described in U.S. Pat. No. 7,596,962, the entire disclosure of which is incorporated herein in its entirety for all purposes as if set forth herein. The handle brackets may include a variety of mounting features, such as one or more apertures. The apertures may be made of various sizes or may include a certain size, such as 2½ inches in diameter so as to accommodate ½″ to 2¼″ round pipe conduit. To accommodate differing sized conduit, pipes, and/or other needs, one or more grommets and/or gaskets may be placed in the apertures. The grommets may be made of rubber, plastic, calcium, polycarbonate, and the like. The outside diameter of the grommet may be configured to the size of the apertures (e.g., 2½ inches), while the inside diameter may vary from ½″ to 2¼ inches or larger. The apertures may likewise include a variety of shapes such as round, rectangle, octagon, and the like. The grommets and/or gaskets may eliminate vibration or the transmission of vibrations in the handle bracket.

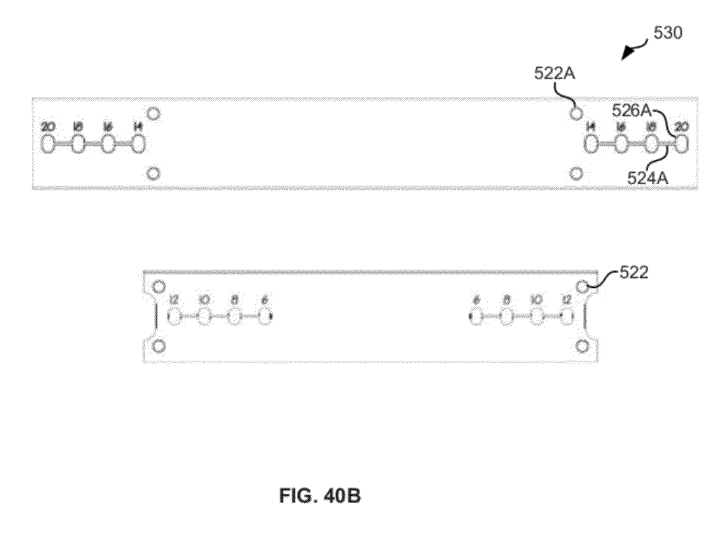

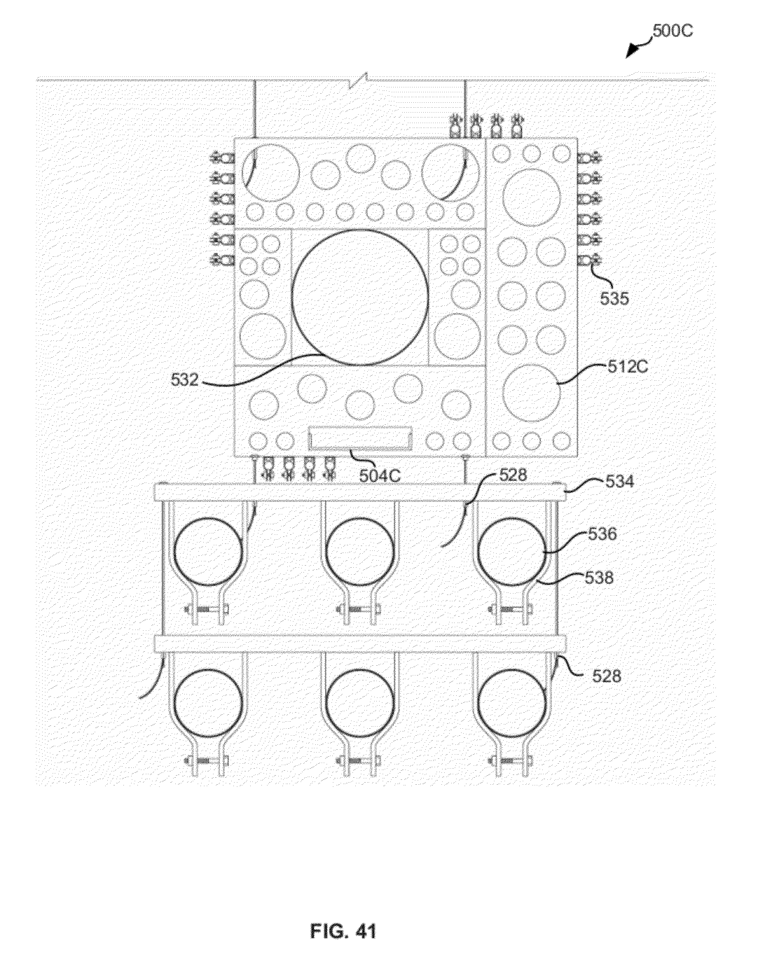

As described herein, the prefabricated or pre-assembled handle brackets and piping may be hung from the ceiling of a building. For example, FIG. 5B illustrates a side view of a handle bracket supporting a round duct. The handle bracket is mounted to the ceiling via one or more cables and cable fasteners. The cable may be attached around the duct using a c-clamp fastener and may be attached to the handle bracket by a cable fastener that fits into beveled apertures in the handle bracket as described herein. The cable may be tightened/fastened within the cable fastener by using a setting pin that allows the cable to slide through the cable fastener in a released position and secures the cable within the cable fastener in a locked position. An embodiment of features of the handle bracket that facilitate attachment is provided in FIGS. 40A-B. The cable and/or cable fasteners may facilitate leveling the distribution assembly. The leveled distribution assembly may allow electrical conduit, cable trays, and the like to be inserted through the holes/grommets on the bracket without requiring these individual components to be leveled. Fire sprinklers can be run through the brackets and/or supported by the brackets.

All or some of the piping could be pressurized at an assembly site prior to shipping and could ship with a pressure gauge under pressure to ensure that ensuring no leaks develop. The pressure in the various ducts and/or piping could be measured after an amount of time (e.g., overnight) to determine if the pressure has dropped. Alternatively or additionally, the piping could be pressurized at a job site once the hose kits are connected to the thermal transfer devices (e.g., ZCU), thus ensuring no leaks develop after connecting the components of the distribution assembly. If leaks are observed, the leaks may be immediately fixed. Pressurizing the piping may include making hose connections to a ZCU unit (or any thermal transfer unit) and/or any drain piping so that the unit form a closed loop and/or is sealed. The piping may then be pressurized and left for an amount of time (e.g., overnight or longer). The pressure may then be measured to determine if a leak is present or if the unit is ready for installation. Pressurizing the pipes and measuring the pressure after an amount of time to check for leaks may save time and/or cost compared to the conventional method of checking for leaks, which typically included a tradesman walking around with a flashlight looking for leaks.

Alternatively or additionally, the piping of one or more distribution assemblies may be coupled together and the entire length of piping along the coupled assemblies may be pressurized and left for an amount of time to determine the presence of any leaks. For example, the ends of the pipes of the coupled assembly may be caped (either shipped this way or done at the job site) and the pipe may then be pressurized and left overnight. The gauges may be checked the next day to determine if the loop is holding pressure.

Turning now to FIGS. 37A-B, illustrated is one embodiment of the handle bracket 500. The handle bracket 500 may include a plurality of mounting features, such as a rectangular cutout for a cable tray 504 and a variety of apertures 506 and 512. Apertures 506 may be used to couple one or more electrical conduits with the handle bracket 500, such as speaker cables or wire 508. Apertures 512 may be used to couple various piping with the handle bracket 500, such as inlet and outlet piping used for transferring hot and cold fluid to the coils of the ZCU. The apertures 512 may be staggered to facilitate coupling of the piping with the bracket. The water piping holes can be located at a lower point in case of a leak so that the water does not drip in and/or on the electrical and/or low voltage components. The handle bracket 500 may further include a handle 514 and wireless transmitter, repeater, or other wireless hardware 510. The handle bracket may also include an air duct support 502 or platform upon which the duct rests. The platform 502 may include one or more apertures 503 that couple with the cable fasteners. The handle bracket may include other devices such as cable trays, remote control transmitters, wireless network equipment (e.g., transmitters, repeaters, routers, and the like). Communication could be vertical and through ceiling tiles instead of through walls and/or floors which may deaden the signal.

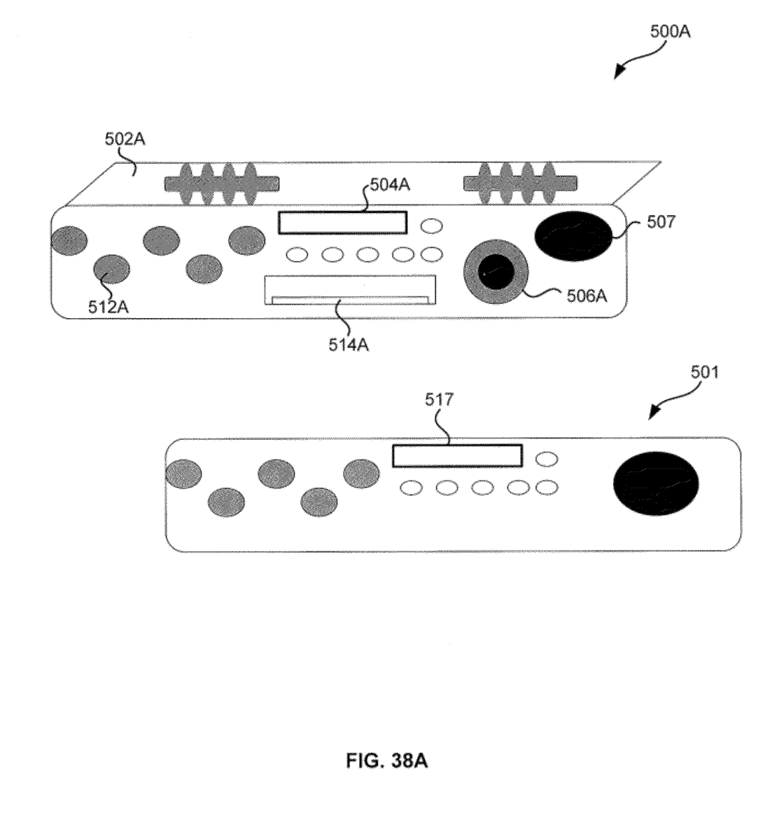

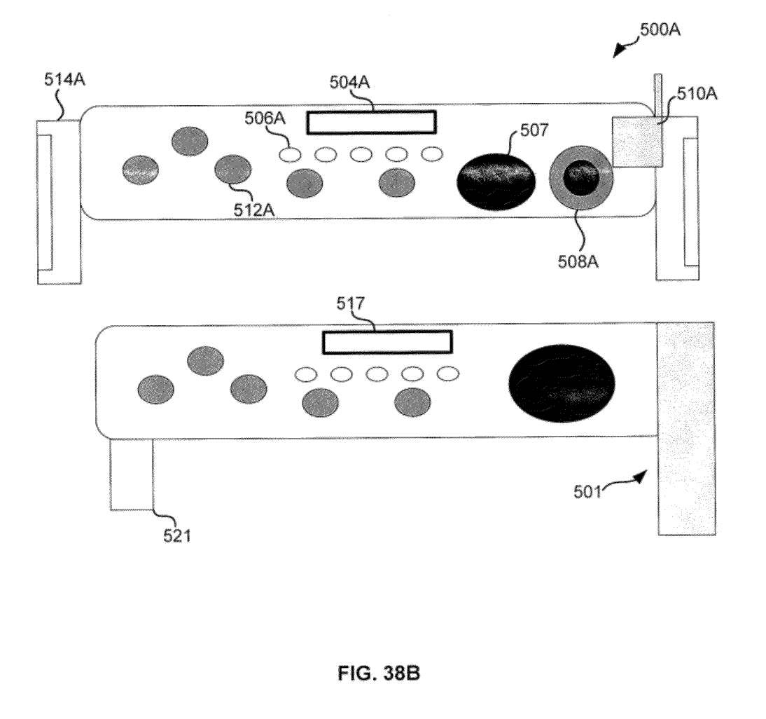

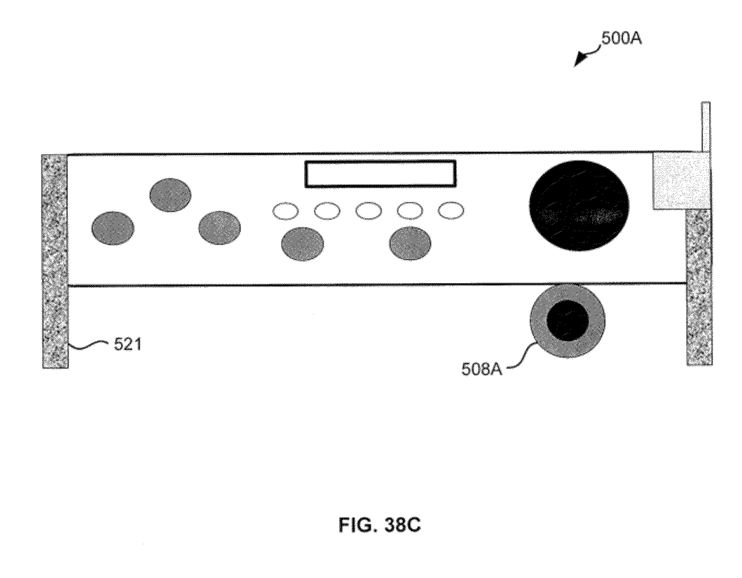

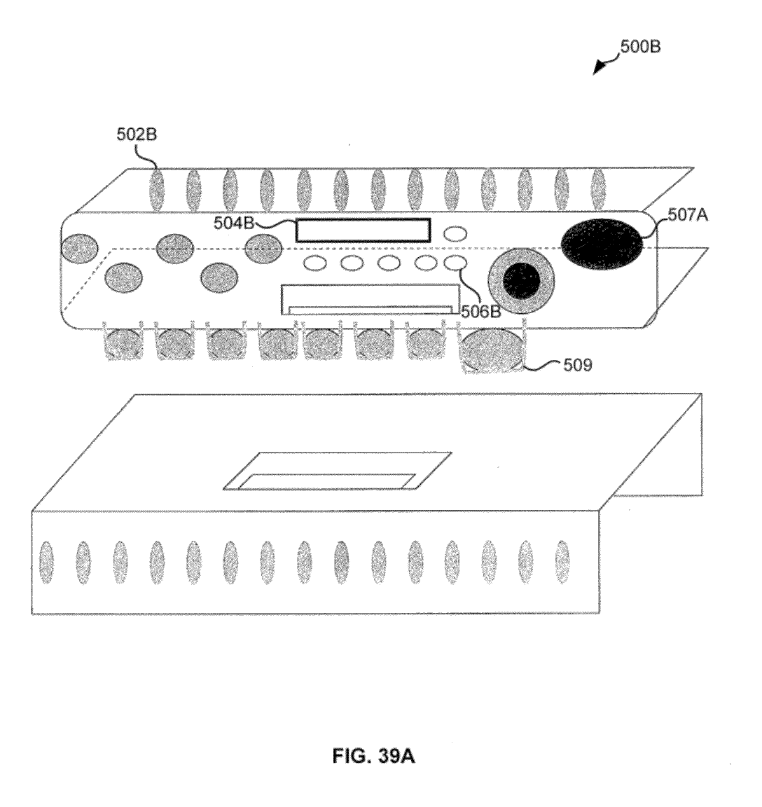

FIGS. 38A-C illustrate another embodiment of the handle bracket where the profile of the handle bracket is shorter and wider than the handle bracket of the FIGS. 37A-B. In one embodiment, the brackets of FIGS. 38A-C may be 30 inches wide by 6-8 inches tall. This embodiment may decrease the space needed for HVAC and other equipment. FIG. 38A shows a handle bracket 500A that may include a cutout 504A that may be used for a cable tray, a platform 502A to support an air duct, a handle 514A, a plurality of apertures 512A that may be used for various piping such as fluid/gas pipes, electrical conduit apertures 506A, and other apertures 507 that may be used for other piping such as fire sprinkler pipes. The apertures 512A, 506A, and 507 may be inline with each other to reduce the space required to couple the various components. Handle bracket 501 may include a cutout 517 that is couplable with cutout 514A so that bracket 501 may be suspended from bracket 500A, thereby allowing additional components to be coupled with the distribution assembly. FIG. 38B illustrates another embodiment of a low profile handle brackets where the handle brackets, 500A & 501, have roughly the same configuration as the handle bracket of FIG. 38A. However, the handle 514A in bracket 500A of FIG. 38B has been positioned and coupled to the sides of bracket 500A and bracket 500A includes a wireless transmitter 510A. The handless 514A positioned on the side of bracket 500A may protect the assembly and assembled components during shipment of the assembly and allow the assemblies to be stacked on top of each other and/or on top of a transporting surface. Bracket 501 likewise includes shipping brackets 521 that protect the assembly during shipping and allow the assemblies to be stacked. All or a portion of shipping bracket 521 and/or handle 514A may be removed prior to, during, or after installation of the assemblies. FIG. 38C illustrates another embodiment of the shipping brackets 521, where the shipping brackets do not protrude beyond the bottom of bracket 500A.

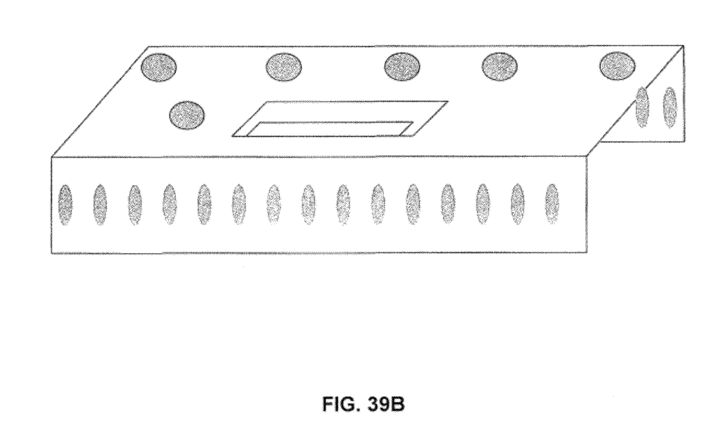

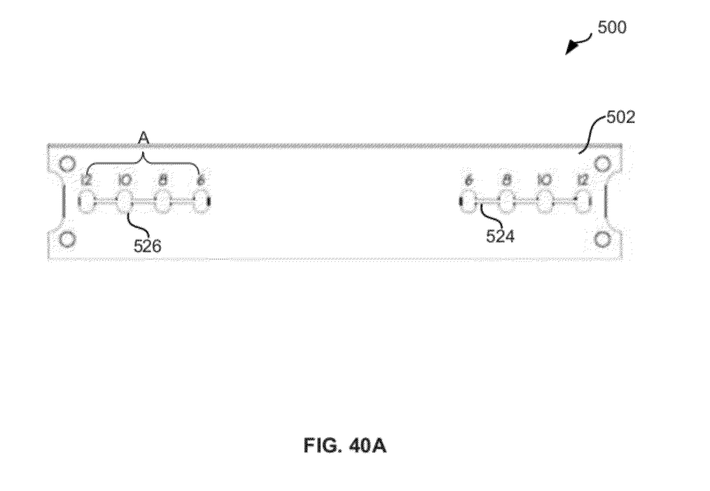

FIGS. 39A-B illustrate another embodiment of a handle bracket 500B including many components similar to the other handle brackets, 500 & 500A, such as platform 502B, cutout 504B, conduit apertures 506B, piping apertures 512B, and other apertures 507A. Bracket 500B may also include one or more additional coupling features 509 that may be used to couple or attach various conduit or piping to bracket 500B. The coupling features 509 may include clips, wires, braces, mechanical fasteners, and the like. The bottom figure of FIG. 39A and FIG. 39B show different perspective view and configurations of bracket 500B. The brackets and/or bracket extensions described herein may allow field mounting of other utilities, equipment, ancillary devices, and/or components on to the modular building utilities system (e.g., distribution assemblies).

FIGS. 40A-B illustrate a top view of bracket 500. Specifically, the figures illustrate platform 502 of bracket 500. Platform 502 may be configured to support and couple with any shaped and sized duct, for example, the duct may be square, rectangular, oval, round, and the like. In one embodiment bracket 500, and therefore platform 502, is 15 inches wide and is configured to support and couple with a round duct approximately 6 to 14 inches in diameter. The platform 502 may include one or more apertures or tabs 522 that may be used to couple with an adapter or extension plate for larger ducts as described in FIG. 40B. The platform may also include one or more coupling apertures 526 that are configured to coupling with a cable fastener, such as the cable fastener illustrated in FIG. 5B. In one embodiment, the platform 502 includes a plurality of apertures 526 that are beveled and spaced approximately 2 inches apart from each other. The apertures may include indicia as shown by element A that indicate which apertures to use to couple a certain sized duct (e.g., indicia 6 on the right and left side apertures indicates coupling a 6 inch duct). The bottom of the apertures 526 may be beveled to allow the bottom of the cable fastener (e.g., Gripple fastener) to lock in place once the cable is tightened. Once the modular distribution assembly is attached to the ceiling platform and leveled, other devices can be attached to the leveled brackets and/or bracket extensions thereby saving time since no or minimal leveling is required. The other devices or components may be assembled (e.g., snapped) onto the brackets and/or bracket extensions without requiring additional support brackets. Between one or more of the apertures 526 may be a slot 524 that allows the cable fastener to transition between apertures 526. The slots 524 may be designed for easy adjustability of the cabling/cable fastener without removing the cable from the fastening device. For example, if a tradesman inadvertently locates the cable fastener in the wrong aperture 526 (e.g., aperture 6) and tightens the cable, they may raise the assembly and/or release the setting pin on the cable fastener to allow slack in the cable so that the cable fastener drops out of the beveled end of the aperture 526. The cable may then be transferred/slid through the slot 524 to a new aperture 526 and the assembly lowered and/or the setting pin locked after the cable is tightened. In other words, the slot allows a tradesman to slide the cable fastener and the cable over to the next slot/correct slot. FIG. 40B illustrates an extension 530 that may be used for larger ducts. The extension 530 may include one or more apertures 522A that couple with aperture 522 of platform 502 via one or more fasteners. For example, the extension 530 may be positioned atop the platform 502 and secured to platform 502 to provide extra width to bracket 500. Extension 530 may include apertures 526A and slots 524A that function similar to apertures 526 and slot 524 of platform 502.

FIG. 41 illustrates another embodiment of a bracket 500C that may be used to couple various piping, conduits, cable trays, ducts, sprinkler pipes, other equipment and/or components, and the like. Bracket 500C may include a central portion 532 that is sized to fully enclose a duct. For example, the central portion 532 may include a 6 inch by 6 inch cutout to fully enclose a 6 inch round duct. The bracket 500C may also include a plurality of apertures 512C that are shaped and sized to couple with various piping, conduit, and the like, such as those described herein. The bracket may further include one or more cutouts 504C that may be used to couple with one or more cable trays. The bracket may be coupled with a ceiling of a building via one or more cable fasteners 528, such as those described herein. Fasteners, such as cable fastener 528, may also couple the bracket 500C with one or more additional components, such as an additional supporting brackets 534 and or other components such as lighting cables (not shown), lighting fixtures (not shown), frame work for a drop/suspended ceiling (not shown), fire sprinkler system (not shown), ceiling fans (not shown), speaker system (not shown), and the like. For example, bracket 500C may be coupled with one or more additional supporting brackets 534 that include additional coupling/supporting features 538 that may be used to couple and/or support various piping 536, conduit, and/or equipment or components. In addition, bracket 500C may also include additional coupling features 535 that allow other components to be coupled directly with bracket 500C.

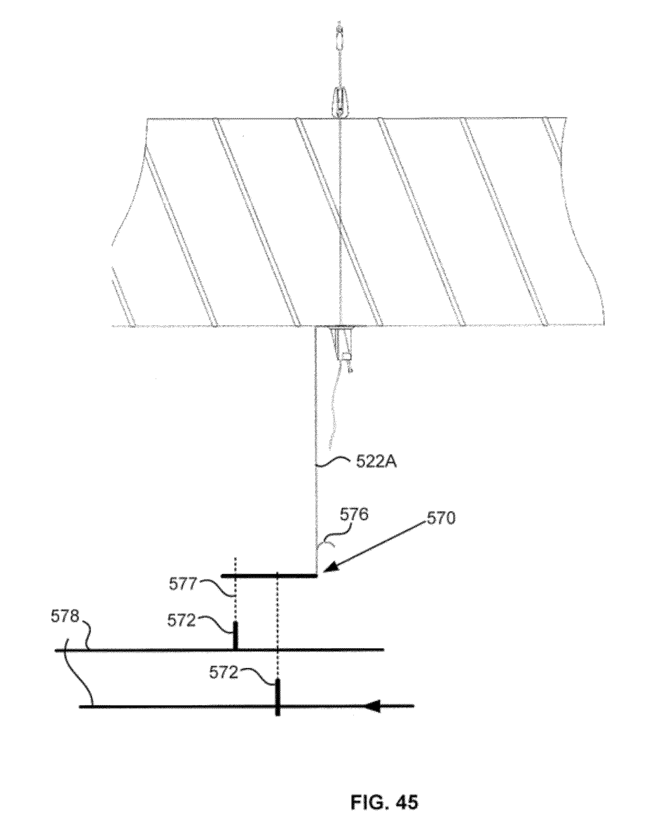

FIG. 45 illustrates another embodiment of a bracket 500 that includes an angled bottom portion 570 that extension substantially perpendicular to the bracket 500 and that may be used to couple additional components, such as additional piping, conduits, lighting fixtures, fire sprinklers, and the like. The bottom portion 570 may include one or more holes through which one or more fasteners 572 may be coupled. The fasteners 572 may be coupled directly with the bottom portion 570 or hang therefrom (shown by the dashed lines). The fasteners 572 may be coupled with additional components 578, such as fire sprinklers, lighting fixtures, drop ceiling fixtures, and the like. In this manner, virtually every component that is suspended from a building's ceiling may be supported by the bracket. The bracket 500 may also include a handle portion 576 that facilitates handling of the bracket and/or coupling of other brackets. For example, cutouts portions of other brackets may be hung or suspended from the extension of handle portion 576.

Manufacturing Jig

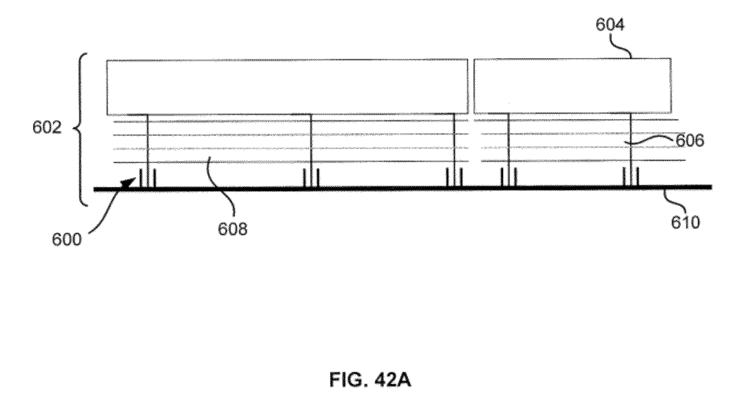

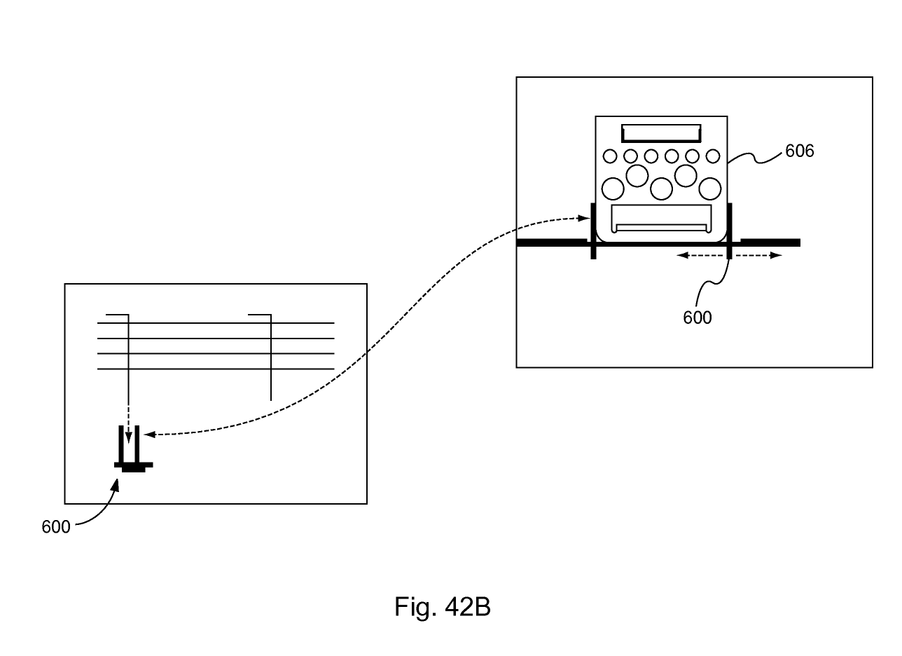

FIGS. 42A-B illustrate a jig 600 that may facilitate in manufacturing, transportation, and/or installation of the distribution assemblies 602. The jig 600 may be coupled with a platform 610 such as in an assembly line at an assembly site or a platform at an installation site that is raised and lowered to raise and lower the distribution assembly 602 during installation. The jig 600 may also be coupled with a handle bracket 606 of the distribution assembly 602. The jig 600 may be spaced 10 feet about on the platform so that every handle bracket 606 is coupled with a jig 600. As described herein, a duct 604 may sit atop and be assembled with bracket 606. A plurality of pipes, conduits, and/or cable trays 608 may also be assembled with the bracket 606. The jigs 600 may facilitate in aligning the mounting features of the brackets (e.g., the apertures, cutouts, and the like). Likewise, the jigs 600 may assure all the pipe and accessories are aligned when the modules are secured to the ceiling.

In an assembly operation at an assembly site, the bracket 606 may be inserted into the jigs 600 with a handle side down. The pipes, conduit, fire sprinklers, valves packages, hose kits, and the like may then be assembled with the brackets and subsequently insulated, pressurized, sealed, leak checked, checked for wiring continuity, and the like. The duct 604, which may be pre-insulated with transitions, taps, and the like, may then be positioned on the brackets and center justified. For high speed production a spiral duct machine and copper coil feeders may be set up in parallel manufacture long runs. The piping 608 may be fed through the brackets 606 as the spiral machine positions the duct 604 atop the brackets 606 and/or insulates the duct. The assembly area can be as long as needed to allow rough dry fitting of the distribution assemblies 602. The assemblies 602 may then be tagged, wrapped in plastic and lifted out of the jigs 600 by handles of the bracket 606 or in some other way. If the bracket 606 has handles, the handles may be exposed outside of the wrapping. In some embodiments, the jigs 600 may ship to an installation site with and support the assemblies 602. In other embodiments, the assemblies 602 are lifted out of the jigs 600 and transported to a transportation surface for shipment to the installation site. FIG. 42B illustrates different view of the jig 600 and shows the bracket 606 being removed from the jig. The manufacturing jig may save time since no leveling or minimal leveling and individual support of component installed in field.

Field Erected Housing

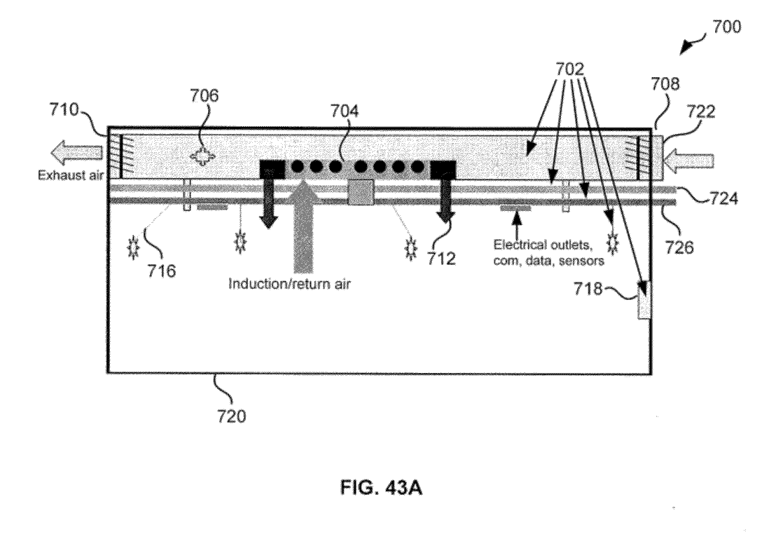

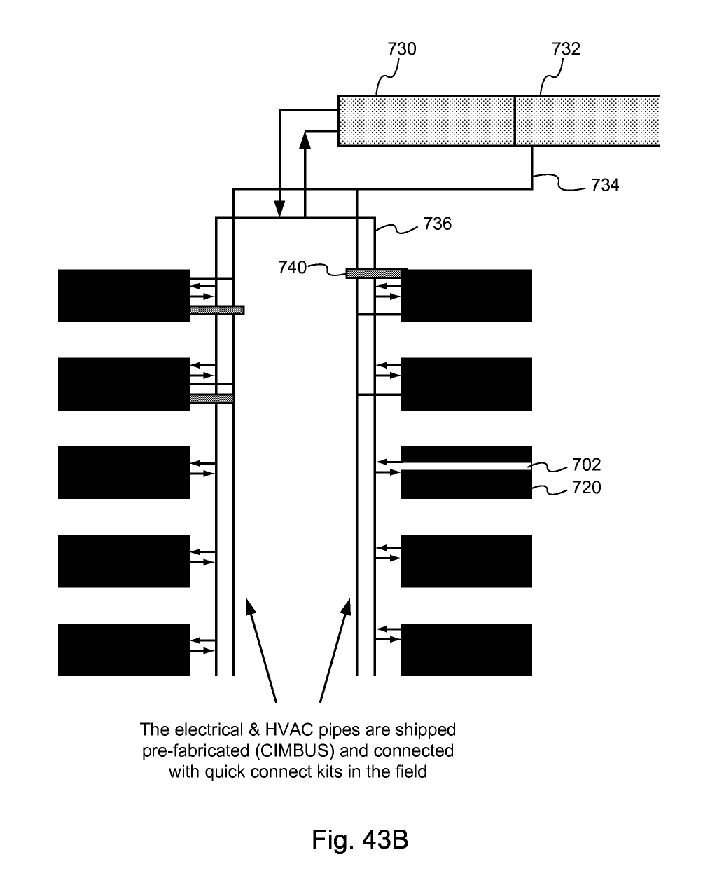

FIGS. 43A-B illustrate an embodiment 700 where the distribution assemblies 702 may be used in field erected housing, or in other words, temporary housing that may be at least partially constructed at an assembly site or prefabrication facility and quickly assembled at a work site or field location. Such an embodiment may be ideal for military or work operations where multiple houses are quickly erected (e.g., Federal Emergency Management Agency (FEMA) work sites). For example, the distribution assembly 702 can be coupled with the ceiling of a portable house and have any or a variety of desired components (e.g., piping, conduits, cable trays, lighting, and the like) prefabricated/pre-assembled so that the roof is snapped into place and all the utilities snap into place with desired connections in place for power, HVAC, sensors, and a web based wireless controller controls desired components through prefabricated sensors/transmitters. In one embodiment, the distribution assembly 702 may be a modular building utilities system with part of the ceiling structure of the portable housing unit. The entire modular setup of a field erected housing unit could be prefabricated at an assembly site for subsequent installation at a field site. The field housing units and/or distribution assembly 702 may be pretested and shipped to field sites (e.g., combat zones) substantially defect free.

FIG. 43B illustrates a schematic plan view of a field erected housing unit. The plan view show a plurality of housing units 720 arranged according to a plan and coupled with one or more main electrical/data conduit 734 and other piping 736 (e.g., water or gas for heating and cooling). The electrical/data conduit 734 may be connected to a generator or fuel cell 732 that provides power the housing units (e.g., a diesel generator, hydrogen cell, and the like) or may be connected to a network that provides data and/or other communication. Each housing unit 720 may include a quick electrical connection to connect to the electrical/data conduit 734. The piping 736 may be connected to a water source and/or heat source 730 (e.g., a heat pump configured to cool water or heat it). For example, the water and/or heat source 730 may be a water line, heat pump, boiler, gas line, and the like. A closed loop water distribution system (or gas/DX), such as fire hoses, could hook up to each housing module via the piping 736, which could supply hot and/or cold water to a thermal transfer unit/coil (704 of FIG. 43A). A bracket 740 may connect the piping 736 and/or electrical/data conduit 734 to the distribution assemblies 702 within one or more of the housing units 720. One or more or all of the components of the field erected housing may be prefabricated at an assembly site and shipped to the field site for easy installation.

FIG. 43A illustrates an embodiment of an individual housing unit 720 having a distribution assembly 702 therein. The housing unit 720 may be prefabricated or fabricated at the field site using a duct 722, which may be round, flexible, sheet metal, pvc, and the like. The duct 722 may be about 2-6 inches in diameter and traverse the length of the house. The duct 722 may be coupled with a thermal transfer unit/coil 704 to provide heating and cooling for the housing unit 720. In one embodiment, the thermal transfer unit/coil 704 may be positioned within the duct 722. In other embodiments, the thermal housing unit/coil 704 is positioned exterior to and adjacent the duct 722. The duct 722 may also be operatively coupled with a fan 706, such as a fan with an ecm motor, which may operate on low energy and can vary the flow. The fan 706 may be disposed within the duct 722. The distribution assembly 702 may also be coupled with a small pump with an ecm motor (not shown), an electrical/data conduit 726, piping 724, lighting fixtures 716, a panel 718, dampers 708 & 710, a condensate collection unit 714, and the like.

The housing unit 720 may include one or more outlets (not shown) that are connected with the electrical/data conduit 726 to provide power and/or communication within the housing unit 720. The housing unit 720 may also include hot and cold water faucets (not shown) for showers and the like. The lighting fixtures 716 may be led lights, for example, the lighting fixtures 716 may include 1-2 foot flexible snakes with 2″×2″ LED lights attached to the snake or along the snake. The occupants would be able to move the light to wherever light is needed, thus reducing the overall demand for light within the housing unit 720. Other lighting fixtures may be used as well. The use of LED lights and an ecm motor may allow the housing unit 720 to be run on DC current and/or off solar power due to the low voltage requirements of led lights and the ecm motor.

The panel 718 may be include wireless sensors and/or controls (e.g., infrared, temp sensor, motion sensor, and the like) and a touch screen wireless control panel. The room sensors and panel 718 may shut down the lights and/or adjust the lighting levels based on the ambient light levels and/or whether the housing units 720 are occupied. Likewise, the sensors and panel 718 may adjust the HVAC setting depending on the occupancy level within the housing unit 720 and/or the climate settings input by an occupant. The panel 718 may allow climate settings to be overridden locally or from a central command and may allow monitoring of the KHW levels, light lumens, water usage, and the like. A central command could monitor energy usage and implement a global energy strategy based on fuel supplies, water supplies, and the like.

The condensate collection unit 714 may be coupled with thermal transfer unit/coil 704 and configured to collect condensate water/liquid rung out from the ambient air from the thermal transfer unit/coil 704. The collected condensate may be converted to drinking water, potable water, and the like. Likewise, the condensate collected could be routed to and collected in a reservoir for the housing unit 720 or the entire field erected housing project.

The thermal transfer unit/coil 704 could include air devices that allow recirculation of the air within each housing unit 720. This may keep the air moving to avoid stagnation keeping the occupants (e.g., soldiers) energized. Likewise, the air system (e.g., thermal transfer unit, air devices, and the like) could include one or more air freshners that keep the housing units 720 smelling fresh. The duct 722 could include dampers, 708 & 710, which may allow for a small flexible duct (e.g., a fabric duct—air moving though blows it up like a balloon) to be attached. In addition, each occupant could have their own duct (not shown) to cool their area.

Distribution Assembly Enclosure

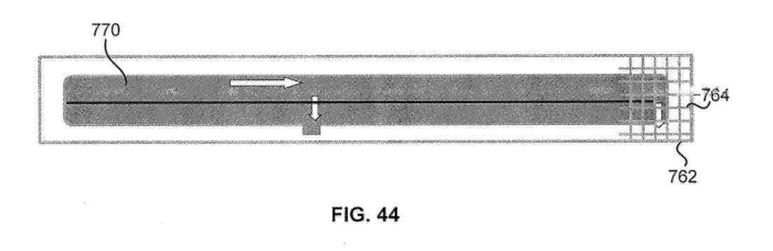

FIG. 44 illustrates a distribution assembly 770 including an enclosure 762 or security cage positioned around the exterior of the distribution assembly 770. The security cage or enclosure 762 may be coupled with the distribution assembly 770 to protect the components of the distribution assembly (e.g., the brackets, duct, piping, conduit, cable trays, fire sprinklers, lighting components, and the like). Further, the enclosure 762 may be tamper proof to protect the components from unauthorized access. The enclosure 762 may be prefabricated/pre-assembled around the distribution assembly or assembled with the distribution assembly 762 at an installation site prior to or after installation. The enclosure 762 may include a plurality of crisscrossing bar that may be fabricates of wire, Kevlar, polycarbonate, steel, stainless steel, and the like. The enclosure 762 may further include access hatches (not shown) that may be locked to allow only authorized individuals to access the assembled components.

Cube AHU Unit

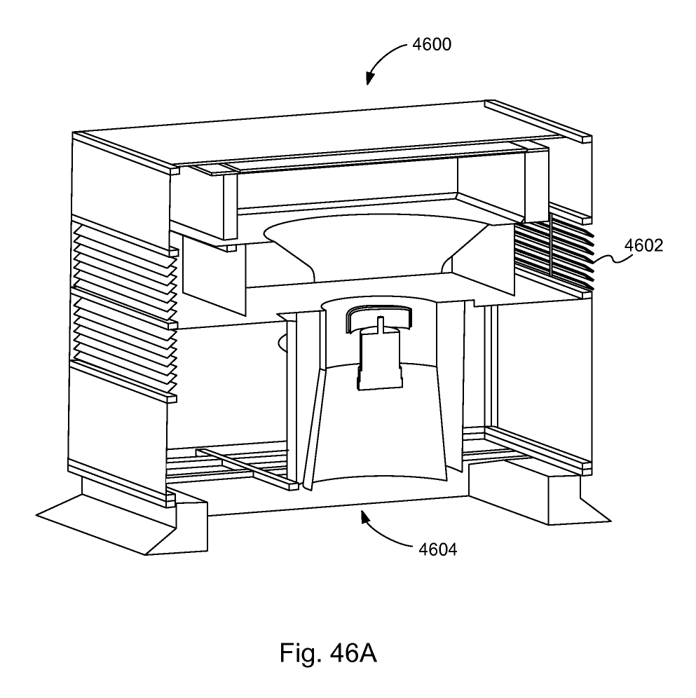

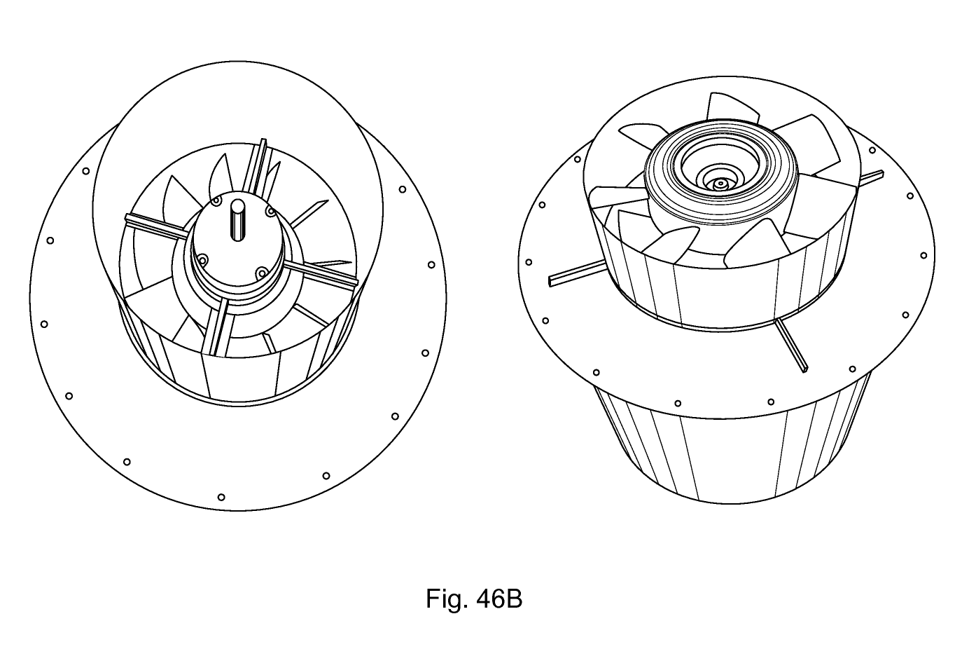

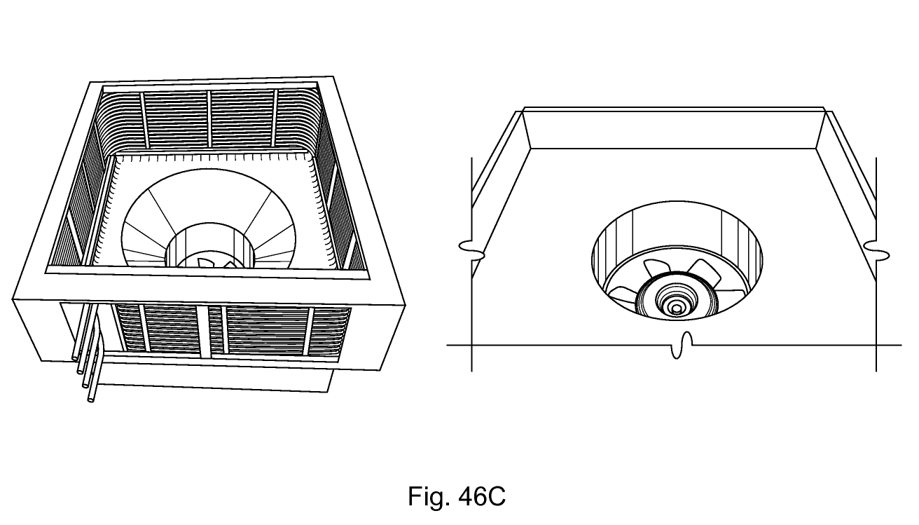

FIGS. 46A-D illustrate a fan section 4600 that can be used with supply air section 14 and/or exhaust air section 16 of FIG. 1. The fan section 4600 may be coupled with a vertically-oriented distribution assembly to supply to and/or exhaust air from the horizontally-oriented distribution assemblies. The fan section 4600 may be enclosed within a protective cage as shown in FIG. 46D. The fan section 4600 may also include one or more dampers 4602 and/or thermal transfer coils that may function to heat or cool air introduce into the fan section 4600. A fan 4604 may be centrally located in the protective cage. The fan section 4600 may re-circulate air within the building and/or supply air from or exhaust air to the outside environment.

Modular Building Utilities Systems and Assemblies

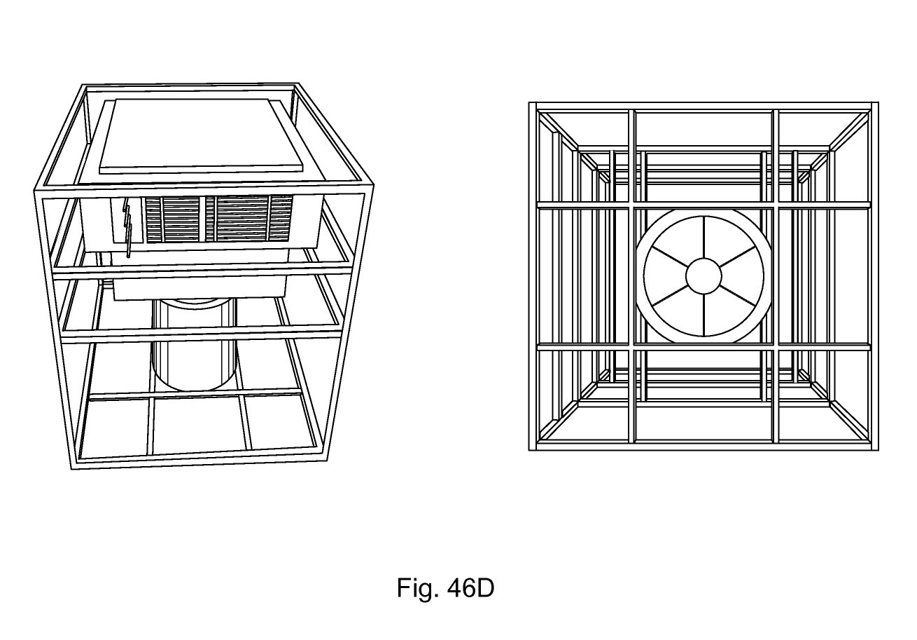

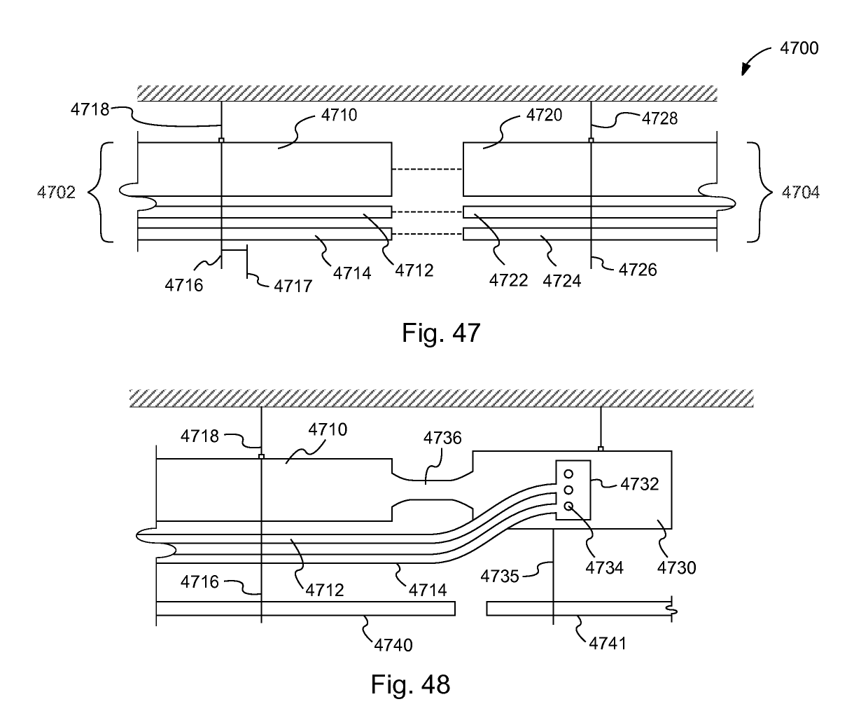

FIG. 47 illustrates a modular building utilities system 4700 for installation in a building 4703. The modular building utilities system 4700 may include a first assembly 4702 having a first duct 4710 for transporting air, a first bracket 4716 coupled with the first duct, a first inlet piping 4712 coupled with first bracket and disposed exterior to the first duct, a first outlet piping 4714 coupled with the first bracket and disposed exterior to the first duct, and a first adjustable fastening mechanism 4718 coupled with the first bracket for adjustably coupling the first bracket with the building 4703. The modular system 4700 may also include a second assembly 4704 having a second duct 4720 for transporting air, a second bracket 4726 coupled with the second duct, a second inlet piping 4722 coupled with second bracket and disposed exterior to the second duct, a second outlet piping 4724 coupled with the second bracket and disposed exterior to the second duct, and a second adjustable fastening mechanism 4728 coupled with the second bracket for adjustably coupling the second bracket with the building. The first bracket 4716 and/or second bracket 4726 may be coupled with a bracket extension 4717, such as the bracket extension of FIG. 41, that allows for additional components (e.g., fire, lights, sprinklers, security, and the like), piping, ancillary devices, and the like to be prefabricated/pre-assembled with the first and/or second modular assembly and/or fabricated/assembled onto the modular assembly at a construction after the assembly has been installed in a building.

The first assembly 4702 and second assembly 4704 may include standardized pipes and/or duct sizes. For example, the first duct 4710 of the first assembly 4702 may be the same size and cross section as the second duct 4720 of the second assembly 4704. Likewise, the first inlet piping 4712 and first outlet piping 4714 may be the same size and cross section as the second inlet piping 4722 and second outlet piping 4724.

In some embodiments, the first bracket 4716 maintains the first inlet piping 4712, the first outlet piping 4714, and the first duct 4710 in a first positional relationship. Likewise, the second bracket 4726 maintains the second inlet piping 4722, the second outlet piping 4724, and the second duct 4720 in a second positional relationship. The first and second positional relationships may provide alignment between the first and second ducts, 4710 and 4720, the first and second inlet piping 4712 and 4714, and the first and second outlet piping 4714 and 4724, to facilitate coupling of the first and second ducts, the first and second inlet piping, and the first and second outlet piping. For example, the first positional relationship and the second positional relationship may axially align the first duct 4710, the first inlet piping 4712, and the first outlet piping 4714 with second duct 4720, the second inlet piping 4722, and the second outlet piping 4724 as shown by the dashed lines between the assemblies. The first and/or second bracket may include a cable tray that is configured to support one or more electrical wires or cables as described herein. Likewise, the first and/or second bracket may include a wireless transmitter and/or wireless repeater. Similarly, the first assembly and/or the second assembly may include an enclosure disposed the respective assembly to protect the assembly. The enclosure may be similar to that protective cage described in FIG. 44. Likewise, the first and second brackets, 4716 and 4726, and/or the bracket extensions 4717 may maintain the other components, devices, and the like described herein (e.g., sprinklers, plumbing, etc.) in the first positional relationship and second positional relationship to facilitate assembling of the additional components, device, and the like.

FIG. 48 illustrates another embodiment of a modular system. The modular system may include a first assembly 4702 having a first duct 4710, a first bracket 4716, a first inlet piping 4712, a first outlet piping 4714, and a first adjustable fastening mechanism 4718 similar to the modular assembly of FIG. 47. The first assembly 4702 may be coupled with a zone control unit (ZCU) 4730 configured to provide HVAC to one or more zones of a building. The first duct 4710 may include a discharge port 4710 configured to supply a portion of the air to the ZCU 4730. The first inlet piping 4712 and first outlet piping 4714 may be coupled with a coil 4734 of the ZCU 4730 so as to provide fluid communication (e.g., liquid, gas, chemical) between the coil and the first inlet piping and first outlet piping. The coil may be a heat exchanger and the first inlet piping 4712 may supply a fluid, such as water or a refrigerant, to the coil 4732 to heat or cool a volume of air passed through the coil. The first outlet piping 4714 may receive the fluid from the coil 4732 after the volume of air has been heated or cooled. The coil 4732 may have a series of tubes 4734 and fins that facilitate in heating or cooling the volume of air. The first assembly 4702 may also include a first drain pan 4740 coupled with the first bracket 4716 and extending along the first modular assembly 4702 (alternatively, element 4740 may represent other components (cable, conduit, process gas piping, lighting fixtures, and the like) that may be coupled with the assembly). The first assembly may also include a condensate water pump through pipe. The first drain pan may be configured to collect condensate, such as water, that drips from the modular assembly. The drain pan may be for backup purposes in case a fluid leak develops. This may be useful in critical area, such as data centers. Although not shown, the second assembly may also include a second drain pan. The first and second brackets may provide alignment between the first and second drain pans so that the drain pans may be coupled together to form a continuous drain pan along which the condensate may be transported. The continuous drain pan may be coupled with a condensate reclamation system. The modular system 4700 may replace conventional HVAC systems and conventional electrical systems because some or all of these components can be coupled with the modular system 4700. Further the ducts could be spread out offering better air entrainment and indoor air quality and also providing the main electrical distribution system from which lights could be installed and/or electrical conduit run off. The ZCU 4730 may also include a bracket 4735 and/or bracket extension (not shown) that is configured to couple with a pipe 4741, conduit, cable tray, component, device, and the like described herein. The bracket 4735 and/or bracket extension may maintain the pipe 4735, conduit, and the like in a positional relationship to facilitate coupling the pipe 4735 or other component with a respective pipe 4740 or other component of the first assembly 4710.

The modular building utilities system may include some, a majority, or all building utilities such as data, conduit, controls, fire, plumbing, HVAC, low voltage and line voltage, DC and AC current, and the like. The modular building utilities system may reduces 50% or more of the construction field labor of multiple trades such as electrical, controls, plumbing, piping, insulation, HVAC, and the like. Further it may speed up the construction of the building, offer standardization, and/or offer one front end building automation system (BAS) integration platform (lights, fire, security, fire, data etc). The modular building utilities system may be the glue which binds all the utilities in the building together; it may be the smart grid inside the building. The thermal transfer medium within the pipes may be a gas such as refrigerant, or a liquid such as water and the like.

Modular Systems and Assemblies Methods

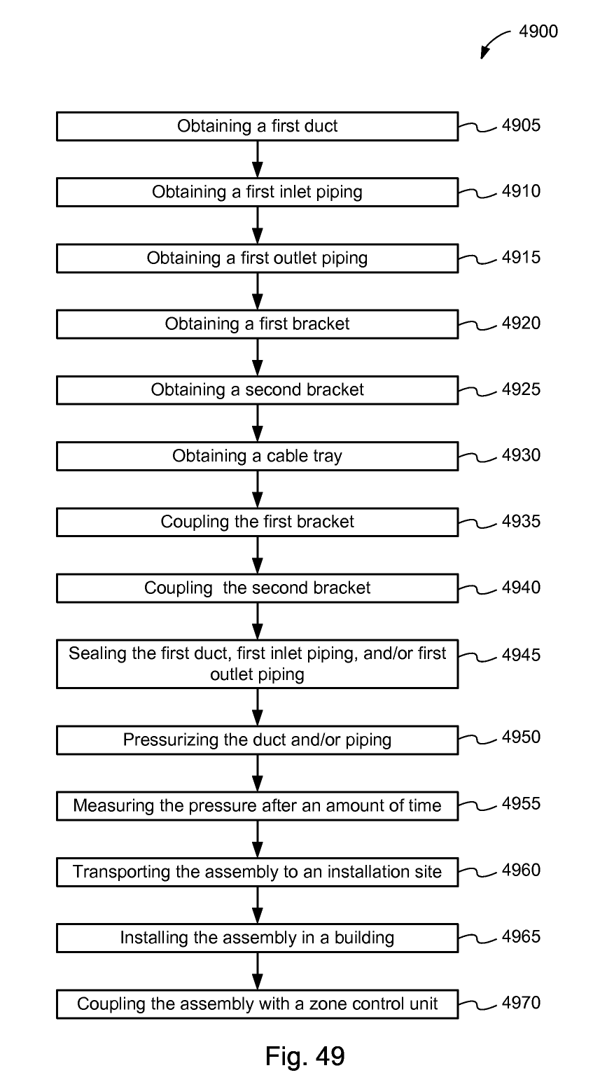

FIG. 49 illustrates a method 4900 of assembling a modular assembly at an assembly site for transportation to an installation site. The modular assembly may be configured similar to the modular assembly of FIG. 47-48. At block 4905, a first modular assembly having a first end and a second end may be obtained. The first duct may be configured to transport air between the first end and the second end. At block 4901, a first inlet piping having a first end and a second end may be obtained. The first inlet piping may be configured to transport a fluid between the first end and the second end. At block 4915, a first outlet piping having a first end and a second end may be obtained. The first outlet piping may be configured to transport a fluid between the first end and the second end. At block 4920, a first bracket having a plurality of mounting features and a first adjustable fastening mechanism for adjustably coupling the first bracket with the building may be obtained. At block 4925, a second bracket having a plurality of mounting features and a second adjustable fastening mechanism for adjustably coupling the second bracket with the building may be obtained. The first and/or second brackets may include a handle configured to maneuver the bracket. The brackets may be configured to maintain support for the assembly components while the bracket is maneuvered by the handle. At block 4930, a cable tray configured to support one or more electrical cables may be obtained.

At block 4935, the first bracket may be coupled via one or more of the plurality of mounting features with the first end of the first duct, the first inlet piping, the first outlet piping, and/or the cable tray. The first inlet piping, the first outlet piping, and/or the cable tray may be disposed exterior to the first duct and the first bracket may maintain the first end of the first duct, the first inlet piping, the first outlet piping, and/or the cable tray in a first positional relationship. At block 4940 the second bracket may be coupled via one or more of the plurality of mounting features with the second end of the first duct, the first inlet piping, the first outlet piping, and/or the cable tray. The second bracket may maintain the second end of the first duct, the first inlet piping, the first outlet piping, and/or the cable tray in the first positional relationship. In some embodiments, one or more of the first duct, the first inlet piping, the first outlet piping, and the cable tray may be coupled with the modular assembly after the modular assembly is installed in a building.

At block 4945, the first and second ends of the first duct, the first inlet piping, and/or the first outlet piping may be sealed. At block 4950, the sealed first duct, first inlet piping, and/or first outlet piping may be pressurized to a predetermined pressure. At block 4955, the pressure in the pressurized first duct, first inlet piping, and/or first outlet piping may be measured after an amount of time to determine whether the sealed and pressurized first duct, first inlet piping, and/or first outlet piping is holding pressure. The amount of time may include overnight, several days, and/or transport to an installation site. At block 4960, the modular assembly may be transported from the assembly site to the installation site. Measuring the pressure as in block 4955 may be performed at the installation site while pressurizing the piping and/or duct may be performed at the assembly site. At block 4965, the modular assembly may be assembly in a building. Additional piping and/or components may be coupled with the modular assembly after installing the assembly in the building. For example, a drain pan may be coupled with the first and second brackets so that the drain pan extends along the length of the modular assembly. The drain pan may be configured to collect condensate and (e.g., water) transport the condensate along the length of the modular assembly. Other components that may be added after installation include: electrical outlets, lights, air distribution devices, thermal transfer devices, fans, pumps, valves, controls hardware/networking equipment, dampers, electrical switch gear, circuit breakers, electrical disconnects, and the like. Alternatively, some, a majority, or all these components could be prefabricated/pre-assembled onto the first and/or second assemblies at an assembly site.

At block 4970, the modular assembly may be coupled with a zone control unit (ZCU) configured to provide HVAC to one or more zones of the building. For example, the first duct may be coupled with the ZCU to provide a portion of the air to the ZCU and the first inlet piping and first outlet piping may be coupled with a coil of the ZCU to supply a fluid (e.g., heat exchange fluid) and receive the fluid from the coil.

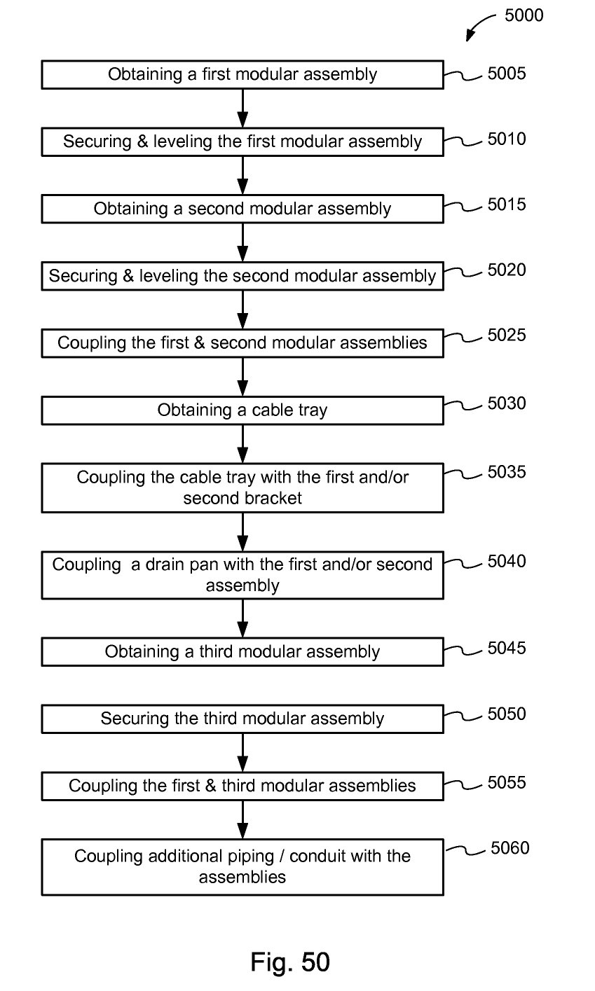

FIG. 50 illustrates a method 5000 of installing a modular system. At block 5005, a first modular assembly may be obtained. The first modular assembly may have a first duct for transporting air, a first bracket coupled with the first duct, a first inlet piping coupled with the first bracket and disposed exterior to the first duct, a first outlet piping coupled with the first bracket and disposed exterior to the first duct, and a first adjustable fastening mechanism coupled with the first bracket for adjustably coupling the first bracket with the building. At block 5010, the first modular assembly may be secured to the building via the first adjustable fastening mechanism and the first modular assembly may be leveled so that opposing ends of the first modular assembly are substantially level (e.g., substantially horizontal). At block 5015, a second modular assembly may be obtained. The second modular assembly may have a second duct for transporting air, a second bracket coupled with the second duct, a second inlet piping coupled with the second bracket and disposed exterior to the second duct, a second outlet piping coupled with the second bracket and disposed exterior to the second duct, and a second adjustable fastening mechanism coupled with the second bracket for adjustably coupling the second bracket with the building. At block 5020, the second modular assembly may be secured to the building via the second adjustable fastening mechanism and the second modular assembly may be leveled so that opposing ends of the second modular assembly are substantially level.

At block 5025, first modular assembly may be coupled with the second modular assembly in a fluid tight relationship to provide air transportation along the combined length of the coupled first and second ducts and to provide fluid transportation along the combined length of the first and second inlet piping and first and second outlet piping. At block 5030, a cable tray may be obtained. The cable tray may be configured to support one or more electrical cables. At block 5035, the cable tray may be coupled with the first bracket and/or second bracket so that the cable tray extends along the length of the first modular assembly and/or second modular assembly. Electrical cables may then be positioned in the cable tray to provide electrical communication to one or more zones of the building. The first modular assembly and the second modular assembly may each include drain pan that extends along the length of the respective modular assembly. At block 5040, the drain pan of the first modular assembly may be coupled with the drain pan of the second modular assembly to form a substantially continuous drain pan that extends along the length of the coupled assemblies. The drain pans may be configured to collect condensate from the first and/or second assemblies and transport the condensate to a condensate reclamation system.

At block 5045, a third modular assembly may be obtained. The third modular assembly may have a third duct for transporting air, a third bracket coupled with the third duct, a third inlet piping coupled with the third bracket and disposed exterior to the third duct, a third outlet piping coupled with the third bracket and disposed exterior to the third duct, and a third adjustable fastening mechanism coupled with the third bracket for adjustably coupling the third bracket with the building. At block 5050, the third modular assembly may be secured to the building so that the third modular assembly comprises a substantially perpendicular orientation with respect to the first modular assembly. At block 5055, the third modular assembly may be coupled with the first modular assembly to provide fluid communication between the first and third ducts, first and third inlet piping, and first and third outlet piping. At block 5060, additional piping, conduit (e.g., electrical conduit), and/or components may be coupled with the first, second, and/or third assemblies.

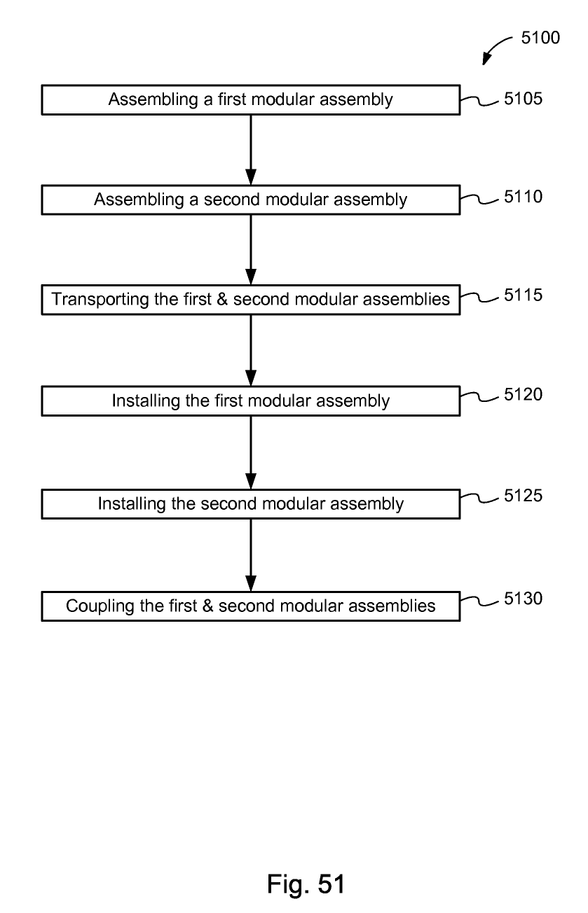

FIG. 51 illustrates a method 5100 of installing a modular building utilities system in a building. At block 5105, a first modular assembly may be assembled at an assembly site. The first modular assembly may include a first duct for transporting air, a first bracket coupled with the first duct, a first inlet piping coupled with the first bracket and disposed exterior to the first duct, a first outlet piping coupled with the first bracket and disposed exterior to the first duct, and a first adjustable fastening mechanism coupled with the first bracket for adjustably coupling the first bracket with the building. At block 5110, a second modular assembly may be assembled at an assembly site. The assembly site may be the same assembly site for the first modular assembly or a different assembly site. The second modular assembly may also include a second duct for transporting air, a second bracket coupled with the second duct, a second inlet piping coupled with the second bracket and disposed exterior to the second duct, a second outlet piping coupled with the second bracket and disposed exterior to the second duct, and a second adjustable fastening mechanism coupled with the second bracket for adjustably coupling the second bracket with the building.

At block 5115, the first modular assembly and the second modular assembly may be transported to an installation site. At block 5020, the first modular assembly may be installed in the building. At block 5025, the second modular assembly may be installed in the building. At block 5030, the first modular assembly may be coupled with the second modular assembly. For example, the first and second ducts, the first and second inlet piping, and the first and second outlet piping may be coupled so as to provide fluid communication between the first and second ducts, the first and second inlet piping, and the first and second outlet piping.

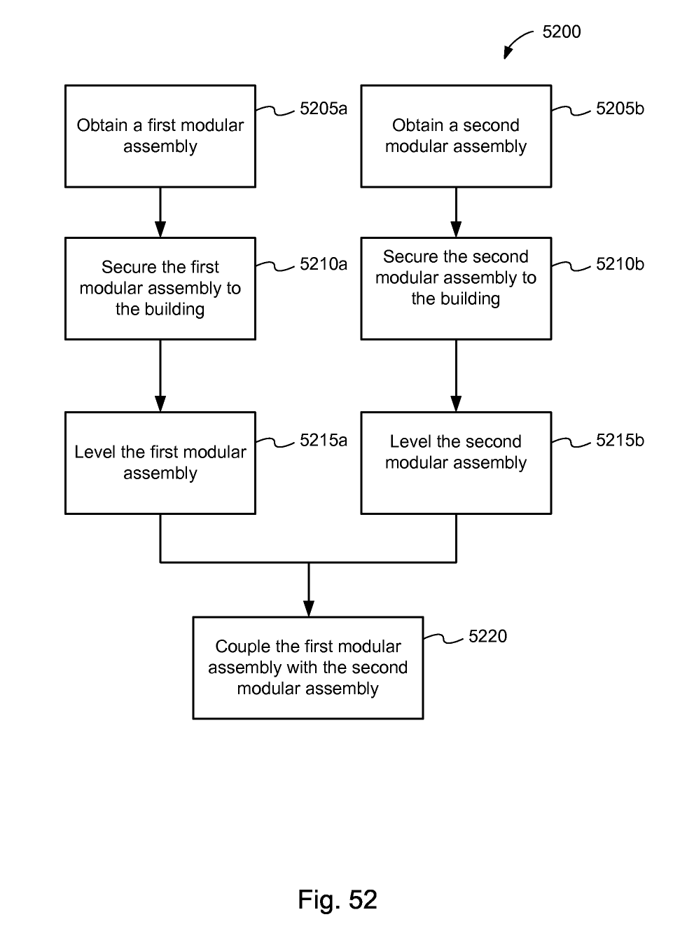

FIG. 52 illustrates a method 5200 of installing a modular building utilities system in a building. At block 5205a, a first modular assembly may be obtained. The first modular assembly may include one or more ducts, inlet piping, outlet piping, cable trays, electrical conduit, sprinkler, speakers, controls, plumbing piping, lighting fixtures, lights, data cables and/or components, network cable and/or components, drain pans, drain pipe, pumps, fans, and the like. The first modular assembly may maintain one or more of these components in a first positional relationship. At block 5205b, a second modular assembly may be obtained. The second modular assembly may include the same or similar components to the first modular assembly and may maintain one or more of these components in a second positional relationship.

At block 5210a the first modular assembly may be secured to the building (e.g., ceiling) via a first adjustable fastening mechanism. At block 5210b the second modular assembly may be secured to the building (e.g., ceiling) via a second adjustable fastening mechanism. At block 5215a, the first modular assembly may be leveled so that opposing ends of the first modular assembly are substantially level. At block 5215b, the second modular assembly may be leveled so that opposing ends of the second modular assembly are substantially level. Optionally, after the first and/or second modular assemblies are secured to the building and/or leveled, additional components, piping, ancillary devices, and the like may be fabricated onto the first and/or second modular assemblies. Fabricating such components, piping, devices, and the like may be quick and easy since leveling is not required or is minimally required. At block 5220, the first modular assembly may be coupled with the second modular assembly. Coupling the assemblies may be facilitated by the first and second positional relationships of the components.

FIG. 53 illustrates an exemplary zone control unit (ZCU) 5300 according to embodiments of the present invention. As shown here, ZCU 5300 can include an outside air mechanism 5310, a return air mechanism 5320, an outside air filter mechanism 5312, a return air filter mechanism 5322, a fan mechanism 5330, and one or more damper mechanisms 5340. ZCU 5300 may also include or be operatively associated with one or more thermal transfer units 5350a, 5350b, 5350c, and 5350d. A thermal transfer unit may be prepiped with valves and pumps, and may be shipped in a pressurized state. Hence, embodiments of the present invention encompass any of a variety of ZCU configurations which may use a fan powered box or mechanism, optionally in association with a multiple outlet damper plenum assembly.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A modular building utilities system for installation in a building, the modular building utilities system comprising:
a first assembly having a first duct for transporting air, a first bracket coupled with the first duct, a first inlet piping coupled with first bracket and disposed exterior to the first duct, a first outlet piping coupled with the first bracket and disposed exterior to the first duct, and a first adjustable fastening mechanism coupled with the first bracket for adjustably coupling the first bracket with the building;
a second assembly having a second duct for transporting air, a second bracket coupled with the second duct, a second inlet piping coupled with second bracket and disposed exterior to the second duct, a second outlet piping coupled with the second bracket and disposed exterior to the second duct, and a second adjustable fastening mechanism coupled with the second bracket for adjustably coupling the second bracket with the building;
wherein the first bracket maintains the first inlet piping, the first outlet piping, and the first duct in a first positional relationship, and the second bracket maintains the second inlet piping, the second outlet piping, and the second duct in a second positional relationship, and
wherein the first and second positional relationships provide alignment between the first and second ducts, the first and second inlet pipings, and the first and second outlet pipings, respectively, so as to facilitate coupling of the first and second ducts, the first and second inlet pipings, and the first and second outlet pipings, respectively.

2. The modular building utilities system of claim 1, further comprising a zone control unit (ZCU) configured to provide HVAC to one or more zones of the building, wherein the first duct comprises a discharge port configured to supply a portion of the air to the ZCU; and wherein the first inlet piping and first outlet piping are coupled with a coil of the ZCU to provide fluid communication between the coil and the first inlet piping and first outlet piping.

3. The modular building utilities system of claim 1, wherein the modular building utilities system is electrically coupled with a computing system to control one or more components of the modular building utilities system selected from the group consisting of: a zone control unit (ZCU), the duct, the inlet piping, the outlet piping, lighting cables, data cables, security systems, plumbing system, electrical cables, and networking equipment.

4. The modular building utilities system of claim 3, wherein the computing system comprises one or more systems selected from the group consisting of: a main frame computing system, a data center, and cloud computing system.

5. The modular building utilities system of claim 1, wherein at least one of the first bracket or the second bracket is coupled with one or more components selected from the group consisting of: fire sprinklers, data cables, electrical conduit, controls, plumbing piping, process gas piping, telecommunication cables, low voltage cables, and line voltage cables.

6. The modular building utilities system of claim 5, wherein the electrical cables provide at least one of dc current or AC current to one or mores zones of the building.

7. The modular building utilities system of claim 1, wherein the modular building utilities system provides one or more utilities to a building selected from the group consisting of: HVAC, electrical power, plumbing, building automation system (BAS) controls, process gas, telecommunications, and security systems.

8. The modular building utilities system of claim 1, wherein the first bracket further comprises a cable tray configured to support one or more electrical wires.

9. The modular building utilities system of claim 1, wherein at least one of the first assembly and the second assembly comprises an enclosure disposed around the at least one of the first assembly and the second assembly to protect the assembly.

10. The modular building utilities system of claim 1, further comprising at least one of a wireless transmitter or a wireless repeater coupled with at least one of the first bracket or second brackets.

11. The modular building utilities system of claim 1, further comprising a first drain pan coupled with and extending along the length of the first bracket and a second drain pain coupled with and extending along the length of the second bracket, wherein the first drain pan and the second drain pan are configured to collect condensate of the modular system.

12. The modular building utilities system of claim 11, wherein the first and second brackets provide alignment between the first and second drain pans, respectively, to facilitate coupling of the first and second drain pans so that the condensate may be transported at least partially along the length of the first and second assemblies to a condensate reclamation system.

13. A method of assembling a modular assembly at an assembly site for transportation to an installation site, the modular assembly being configured for installation in a heating, ventilating, and air conditioning (HVAC) system of a building, the method comprising:
obtaining a first duct having a first end and a second end, the first duct configured to transport air between the first end and the second end;
obtaining a first inlet piping having a first end and a second end, the first inlet piping configured to transport a fluid between the first end and the second end;
obtaining a first outlet piping having a first end and a second end, the first outlet piping configured to transport a fluid between the first end and the second end;
obtaining a first bracket having a plurality of mounting features and a first adjustable fastening mechanism for adjustably coupling the first bracket with the building;
obtaining a second bracket having a plurality of mounting features and a second adjustable fastening mechanism for adjustably coupling the second bracket with the building;
coupling via one or more of the plurality of mounting features, the first bracket with the first end of the first duct, the first inlet piping, and the first outlet piping, wherein the first inlet piping and the first outlet piping are disposed exterior to the first duct, and wherein the first bracket maintains the first end of the first duct, the first inlet piping, and the first outlet piping in a first positional relationship; and
coupling via one or more of the plurality of mounting features, the second bracket with the second end of the first duct, the first inlet piping, and the first outlet piping, wherein the second bracket maintains the second end of the first duct, the first inlet piping, and the first outlet piping in the first positional relationship.

14. The method of claim 13, further comprising:
sealing the first and second ends of at least one of the first duct, the first inlet piping, and the first outlet piping;
pressurizing the at least one of the first duct, the first inlet piping, and the first outlet piping to a predetermined pressure; and
measuring the pressure in the at least one of the first duct, the first inlet piping, and the first outlet piping after an amount of time to determine whether the at least one of the first duct, the first inlet piping, and the first outlet piping is holding pressure.

15. The method of claim 14, further comprising:
coupling one or more electrical cables with the first and second brackets; and
testing the electrical cables for conductivity.

16. The method of claim 14, further comprising transporting the modular assembly from the assembly site to the installation site, wherein pressurizing is performed at the assembly site, and wherein measuring the pressure is performed at the installation site.

17. The method of claim 13, further comprising:
obtaining a cable tray having a first end and a second end, the cable tray configured to support one or more electrical cables;
coupling the first bracket with the first end of the cable tray via a mounting feature of the plurality of mounting features; and
coupling the second bracket with the second end of the cable tray via a mounting feature of the plurality of mounting features.

18. The method of claim 17, wherein coupling the first and second brackets with the first and second ends of the cable tray, respectively, is performed at the installation site.

19. The method of claim 17, wherein coupling the first and second brackets with the first and second ends of the cable tray, respectively, is performed at the assembly site.

20. The method of claim 13, further comprising:
coupling the first duct with a zone control unit (ZCU) configured to provide HVAC to one or more zones of the building, wherein the first duct provides fluid communication between the ZCU and the air; and
coupling a coil of the ZCU with the first inlet piping and first outlet piping, wherein the first inlet piping supplies a hot or cold fluid to the coil to heat or cool a volume of air, and wherein the first outlet piping receives a hot or cold fluid from the coil after the volume of air is heated or cooled.

21. The method of claim 13, further comprising coupling a drain pan with the first and second brackets, wherein the drain pan extends along the length of the modular assembly, and wherein the drain pan is configured to collect condensate and transport the condensate along the length of the modular assembly.

22. The method of claim 13, wherein each bracket includes a handle configured to maneuver the bracket, wherein the bracket is configured to maintain support for the pipe assembly while the bracket is maneuvered by the handle.

23. A method of installing a modular system in a building comprising:
obtaining a first modular assembly having a first duct for transporting air, a first bracket coupled with the first duct, a first inlet piping coupled with the first bracket and disposed exterior to the first duct, a first outlet piping coupled with the first bracket and disposed exterior to the first duct, and a first adjustable fastening mechanism coupled with the first bracket for adjustably coupling the first bracket with the building;
securing the first modular assembly to the building via the first adjustable fastening mechanism;
leveling the first modular assembly so that opposing ends of the first modular assembly are substantially level;
obtaining a second modular assembly having a second duct for transporting air, a second bracket coupled with the second duct, a second inlet piping coupled with the second bracket and disposed exterior to the second duct, a second outlet piping coupled with the second bracket and disposed exterior to the second duct, and a second adjustable fastening mechanism coupled with the second bracket for adjustably coupling the second bracket with the building;
securing the second modular assembly to the building via the second adjustable fastening mechanism;
leveling the second modular assembly so that opposing ends of the second modular assembly are substantially level;
coupling the first modular assembly with the second modular assembly in a fluid tight relationship to provide air transportation along the combined length of the coupled first and second ducts and to provide fluid transportation along the combined length of the first and second inlet piping and first and second outlet piping.

24. The method of claim 23, further comprising:
obtaining a cable tray a cable tray configured to support one or more electrical cables; and
coupling the cable tray with at least one of the first bracket or the second bracket so that the cable tray extends along the length of at least one of the first modular assembly or second modular assembly.

25. The method of claim 24, further comprising positioning electrical cables in the cable tray to provide electrical communication to one or more zones of the building.

26. The method of claim 23, further comprising:
obtaining a third modular assembly having a third duct for transporting air, a third bracket coupled with the third duct, a third inlet piping coupled with the third bracket and disposed exterior to the third duct, a third outlet piping coupled with the third bracket and disposed exterior to the third duct, and a third adjustable fastening mechanism coupled with the third bracket for adjustably coupling the third bracket with the building;
securing the third modular assembly to the building so that the third modular assembly comprises a substantially perpendicular orientation with respect to the first modular assembly; and
coupling the third modular assembly with the first modular assembly to provide fluid communication between the first and third ducts, first and third inlet piping, and first and third outlet piping.

27. The method of claim 23, wherein the first modular assembly and the second modular assembly each comprise a drain pan that extends along the length of the respective modular assembly, and wherein the method further comprises:
coupling the drain pan of the first modular assembly with the drain pan of the second modular assembly to form a substantially continuous drain pan extending along the length of the coupled assemblies, wherein the drain pans are configured to collect condensate from at least one of the first or second assemblies and transport the condensate to a condensate reclamation system.

28. The method of claim 23, further comprising:
obtaining a fourth piping;
obtaining a fifth piping;
after securing the first modular assembly to the building, coupling the fourth piping with the first modular assembly;
after securing the second modular assembly to the building, coupling the fifth piping with the second modular assembly; and
coupling the fourth piping with the fifth piping to provide fluid transportation along the combined length of the fourth and fifth piping.

29. A method of installing a modular building utilities system in a building, the method comprising:
assembling a first modular assembly at an assembly site, the first modular assembly having a first duct for transporting air, a first bracket coupled with the first duct, a first inlet piping coupled with the first bracket and disposed exterior to the first duct, a first outlet piping coupled with the first bracket and disposed exterior to the first duct, and a first adjustable fastening mechanism coupled with the first bracket for adjustably coupling the first bracket with the building;
assembling a second modular assembly at an assembly site, the second modular assembly having a second duct for transporting air, a second bracket coupled with the second duct, a second inlet piping coupled with the second bracket and disposed exterior to the second duct, a second outlet piping coupled with the second bracket and disposed exterior to the second duct, and a second adjustable fastening mechanism coupled with the second bracket for adjustably coupling the second bracket with the building;
transporting the first modular assembly and the second modular assembly to an installation site;
installing the first modular assembly in the building;
installing the second modular assembly in the building; and
coupling the first and second ducts, the first and second inlet piping, and the first and second outlet piping so as to provide fluid communication between the first and second ducts, the first and second inlet piping, and the first and second outlet piping.
